(19) United States
(12) Patent Application Publication
(10) Pub. No.: US 2014/0206832 A1
(43) Pub. Date: Jul. 24, 2014

(54) POLY OLIGOSILOXYSILANE

(71) Applicants: Johan Martens, Huldenberg (BE); Pieter Leo Hendrik Verlooy, Grimbergen (BE)

(72) Inventors: Johan Martens, Huldenberg (BE); Pieter Leo Hendrik Verlooy, Grimbergen (BE)

(73) Assignee: Katholieke Universiteit Leuven, Leuven (BE)

(21) Appl. No.: 14/239,692

(22) PCT Filed: Aug. 17, 2012
(86) PCT No.: PCT/BE2012/000042

§ 371 Date: Feb. 19, 2014

Related U.S. Application Data
(60) Provisional application No. 61/575,379, filed on Aug. 19, 2011.

(30) Foreign Application Priority Data
Jan. 27, 2012 (GB) 1201357.9

(51) Int. Cl. C08G 77/02; C08G 77/06

(52) U.S. Cl. CPC C08G 77/02; C08G 77/06
USPC 528/10

(57) ABSTRACT

The present invention relates to a new synthesis procedure for a family of silica based polymer materials synthesized through the interconnection of silicate oligomers with reactive silanes. By using this synthesis it is possible to generate novel silica based polymer materials. The present invention thus also relates to the members of this group of ordered silica based polymer materials whereby silicate oligomers are interconnected trough siloxane bridges and with empirical formulae Abₓ, whereby A presents the silicate oligomer, b the siloxane bridge and x the ratio between the number of silanes and the number of silicate oligomers in the material. This group of materials are particularly useful for certain applications. In another aspect, the present invention provides the use of the materials of present invention as a fire retardant coating, to enforce polymers, as a cross linking agent in polymers, as adsorbent in water purification, in separation processes, as catalyst or catalyst support in catalysis, for spin-coating of thin films, for spin-coating of thin films with low k dielectric layers in integrated circuit applications, in sensors, as (super)hydrophobic anti-ice coating on airplanes and windmills, as anti-fouling coating inside for instance in pipelines, as anti-dirt coating.

### BACKGROUND OF THE INVENTION

A. Field of the Invention

The present invention relates generally to a new family of poly oligosiloxysilane based polymeric materials and, more particularly to a system and method for producing polymers based on silicate oligomers interconnected by siloxane bridges (hereinafter called poly oligosiloxysilanen (POSiSil)) by a process of bridging silicate oligomers by silane compounds.

Several documents are cited throughout the text of this specification. Each of the documents herein (including any manufacturer's specifications, instructions etc.) are hereby incorporated by reference; however, there is no admission that any document cited is indeed prior art of the present invention.

B. Description of the Related Art

The poly dimethyl siloxane (PDMS) polymers, one of the most common members of the silicone family are silica based materials. Such silicones are inert synthetic compounds with a variety of forms and uses. In general silicones are heat-resistant and rubber-like and are used is a large variety of applications: sealants, adhesives, lubricants, insulation, fire retardant, medical applications, food applications (anti foaming agent), cookware, etc. But they all have quite flexible polymer backbones (or chains). These have disadvantages for particular application.

There is a strong need in the art for hydrophobic and thermally and chemically stable materials with rigid polymer backbones (or chains) that could find many applications in for example enforcing polymers, fire retardation, cross linking polymers, resistant coatings, etc.

The present invention provides such materials and a production process thereof.

Zeolites are a class of porous crystalline materials. A typical zeolite synthesis involves a hydrothermal heating of a solution/suspension or gel containing water, a silica source, a (organic/inorganic) template and optional some other metal species. A large variety of metal atoms can be incorporated into zeolites. This potential of incorporation of metal together with the specific pore architectures of the different zeolites make, them ideally suited for as catalysts. Other potential applications are molecular sieving in separation processes, ion exchange, water adsorption, etc. Hydrophobic zeolites can be used in separation, in water purification, as fire resistant material in polymer coatings etc. The robustness and the inorganic nature of zeolites makes them difficult to incorporate in for example membranes. Flexible, nanoporous inert and stable materials with monodisperse pore dimensions are however difficult to prepare. Therefore there is a strong need in the art for new materials such as hydrophobic microporous POSiSils and for a production method for such a materials.

### SUMMARY OF INVENTION

In one aspect of the invention, the present invention relates to a new synthesis procedure for a family of silica based polymer materials (for instance chain silica polymers or for instance double chain polymers) synthesized through the interconnection of silicate oligomers with reactive silanes.

Another aspect of the invention concerns the members of this group of silica based polymer materials whereby silicate oligomers are interconnected trough siloxane bridges with empirical formulae Abₓ, whereby A presents the silicate oligomer, B the siloxane bridge and x the ratio between the number of bridges and the number of silicate oligomers in the material, as is further described in this application. This group of silica based polymer materials can be among other applications, be used as a fire retardant coating, to enforce polymers, as a cross linking agent in polymers, as adsorbent in water purification, as catalyst or catalyst support in catalysis, for spin-coating of thin films, for spin-coating of thin films with low k dielectric layers in integrated circuit applications, in sensors, as (super)hydrophobic anti-ice coating for instance on airplanes and windmills, as anti-fouling coating for instance in inside pipelines, as anti-dirt coating etc.

An object of the present invention is to provide a silica based polymer comprising by siloxane bridges interconnected silicate oligomers, whereby said material is ordered, has long range ordering or locally ordered. Another aspect of the present invention is a silica based polymer comprising by siloxane bridges interconnected silicate oligomers, whereby said material is ordered, has long range ordering or locally ordered, whereby the polymer is not a liquid and the polymer is not a gel material. The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer. The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5

In a further embodiment these silica based polymer comprise local ordering or is locally ordered as demonstrable by pair correlation function analysis. This ordering can be characterized. Particular aspects of present invention are silica based polymer that comprise local ordering or is locally ordered as demonstrable by Extended X-ray adsorption fine structure analysis; that comprise local ordering or is locally ordered as demonstrable by Infrared spectroscopy or Fourier transform infrared spectroscopy; that comprise local ordering or is locally ordered as demonstrable by RAMAN spectroscopy; that comprise local ordering or is locally ordered as demonstrable by N₂-fysisorption; that comprise local ordering or is locally ordered as demonstrable by ²⁹Si MAS NMR comprise local ordering or is locally ordered as demonstrable by 2D and 3D ²⁹Si NMR techniques; that comprise local ordering or is locally ordered as demonstrable by Shape selective adsorption of molecules; that comprises local ordering or is locally ordered as demonstrable by adsorption sites with similar energy of adsorption for a specific molecules or for several specific molecules; that comprise local ordering or is locally ordered as demonstrable by X-ray diffraction (WAXS); that comprise local ordering or is locally ordered as demonstrable by small angle X-ray scattering; comprise local ordering or is locally ordered as demonstrable by Electron diffraction or that comprise local ordering or is locally ordered as demonstrable by nanobeam Electron diffraction.

Yet other particular aspects of present invention are silica based polymer that comprise long range ordering or is long range ordered as demonstrable by X-ray diffraction; that comprise long range ordering or is long range ordered as demonstrable by high resolution transmission electron microscopy; that comprise long range ordering or is long range ordered as demonstrable by electron diffraction or that comprise long range ordering or is long range ordered as demonstrable by scanning electron diffraction microscopy.

One aspect of the present invention relates to the above described silica based polymer but with these features that siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of H, OH, Cl, Br, I, NHR, NR₂, OSi(R)₃, NSi(R)₃, OSn(R)₃, OSb(R)₃ or OSi(R)₂H, OR, (with R selected from methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl and dibromoethyl or being an organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne) and whereby the remaining 0, 1 or 2 groups W, X, Y, Z are independently of each other selected from the organic groups consisting of H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne.

Another aspect of the present invention relates to the above described silica based polymer of the invention but with these features that the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of Cl, Br, NR₂, OR, (with R selected of the group consisting of methyl, ethyl, vinyl, allyl, isopropyl, propyl, isobutyl, butyl, phenyl, benzyl, cyclopentyl and cyclohexyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl, cyclohexyl, alkyl, alkenyl, aryl, arenyl, haloalkyl, haloaryl, fluoroalkyl and fluoroaryl.

Another aspect of the present invention relates to the above described silica based polymer of the invention but with these features that the siloxane bridge (b) is derived from a silane (B) or combination of form SiWXYZ whereby 2, 3 or 4 of the groups W, X, Y, Z are independently of each other selected from the group of reactive leaving groups (rlg) consisting of Cl, Br, OR, (with R selected of the group consisting of methyl, ethyl, isopropyl and propyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl and cyclohexyl.

Another aspect of the present invention relates to the above described silica based polymer of the invention but with these features that the siloxane bridge (b) is derived from a silane (B) or combination of silanes selected of SiCl₂(CH₃)₂, SiCl₂(CH₃)H, SiCl₂H₂, SiCl₃(CH₃), SiCl₃H and SiCl₄.

In specific embodiments the silica based polymer is characterized by any one of the following the silicate oligomer A is a D4R silicate octamer of formula [Si₈O₂₀H_{b}]^{b-8} with b selected from 0, 1, 2, 3, 4, 5, 6, 7, 8, 9, 10, 11, 12, 13, 14, 15 and 16; each silicate oligomer A is a double ring silicate oligomer independently from each other of formula [SiₙO_{5n/2}H_{b}]^{b-n} with n being 6, 8, 10, 12, 14 or 16 and each b selected from 0 to 2n OR each silicate oligomer A is a ring silicate oligomer independently of formula [SiₙO₃ₙH_{b}]^{b-2n} with n=3, 4, 5, 6, 7, 8 or 9 and each b independently from 0 to 4n.

In a particular embodiment these silica based polymer here above described are characterized in that the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of H, OH, Cl, Br, I, NHR, NR₂, OSi(R)₃, NSi(R)₃, OSn(R)₃, OSb(R)₃ or OSi(R)₂H, OR, (with R selected from methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl and dibromoethyl or being an organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne) and whereby the remaining 0, 1 or 2 groups W, X, Y, Z are independently of each other selected from the organic groups consisting of H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne or whereby the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of Cl, Br, NR₂, OR, (with R selected of the group consisting of methyl, ethyl, vinyl, allyl, isopropyl, propyl, isobutyl, butyl, phenyl, benzyl, cyclopentyl and cyclohexyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl, cyclohexyl, alkyl, alkenyl, aryl, arenyl, haloalkyl, haloaryl, fluoroalkyl and fluoroaryl or whereby the siloxane bridge (b) is derived from a silane (B) or combination of form SiWXYZ whereby 2, 3 or 4 of the groups W, X, Y, Z are independently of each other selected from the group of reactive leaving groups (rlg) consisting of Cl, Br, OR, (with R selected of the group consisting of methyl, ethyl, isopropyl and propyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl and cyclohexyl, whereby the structure of the polymer is structurally related to zeolite with the LTA topology but whereby the oxygen atoms of the siloxane bonds (—O—) between the silicate cubes in the LTA zeolites are replaced by siloxane bridges (—O—Si(Y)(Z)—O—) formed by the silane molecule B and with Y and Z

In a particular embodiment these silica based polymer here above described are characterized in that the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of H, OH, Cl, Br, I, NHR, NR₂, OSi(R)₃, NSi(R)₃, OSn(R)₃, OSb(R)₃ or OSi(R)₂H, OR, (with R selected from methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl and dibromoethyl or being an organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne) and whereby the remaining 0, 1 or 2 groups W, X, Y, Z are independently of each other selected from the organic groups consisting of H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne or whereby the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of Cl, Br, NR₂, OR, (with R selected of the group consisting of methyl, ethyl, vinyl, allyl, isopropyl, propyl, isobutyl, butyl, phenyl, benzyl, cyclopentyl and cyclohexyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl, cyclohexyl, alkyl, alkenyl, aryl, arenyl, haloalkyl, haloaryl, fluoroalkyl and fluoroaryl or whereby the siloxane bridge (b) is derived from a silane (B) or combination of form SiWXYZ whereby 2, 3 or 4 of the groups W, X, Y, Z are independently of each other selected from the group of reactive leaving groups (rlg) consisting of Cl, Br, OR, (with R selected of the group consisting of methyl, ethyl, isopropyl and propyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl and cyclohexyl and whereby the structure of the polymers is structurally related to zeolite whereby the oxygen atoms of siloxane bonds (—O—) between specific silicate oligomeric species in the zeolite are replaced by a siloxane bridge (—O—Si(Y)(Z)—O—) formed by the silane molecule B and with Y.

One aspect of the present invention relates to above embodied silica based polymer of present invention but with these features 1) each A silicate oligomer is directly connected through siloxane bridges with eight other neighboring silicate oligomers, or 2) minimum 50% of the silicate oligomers is directly connected through siloxane bridges with exactly eight other neighboring silicate oligomers or 3) minimum 80% of the silicate oligomers is directly connected through siloxane bridges with exactly eight other neighboring silicate oligomers or 4) if a silicate oligomer is connected to another silicate oligomer through minimum one siloxane bridge, then in more than 50% of the cases, this connection consist of exactly one siloxane bridge or 5) if a silicate oligomer is connected to another silicate oligomer through minimum one siloxane bridge, then in more than 75% of the cases, this connection consist of exactly one siloxane bridge or 6) if a silicate oligomer is connected to another silicate oligomer through minimum one siloxane bridge, then in more than 90% of the cases, this connection consist of exactly one siloxane bridge or 7) if a silicate oligomer is connected to another silicate oligomer through minimum one siloxane bridge, then in more than 95% of the cases, this connection consist of exactly one siloxane bridge or 8) less than 20% of the connections between a silicate oligomers and another silicate oligomer consists of minimum 2 siloxane bridges.

One aspect of the present invention relates to above embodied silica based polymer of present invention but with these features that 1) the siloxane bridges b connected to a silicate oligomers are connected to two silicate oligomers or 2) minimum 50% of the siloxane bridges b connected to a silicate oligomer are connected to two silicate oligomers or 3) minimum 75% of the siloxane bridges b connected to a silicate oligomer are connected to two silicate oligomers, or 4) minimum 90% of the siloxane bridges b connected to a silicate oligomer are connected to two silicate oligomers, or 5) minimum 95% of the siloxane bridges b connected to a silicate oligomer are connected to two silicate oligomers, or 6) less than 25% of the siloxane bridges b connected to a silicate oligomer are connected to only one silicate oligomer, or 7) less than 10% of the siloxane bridges b connected to a silicate oligomer are connected to only one silicate oligomer.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the structure of the individual polymers has a linear shape. The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer. These polymers can be ordered, have long range ordering or be locally ordered. Yet another aspect is that these polymers is not a gel material.

An object of the present invention is also to provide a silica based polymer comprising by siloxane bridges interconnected silicate oligomers, whereby the silica based polymer comprises by siloxane bridges interconnected silicate oligomers (poly oligosiloxysilane), with the general formulae Abₓ whereby b is a siloxane bridge and A is a silicate oligomer or whereby the silica based polymer comprises by siloxane bridges interconnected silicate oligomers (poly oligosiloxysilane), with the general formulae [Abₓ+b_{y}] whereby b is a siloxane bridge and A is a silicate oligomer and the polymer not being a liquid or a gel and this polymer being ordered, having s long range ordering or being locally ordered and the polymer being further characterized in that the structure of the individual polymers has a linear shape or each A silicate oligomer is directly connected through siloxane bridges with two other neighboring silicate oligomers. In a particular embodiment each A silicate oligomer is directly connected through siloxane bridges with two other neighboring silicate oligomers. In particular embodiments each A silicate oligomer is directly connected through siloxane bridges with two other neighboring silicate oligomers, whereby minimum 50% or the silicate oligomers is directly connected through siloxane bridges with exactly two other neighboring silicate oligomers or minimum 80% or the silicate oligomers is directly connected through siloxane bridges with exactly two other neighboring silicate oligomers, or minimum 40% of the siloxane bridges involved in the bridging of silicate oligomers are involved in the bridging of neighboring silicate oligomers so that a linear shape structure if formed. In yet other particular embodiments a connection between a silicate oligomers consists of four siloxane bridges or minimum 50% of the connections between a silicate oligomers and another silicate oligomer consists of four siloxane bridges or minimum 80% of the connections between a silicate oligomers and another silicate oligomer is formed by or consists of four siloxane bridges or minimum 50% of the connections between a silicate oligomers and another silicate oligomer is formed by or consists of minimum 3 siloxane bridges or minimum 80% of the connections between a silicate oligomers and another silicate oligomer is formed by or consists of minimum 3 siloxane bridges or minimum 80% of the connections between a silicate oligomers and another silicate oligomer is formed by or consists of minimum 2 siloxane bridges.

An object of the present invention is also to provide a silica based polymer comprising by siloxane bridges interconnected silicate oligomers, whereby the silica based polymer comprises by siloxane bridges interconnected silicate oligomers (poly oligosiloxysilane), with the general formulae Abₓ whereby b is a siloxane bridge and A is a silicate oligomer or whereby the silica based polymer comprises by siloxane bridges interconnected silicate oligomers (poly oligosiloxysilane), with the general formulae [Abₓ+b_{y}] whereby b is a siloxane bridge and A is a silicate oligomer and the polymer not being a liquid or a gel and this polymer being ordered, having s long range ordering or being locally ordered and the polymer being further characterized in that the siloxane bridges b connected to a silicate oligomers are connected to two silicate oligomers or that minimum 30% of the siloxane bridges b connected to a silicate oligomers is connected to two silicate oligomers or that minimum 75% of the siloxane bridges b connected to a silicate oligomers is connected to two silicate oligomers or that minimum 90% of the siloxane bridges b connected to a silicate oligomers is connected to two silicate oligomers or that minimum 50% of the siloxane or that bridges b connected to a silicate oligomers is connected to minimum two silicate oligomers.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the structure of the individual polymers has a linear shape and whereby no siloxane bridges are formed between parallel linear silica based polymer chains or whereby the individual poly oligosiloxysilane chains, composed of silicate oligomers interconnected by siloxane bridges, form silica based nano needles or nano fibers with a diameter or with a thickness between 0.6 nm to 3 nm, preferably 0.8 nm to 1.5 nm and with a length preferable less than 5 μm long or whereby the individual poly oligosiloxysilane chains, composed of silicate oligomers interconnected by siloxane bridges, form silica based nano needles or nano fibers with a diameter or with a thickness between 0.5 nm to 3 nm, preferably between 0.7 nm to 1.5 nm and with a length preferable less than 5 μm long and with less than 4 silanol groups per nm of length of the individual nano fiber or nano needle, preferably less than 2 silanol groups per nm of length of the individual nano fiber or nano needle or whereby the individual poly oligosiloxysilane chains, composed of silicate oligomers interconnected by siloxane bridges, form silica based nano needles or nano fibers the nano needles or nano fibers being more rigid than typical poly dimethyl siloxane (PDMS) polymers.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the structure of the individual polymers has a linear shape and whereby less than 25% of the siloxane bridges between silicate oligomers form siloxane bridges between parallel linear silica based polymer chains or whereby less than 10% of the siloxane bridges between silicate oligomers form siloxane bridges between parallel linear silica based polymer chains.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that more than 50% of the siloxane bridges b is involved is involved in more than two siloxane bonds or that more than 30% the siloxane bridges is involved in siloxane bridges between the parallel linear silica based polymer chains or that more than 60% the siloxane bridges is involved in siloxane bridges between parallel linear silica based polymer chains or that more than 20% of the silicon atoms of the silicate oligomers is involved in siloxane bridges between silicate oligomers in parallel linear silica based polymer chains.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking double ring silicate oligomers (A) the general formulae for the poly oligosiloxysilane compounds are:

siloxane bridge (b) linking 2 silicate oligomers providing an Ab_{n/2} polymer or
siloxane bridge (b) linking 3 silicate oligomers providing an Ab_{n/3} polymer
with A=[SiₙO_{5n/2}]* and with n selected from 6, 8, 10, 12, 14 and 16
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking single ring silicate oligomers (A) the general formulae for the poly oligosiloxysilane compounds are:

siloxane bridge (b) linking 2 silicate oligomers providing an Abₙ, polymer or
siloxane bridge (b) linking 3 silicate oligomers providing an Ab_{2n/3} polymer
with A=[SiₙO₃ₙ]* and with n selected from 3, 4, 5, 6, 7, 8 and 9
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking linear chain silicate oligomers (A) the general formulae for the poly oligosiloxysilane compounds are:

siloxane bridge (b) linking 2 silicate oligomers providing an Abₙ₊₁ polymer or
siloxane bridge (b) linking 3 silicate oligomers providing an Ab_{(2n+2)/3} polymer
with A=[SiₙO₃ₙ₊₁]* and with n selected from 1, 2, 3, 4, 5, 6, 7 and 8
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that

for the siloxane bridge (b) linking linear chain silicate polymers (A) the general formulae for the poly oligosiloxysilane compounds are:
siloxane bridge (b) linking 2 silicate oligomers providing an Abₙ₊₁ polymer or
siloxane bridge (b) linking 3 silicate oligomers providing an Ab_{(2n+2)/3} polymer or
siloxane bridge (b) linking 5 silicate oligomers providing an Ab_{(2n+2)/5} polymer
with A=[SiₙO₃ₙ₊₁]* and with 20<n<∝
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking ladder type linear double chain silicate polymers (A) the general formulae for the poly oligosiloxysilane compounds are:

siloxane bridge (b) linking 2 silicate oligomers providing an Abₙ₊₂ polymer or
siloxane bridge (b) linking 3 silicate oligomers providing an Ab_{(2n+4)/3} polymer
with A=[Si₂ₙO₅ₙ₊₂]* and with 20<n<∝
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that

for the siloxane bridge (b) linking six-ring type linear double chain silicate polymers (A) the general formulae for the poly oligosiloxysilane compounds are:
siloxane bridge (b) linking 2 silicate oligomers providing an Ab₃ₙ₊₂ polymer or
siloxane bridge (b) linking 3 silicate oligomers providing an Ab_{(6n+4)/3} polymer
with A=[Si₄ₙO₁₁ₙ₊₂]* and with 20<n<∝
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking double chain silicate polymers (A) the general formulae for the poly oligosiloxysilane compounds are:

siloxane bridge (b) linking 2 silicate oligomers providing an Abₓ polymer or
siloxane bridge (b) linking 3 silicate oligomers providing an Ab_{2x/3} polymer or
siloxane bridge (b) linking 5 silicate oligomers providing an Ab_{2x/5} polymer
with A=[SiₙO_{y}]*, with 20<n<∝; 5n/2+1≦y≦3n+1; x=y−2n
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that for the siloxane bridge (b) linking silicate oligomers (A) the general formulae for the poly oligosiloxysilane compounds are:

siloxane bridge (b) linking 2 silicate oligomers providing an Abₓ polymer or
siloxane bridge (b) linking 3 silicate oligomers providing an Ab_{2x/3} polymer or
siloxane bridge (b) linking 5 silicate oligomers providing an Ab_{2x/5} polymer
with A=[SiₙO_{y}]*, with 1<n<40; 2n+1≦y≦3n+1; x=y−2n
*for sake of clarity Hydrogen atoms in the formulae of A are omitted.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the silicate oligomers interconnected by siloxane bridges in the form of microporous silica polymers materials with a pore size in the range of 0.2 to 2 nm, preferably 0.3 to 1 nm.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the silicate oligomers interconnected by siloxane bridges in the form of microporous silica polymers materials with pores mainly formed by six, eight, nine, ten, twelve, fourteen, fifteen, sixteen, eighteen, twenty, twenty-one or twenty-four silicate tetrahedral or any combination of those different ring structures.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores accessible through 9 ring and 12 ring structures (9 and 12 ‘—Si—O—’ units).

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by 9 rings (9 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by 12 rings (12 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by one dimensional 16 ring structures (ring structures formed by 16 ‘—Si—O—’ units) interconnected by a network of 8 ring pores (ring structures formed by 8 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by one dimensional 20 ring structures (ring structures formed by 20 ‘—Si—O—’ units) interconnected by a network of 10 ring pores (ring structures formed by 10 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by one dimensional 15 ring structures (ring structures formed by 15 ‘—Si—O—’ units) interconnected by a network of 10 ring pores (ring structures formed by 10 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by one dimensional 12 ring structures (ring structures formed by 12 ‘—Si—O—’ units) interconnected by a network of 8 ring pores (ring structures formed by 8 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that whereby the polymer or the material comprising said polymer is microporous with pores formed by one dimensional 8, 12 or 16 ring structures (ring structures formed by 8, 12 or 16 ‘—Si—O—’ units) interconnected by a network of 14 ring pores (ring structures formed by 14 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the polymer or the material comprising said polymer is microporous with pores formed by one dimensional 6, 9 or 12 ring structures (ring structures formed by 6, 9 or 12 ‘—Si—O—’ units) interconnected by a network of 12 ring pores (ring structures formed by 12 ‘—Si—O—’ units)

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that silicate oligomers, which are interconnected by siloxane bridges, in the form of microporous silica polymers materials with hydride or organic groups connected to the silica core structure.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that the silica based polymer contains less than 4 silanol groups per nm² of BET surface area, preferably less than 2 silanol groups per nm² of BET surface area, more preferably less than 1 silanol groups per nm² of BET surface area, most preferably less than 0.5 silanol groups per nm² of BET surface area.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+by] whereby b is a siloxane bridge and A is a silicate oligomer, whereby x=4; whereby x=2-6; whereby x=2.5-5.5; whereby x=3-5 or whereby x=3.5-4.5 and that is characterized in that the silica based polymer comprising by siloxane bridges interconnected silicate oligomers (poly oligosiloxysilane) with the general formulae Abₓ whereby b is a siloxane bridge and A is a silicate oligomer also contains one or more different types of silane oligomers b_{y}

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that part of the silane oligomers b_{y} are inside the pores of the Abₓ polymer

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that part of the silane oligomers b_{y} are in close contact with the Abₓ polymer

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that part of the silane oligomers b_{y} are directly connected to the Abₓ polymer

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that no silanes B or siloxane bridges b connected by minimum one siloxane bond to minimum one silicate oligomer A are also connected to minimum one silane molecule B or B′ or to minimum one siloxane bridge b or b′.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that maximum 30% of the silanes B or siloxane bridges b connected by minimum one siloxane bond to minimum one silicate oligomer A are also connected to minimum one silane molecule B or B′ or to minimum one siloxane bridge b or b′.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that maximum 10% of the silanes B or siloxane bridges b connected by minimum one siloxane bond to minimum one silicate oligomer A are also connected to minimum one silane molecule B or B′ or to minimum one siloxane bridge b or b′.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that maximum 5% of the silanes B or siloxane bridges b connected by minimum one siloxane bond to minimum one silicate oligomer A are also connected to minimum one silane molecule B or B′ or to minimum one siloxane bridge b or b′.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that B═B′—B′; B′ is a silane and A is a silicate oligomer and the B′—B′ bond is a siloxy bond.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that B═B″—B″; B″ is a silane and A is a silicate oligomer and the B″—B″ bond is a silicon-silicon bond.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that siloxane bridges are formed between two silicate oligomers and whereby the polymer Abₓ is more flexible than structurally related materials of form A_{y}

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that siloxane bridge are of the form —OSi(CH₃)₂O— and the material is hydrophobic.

The present invention further provides that these silica based polymer comprise by siloxane bridges interconnected silicate oligomers (poly oligosiloxysilane), with the general formulae Abₓ whereby b is a siloxane bridge and A is a silicate oligomer or comprise by siloxane bridges interconnected silicate oligomers (poly oligosiloxysilane), with the general formulae [Abₓ+b_{y}] whereby b is a siloxane bridge and A is a silicate oligomer, whereby x=4; whereby x=2-6; whereby x=2.5-5.5; whereby x=3-5 or whereby x=3.5-4.5 and that is characterized in that siloxane bridge are of the form —OSi(CH₃)₂O— and the material is very hydrophobic.

Another aspect of the present invention is a silica based polymer material comprising by siloxane bridges (-b-) interconnected silicate oligomers (A)(poly oligosiloxysilane) whereby

a. the silicate oligomers (A) can be chosen from the following groups of silicate oligomers:
i. single ring silicate oligomers of general formula A=[SiₙO₃ₙ₊₁]* with n=3, 4, 5, 6, 7, 8, 9
ii. linear chain silicate oligomers of general formula A=[SiₙO₃ₙ₊₁]* with n=1, 2, 3, 4, 5, 6, 7, 8
iii. linear chain silicate polymers of general formula A=[SiₙO₃ₙ₊₁]* with 20<n<∞
iv. linear double chain silicate polymers of general formula A=[Si₂ₙO₅ₙ₊₂]* with 20<n<∞
v. six-ring type linear double chain silicate polymers of general formula A=[Si₄ₙO₁₁ₙ₊₂]* with 20<n<∞
vi. double chain silicate polymers of general formula A=[SiₙO_{y}]*, with 20<n<∞; 5n/2+1≦y≦3n+1
vii. silicate oligomers of general formula A=[SiₙO_{y}]* with 1<n≦40; 2n+1≦y≦3n+1
viii. more preferably the double ring silicate oligomers of general formula A=[SiₙO_{5n/2}]* with n=6, 8, 10, 12, 14, 16
   *for sake of clarity Hydrogen atoms in the formulae of A are omitted.

b. the silane linker molecule (B) can be chosen from the following groups of silanes:
i. silanes of form SiWXYZ whereby 2, 3 or 4 of the groups W, X, Y, Z are independently from the group of reactive leaving groups (rlg) (with the reactive leaving groups (rlg) independently from: H, OH, Cl, Br, I, NHR, NR₂, OSi(R)₃, NSi(R)₃, OSn(R)₃, OSb(R)₃ or OSi(R)₂H, OR, (with R independently from: methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl, dibromoethyl or any organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, cyclic alkyne or their derivates) and whereby the remaining 0, 1 or 2 groups W, X, Y, Z are independently from the organic groups of one of the following types: H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, cyclic alkyne or their derivates.
ii. Preferably silanes of form SiWXYZ whereby 2, 3 or 4 of the groups X, Y, Z, A are independently from the group of reactive leaving groups (rlg) (with the reactive leaving groups (rlg) independently from: Cl, Br, NR₂, OR, (with R methyl, ethyl, vinyl, allyl, isopropyl, propyl, isobutyl, butyl, phenyl, benzyl, cyclopentyl, cyclohexyl) and whereby the remaining 0, 1 or 2 groups W, X, Y, Z are independently from the organic groups of one of the following types: H, methyl, ethyl, vinyl, allyl, isopropyl, propyl, isobutyl, butyl, phenyl, benzyl, cyclopentyl, cyclohexyl, alkyl, alkenyl, aryl, arenyl, haloalkyl, haloaryl, fluoroalkyl, fluoroaryl.
iii. More preferably silanes of form SiWXYZ whereby 2, 3 or 4 of the groups X, Y, Z, A are independently from the group of reactive leaving groups (rlg) (with the reactive leaving groups (rlg) independently from: Cl, Br, OR, (with R methyl, ethyl, isopropyl or propyl) and whereby the remaining 0, 1 or 2 groups W, X, Y, Z are independently from the organic groups of one of the following types: H, methyl, ethyl, vinyl, allyl, isopropyl, propyl, isobutyl, butyl, phenyl, benzyl, cyclopentyl or cyclohexyl.
iv. more preferably silanes of form SiWXYZ whereby 2, 3 or 4 of the groups X, Y, Z, A are independently from the group of reactive leaving groups (rlg) (with the reactive leaving groups (rlg) Cl, and whereby the remaining 0, 1 or 2 groups W, X, Y, Z are independently from the organic groups of one of the following types: H, methyl, ethyl, vinyl, allyl,
v. Most preferably silanes chosen from: SiCl₂(CH₃)₂, SiCl₂(CH₃)H, SiCl₂H₂, SiCl₃(CH₃), SiCl₃H, SiCl₄.
   c. The synthesis of the poly oligosiloxysilane consist of the following steps:
i. Synthesize or take a suitable silicate oligomer containing material. This material
1. Preferentially consists of only one type of silicate oligomers
2. Preferentially possesses ordering of the silicate oligomers
3. Is preferentially porous or poses some degree of flexibility that could allow small molecules to diffuse or adsorb into the material
ii. Optionally the silicate oligomers can be suspended into a solvent or a mixture of solvents
iii. Optionally the silicate oligomers can be crystallized or recrystallized
iv. Optionally excess template could be removed from the silicate oligomer material, to the silicate oligomer suspension or to the reaction vessel containing the silicate oligomer material
v. If a solvent is present
1. And the silicate oligomers are suspended in a solvent, the solvent should preferentially be removed
2. If a solvent is present in the pores of the silicate oligomer material this solvent could optionally be removed
3. if the solvent is water, an alcohol or an organic acid, this solvent should preferably be removed
i. If the silicate oligomers or the reaction vessel would contain water or traces of water this water should preferentially be removed, after removal of this water the silicate oligomers should preferentially have a certain degree of ordering. Water should preferentially be removed
1. By applying vacuum
a. Preferentially at a pressure below 10 mbar
b. More preferentially at a pressure below 1 mbar

### At a Temperature

a. Preferentially below 100° C.
b. More preferably below 60° C.
c. In some cases even more preferably at a temperature below 30° C.
2. By drying with a gas flow
a. An inert gas flow
b. Preferentially a dry air flow
c. More preferentially a dry inert gas flow

At a temperature

a. Preferentially at a temperature below 100° C.

b. More preferably at a temperature below 60° C.

c. In some cases even more preferably at a temperature below 30° C.
vii. Optionally an adsorbent capable of adsorbing

### 1. Water

2. Reactive leaving groups from the silanes
Could be added to the silicate oligomer material, to the silicate oligomer suspension or to the reaction vessel containing the silicate oligomer material
viii. The silicate oligomer material could be added to the silanes, but more preferentially one or more silanes (B) could be added to the silicate oligomer material, to the silicate oligomer suspension or to the reaction vessel containing the silicate oligomer material. The silanes could be added
   1. As a solid
   2. In a supercritical state
   3. as a solution or a suspension in an organic liquid
   4. as a solution or a suspension in an organic amine
   5. More preferentially in the liquid phase
   6. More preferentially in the gas phase
ix. After the formation of the poly oligosiloxysilanes excess silane (B) or silane oligomers B_{y} (with y>1) could optionally be removed
x. After the formation of the poly oligosiloxysilanes water could optionally be added in gas, liquid or solid state.
xi. After and/or during the formation of the poly oligosiloxysilanes the formed H-(rlg) molecules could optionally be removed
ii. After the formation of the poly oligosiloxysilanes removing of the templates is an optional synthesis step
xiii. If solvent molecules are present in any of the reaction steps, these solvent molecules could optionally be removed
xiv. Any of the above steps i to xiii could optionally be repeated
v. The order of the above mentioned necessary, optional and preferential synthesis steps i to xiii is not a fixed order, but only more or less a guideline for good practice
xvi. At the moment of the addition of silanes to the silicate oligomer material, to the silicate oligomer suspension or to the reaction vessel containing the silicate oligomer material
1. crystalline matrix or semicrystalline matrix containing silicate oligomers are preferred over other non ordered silicate oligomer materials or silicate oligomer suspensions
2. Preferentially there should be a way for the silane molecules to diffuse towards all or most of the silicate oligomers
3. Preferentially there should not be any or only a limited amount of water that could come into contact with the silanes prior to the formation of the poly oligosiloxysilanes
4. The temperature of the reaction vessel should not be too high in order to reduce the formation of b_{y} oligomers and bₙ polymers. The temperature should be, dependent on the source of silicate oligomer materials and dependent on the silane,
   a. Preferentially below 150° C.
   b. More preferentially below 100° C.
   c. More preferentially between −50° C. and +60° C.
   d. More preferentially below 30° C.
5. In the (preferentially ordered) silicate oligomer material prior to the addition of the silanes a large fraction of the individual terminal oxygen atoms on the silicate oligomers have
a. preferably minimum one terminal oxygen on minimum one of the other silicate oligomers at a distance of between 0.17 nm and 0.6 nm
b. more preferably minimum one terminal oxygen on minimum one of the other silicate oligomers at a distance of between 0.17 nm and 0.35 nm
c. more preferably minimum one terminal oxygen on minimum one of the other silicate oligomers at a distance of between 0.22 nm and 0.3 nm
d. most preferably exactly one terminal oxygen on one of the other silicate oligomers at a distance of between 0.22 nm and 0.3 nm
   Some embodiments of the invention are set forth in claim format directly below:
1. A silica based polymer material comprising by siloxane bridges interconnected silicate oligomers (poly oligosiloxysilane).
2. A silica based polymer material consisting essentially of by siloxane bridges interconnected silicate oligomers.
3. A silica based polymer material consisting of by siloxane bridges interconnected silicate oligomers.
4. A silica based polymer material according to embodiments 1 to 3, with the general formulae of A and Abₓ whereby B is a silane and A is a silicate oligomer
5. A silica based polymer material according to embodiments 1 to 3, with the general formulae of A and Abₓ whereby B′═B—B; B is a silane and A is a silicate oligomer and the B—B bond is a siloxy bond.
6. The polymer according to embodiment 4, whereby for the silane (B) compounds linking two double ring silicate oligomers (A) the general formulae for the poly oligosiloxysilane compounds are:
   Silane (B) linking 2 silicate oligomers providing an Ab_{n/2} polymer or
   Silane (B) linking 3 silicate oligomers providing an Ab_{n/3} polymer
   with A=[SiₙO_{5n/2}] and with n=6, 8, 10, 12, 14, 16
7. The polymer according to embodiment 4, whereby for the silane (B) compounds linking two single ring silicate oligomers (A) the general formulae for the poly oligosiloxysilane compounds are:
   Silane (B) linking 2 silicate oligomers providing an Abₓ polymer or
   Silane (B) linking 3 silicate oligomers providing an Ab_{2n/3} polymer
   with A=[SiₙO₃ₙ] and with n=3, 4, 5, 6, 7, 8, 9
8. The polymer according to embodiment 4, whereby for the silane (B) compounds linking linear chain silicate oligomers (A) the general formulae for the poly oligosiloxysilane compounds are:
   Silane (B) linking 2 silicate oligomers providing an Abₙ₊₁ polymer or
   Silane (B) linking 3 silicate oligomers providing an Ab_{(2n+2)/3} polymer
   with A=[Siₙ O₃ₙ₊₁] and with n=1, 2, 3, 4, 5, 6, 7, 8,
9. The polymer according to embodiment 4, whereby for the silane (B) compounds linking linear chain silicate polymers (A) the general formulae for the poly oligosiloxysilane compounds are:
   Silane (B) linking 2 silicate oligomers providing an Abₙ₊₁ polymer or
   Silane (B) linking 3 silicate oligomers providing an Ab_{(2n+2)/3} polymer or
   Silane (B) linking 5 silicate oligomers providing an Ab_{(2n+2)/5} polymer
   with A=[SiₙO₃ₙ₊₁] and with 20<n<∞
10. The polymer according to embodiment 4, whereby for the silane (B) compounds linking ladder type linear double chain silicate polymers (A) the general formulae for the poly oligosiloxysilane compounds are:
   Silane (B) linking 2 silicate oligomers providing an Abₙ₊₂ polymer or
   Silane (B) linking 3 silicate oligomers providing an Ab_{(2n+4)/3} polymer
   with A=[Si₂ₙO₅ₙ₊₂] and with 20<n<∞
11. The polymer according to embodiment 4, whereby for the silane (B) compounds linking six-ring type linear double chain silicate polymers (A) the general formulae for the poly oligosiloxysilane compounds are:
Silane (B) linking 2 silicate oligomers providing an Ab₃ₙ₊₂ polymer or
   Silane (B) linking 3 silicate oligomers providing an Ab₃ₙ₊₂ polymer
   with A=[Si₄ₙO₁₁ₙ₊₂] and with 20<n<∞
12. The polymer according to embodiment 4, whereby for the silane (B) compounds linking double chain silicate polymers (A) the general formulae for the poly oligosiloxysilane compounds are:
   Silane (B) linking 2 silicate oligomers providing an Abₓ polymer or
   Silane (B) linking 3 silicate oligomers providing an Ab_{2x/3} polymer or
   Silane (B) linking 5 silicate oligomers providing an Ab_{2x/5} polymer
   with A=[SiₙO_{y}], with 20<n<∞; 5n/2+1≦y≦3n+1; x=y−2n
13. The polymer according to embodiment 4, whereby for the silane (B) compounds linking silicate oligomers (A) the general formulae for the poly oligosiloxysilane compounds are:
   Silane (B) linking 2 silicate oligomers providing an Abₓ polymer or
   Silane (B) linking 3 silicate oligomers providing an Ab_{2x/3} polymer or
   Silane (B) linking 5 silicate oligomers providing an Ab₂₁₅ polymer
   with A=[SiₙO_{y}], with 1<n≦40; 2n+1≦y≦3n+1; x=y−2n
14. The polymer according to any one of the preceding embodiments 1 to 13, wherein the silicate oligomer building blocs are crystalline.
15. The polymer according to any one of the preceding embodiments 1 to 14, wherein silicate oligomers, which are interconnected by siloxane bridges, form silica based nano needles or nano fibers with a diameter or with a thickness between 0.8-3 nm, preferably 0.8 to 1.5 nm and preferable less then 5 μm long.
16. The polymer according to any one of the preceding embodiments 1 to 15, wherein silicate oligomers, which are interconnected by siloxane bridges, form silica based nano needles or nano fibers with a diameter or with a thickness between 0.8-3 nm, preferably 0.8 to 1.5 nm and preferable less then 5 μm long and with less then 4 silanol groups per nm of length, preferably less then 2 silanol groups per nm of length.
17. The polymer according to any one of the preceding embodiments 1 to 16, wherein silicate oligomers, which are interconnected by siloxane bridges, form silica based nano needles or nano fibers with a diameter or with a thickness between 0.8-3 nm, preferably 0.8 to 1.5 nm and preferable less then 5 μm long and with hydride or organic groups connected to the silica core structure.
18. The polymer according to any one of the preceding embodiments 1 to 17, wherein the nano needles or nano fibers more rigid than typical poly dimethyl siloxane (PDMS) polymers
19. The polymer to any one of the preceding embodiments 1 to 14, wherein the silicate oligomers interconnected by siloxane bridges in the form of microporous silica polymers materials with a pore size in the range of 0.2 to 2 nm, preferably 0.2 to 1 nm.
20. The polymer to any one of the preceding embodiments 1 to 14, wherein the silicate oligomers interconnected by siloxane bridges in the form of microporous silica polymers materials with pores formed by six, eight, nine, ten, twelve, fourteen, fifteen, sixteen, eighteen, twenty, twenty-one or twenty-four silicon atoms.
21. The polymer according to any one of the preceding embodiments 1 to 14 or according to any one of the preceding embodiments 19 to 20, wherein silicate oligomers, which are interconnected by siloxane bridges, in the form of microporous silica polymers materials with less then 4 silanol groups per nm² of BET surface area, preferably less then 2 silanol groups per nm² of BET surface area, more preferably less then 1 silanol groups per nm² of BET surface area, most preferably less then 0.5 silanol groups per nm² of BET surface area.
22. The polymer according to any one of the preceding embodiments 1 to 14 or according to any one of the preceding embodiments 19 to 21, wherein silicate oligomers, which are interconnected by siloxane bridges, in the form of microporous silica polymers materials with hydride or organic groups connected to the silica core structure.
23. A membrane formed by the polymer according to any one of the preceding embodiments 1 to 22.
24. A membrane comprising the polymer according to any one of the preceding embodiments 1 to 22.
25. A membrane consisting essentially of the polymer according to any one of the preceding embodiments 1 to 22.
26. The polymer or the membrane, according to any one of the preceding embodiments 1 to 25, characterized in that it is organic solvent durable or resistant
27. The polymer or the membrane, according to any one of the preceding embodiments 1 to 25, characterized in that it is fire durable or resistant
28. Use of polymer or the membrane, according to any one of the preceding embodiments 1 to 27, for enforcing other polymers, fire retardation or cross linking polymers.
29. Use of polymer or the membrane, according to any one of the preceding embodiments 1 to 27, in a process of gas exchange, adsorption of organic molecules, adsorption of gasses, exchange of organic molecules, water purification, gas purification
30. Use of polymer or the membrane, according to any one of the preceding embodiments 1 to 27, as a catalys, as a catalyst support in catalysis, for spin-coating of thin films, for spin-coating of thin films with low k dielectric layers in integrated circuit applications, as an active component in sensors, as (super)hydrophobic anti-ice coating for instance on airplanes and windmills, as anti-fouling coating for instance inside pipelines or as anti-dirt coating.
   Some embodiments of the invention are set forth in claim format directly below:
1. A process of forming or a method for producing a silica based polymer, characterized in that the silica based polymer is formed by reacting said silicate oligomers (A) by silane compounds (B) to form silica based polymers that comprise silicate oligomers interconnected by siloxane bridges or siloxane bonds with the silane compounds.
2. The process or method according to embodiment 1, characterized in that it is a low temperature process with the reaction between said silicate oligomers and said silane compounds being at a temperature less than 150° C., preferably less than 100° C., more preferably less than 60° C. and most preferably less than 30° C.
3. The process or method according to any one of the preceding embodiments 1 to 2, characterized in that silicate oligomers are crystalline.
4. The process or method according to any one of the preceding embodiments 1 to 2, characterized in that silicate oligomers are chain or double chain silicate polymers
5. The process or method according to any one of the preceding embodiments 1 to 2, characterized in that silicate oligomers are structurally defined as silicate species of formula: [SiₙO_{y}Hₓ]^{a} with 3≦n≦40; 2n≦y≦3n+1; 0≦x≦4n+4 and −3n−1≦a≦3n+1.
6. The process or method according to any one of the preceding embodiments 1 to 2, characterized in that silicate oligomers are chain silicate polymers with formula selected from [SiₙO₃ₙ₊₁Hₓ]^{a-2n-2} with 20≦n≦∞; 0≦x≦4n+4
7. The process or method according to any one of the preceding embodiments 1 to 2, characterized in that silicate oligomers are double chain silicate polymers with a general formula: [SiₙO_{y}Hₓ]^{a} with 20≦n≦∞; 5n/2≦y<3n+1; 0≦x≦4n+4; −x−2n−2a<x−2n−2.
8. The process or method according to any one of the preceding embodiments 1 to 2, characterized in that silicate oligomers are selected of the group consisting of double ring silicate oligomers (double tree ring hexamers (D3R); double four ring octamers (D4R); double five ring decamers (D5R); double six ring dodecamers (D6R), double seven ring tetradecamers (D7R); double eight ring octadecamers (D8R)), cyclic silicate oligomers (tree ring trimers (3R); four ring tetramers (4R); five ring pentamers (5R); six ring hexamers (6R); seven ring heptamers (7R); eight ring octamers (8R); nine ring nonamers (9R)), linear silicate oligomers (silicate monomers; silicate dimers; silicate trimers; silicate tetramers; silicate pentamers; silicate hexamers; silicate heptamers; silicate octamers), linear chain silicate polymers and double chain silicate polymers.
9. The process or method according to any one of the preceding embodiments 1 to 2, characterized in that silicate oligomers are selected of the group consisting of nesosilicates, sorosilicates and cyclosilicates
10. The process or method according to any one of the preceding embodiments 1 to 2, characterized in that silicate oligomers are Inosilicates or Pyroxenes.
11. The process or method according to any one of the preceding embodiments 1 to 2, wherein the silanes have a base structure: SiX₄₋ₐRₐ, wherein a=0, 1 or 2; X═H, Cl, Br, I or OR′ and with R′, R being hydride, aliphatic or aromatic organic groups; for instance selected of methyl, ethyl, isopropyl, propyl, buthyl, phenyl, benzyl, cyclohexyl, or octyl
12. The process or method according to any one of the preceding embodiments 1 to 2, wherein the silanes have a base structure: SiX₄₋ₐRₐ, wherein a=0, 1 or 2; X═H, Cl, Br, I or OR′ and with R′, R being hydride, aliphatic or aromatic organic groups; for instance selected of methyl, ethyl, isopropyl, propyl, buthyl, phenyl, benzyl, cyclohexyl, or octyl
13. The process or method according to any one of the preceding embodiments 1 to 2, wherein the silanes have a base structure: SiX₄₋ₐRₐ, wherein a=0, 1 or 2; X═H and with R being a hydride, aliphatic or aromatic organic group; for instance selected of methyl, ethyl, isopropyl, propyl, buthyl, phenyl, benzyl, cyclohexyl, or octyl
14. The process or method according to any one of the preceding embodiments 1 to 2, wherein the silanes have a base structure: SiX₄₋ₐRₐ, wherein a=0, 1 or 2; X═Cl and with R being a hydride, aliphatic or aromatic organic group; for instance selected of methyl, ethyl, isopropyl, propyl, buthyl, phenyl, benzyl, cyclohexyl, or octyl
15. The process or method according to any one of the preceding embodiments 1 to 2, wherein the silanes have a base structure: SiX₄₋ₐRₐ, wherein a=0, 1 or 2; X═Br and with R being a hydride, aliphatic or aromatic organic group; for instance selected of methyl, ethyl, isopropyl, propyl, buthyl, phenyl, benzyl, cyclohexyl, or octyl
16. The process or method according to any one of the preceding embodiments 1 to 2, wherein the silanes have a base structure: SiX₄₋ₐRₐ, wherein a=0, 1 or 2; X═I and with R being a hydride, aliphatic or aromatic organic group; for instance selected of methyl, ethyl, isopropyl, propyl, buthyl, phenyl, benzyl, cyclohexyl, or octyl
17. The process or method according to any one of the preceding embodiments 1 to 2, wherein the silanes have a base structure: SiX₄₋ₐRₐ, wherein a=0, 1 or 2; X═OR′ and with R, R′ being hydride, aliphatic or aromatic organic groups; for instance selected of methyl, ethyl, isopropyl, propyl, buthyl, phenyl, benzyl, cyclohexyl, or octyl
18. The process or method according to any one of the preceding embodiments 1 to 2, wherein the silanes have a base structure: SiX₄₋ₐRₐ, wherein a=1 or 2; X═OH and with R being a hydride, aliphatic or aromatic organic group; for instance selected of methyl, ethyl, isopropyl, propyl, buthyl, phenyl, benzyl, cyclohexyl, or octyl
19. The process or method according to any one of the preceding embodiments 1 to 2, wherein the silanes have a base structure: SiX₄₋ₐRₐ, wherein a=0, 1 or 2; X═Cl and with R being a hydride, aliphatic or aromatic organic group; for instance selected of methyl, ethyl, isopropyl, phenyl, benzyl, cyclohexyl or octyl
20. The process or method according to any one of the preceding embodiments 1 to 2, wherein the silane compound has the general formula of SiₙO_{b}X₂ₙ₊₂₋ₐAₐ whereby a>0; n>0; b □□□; X═H, OH, Cl, Br, I, or OR′ and A=H or R with R, R′ being aliphatic or aromatic organic groups for instance selected of methyl, ethyl, isopropyl, propyl, buthyl, phenyl, benzyl, cyclohexyl, or octyl
21. The process or method according to any one of the preceding embodiments 1 to 2, wherein the silane compound has the general formula of SiₙX₂ₙ₊₂₋ₐAₐ whereby a>0; n>0; b □□□; X═H, OH, Cl, Br, I, or OR′ and A=H or R with R, R′ being aliphatic or aromatic organic groups for instance selected of methyl, ethyl, isopropyl, propyl, buthyl, phenyl, benzyl, cyclohexyl, or octyl
22. The process or method according to any one of the preceding embodiments 1 to 2, wherein the silane compound is mono-, di-, tri- or tetra-silane.
23. The process or method according to any one of the preceding embodiments 1 to 2, wherein the silane compound to connect the silicate oligomers, are silicon containing molecules of the form of SiXYZA whereby minimum 2 of the groups X, Y, Z, A are independently from the group of reactive leaving groups (H, OH, Cl, Br, I, OSi(Me)₃, NSi(Me)₃, OSn(Me)₃, OSb(Me)₃ or OSi(Me)₂H, OR, (with R methyl, ethyl, isopropyl, propyl, buthyl, phenyl, benzyl, cyclohexyl, or octyl) and whereby the remaining 0, 1 or 2 groups X, Y, Z, A are independently from the organic groups of one of the following types: aliphatic organic group, aromatic organic group, alcohol, thiol, phenolic compound, amine, keton, ester, ether, amide, cyanate, nitrile, sulfate, sulfonate, halogenated organic compound, epoxide, phosforous containing organic compound, organic acid, organic acid chloride, aldehyde, anhydride, alkene, alkyne, cyclic alkane, cyclic alkene, cyclic alkyne or their derivates
24. The process or method according to any one of the preceding embodiments 1 to 2, wherein the silane compound to connect the silicate oligomers, are silicon containing molecules of the form of SiXYZA whereby minimum 2 of the groups X, Y, Z, A are independently from the group of reactive leaving groups (H, Cl, Br, I, OR, (with R methyl, ethyl, isopropyl, propyl, buthyl, phenyl, benzyl, cyclohexyl, or octyl) and whereby the remaining 0, 1 or 2 groups X, Y, Z, A are independently from the organic groups of one of the following types: aliphatic organic group, aromatic organic group, alcohol, thiol, phenolic compound, amine, keton, ester, ether, amide, cyanate, nitrile, sulfate, sulfonate, halogenated organic compound, epoxide, phosforous containing organic compound, organic acid, organic acid chloride, aldehyde, anhydride, alkene, alkyne, cyclic alkane, cyclic alkene, cyclic alkyne or their derivates
25. The process or method according to any one of the preceding embodiments 1 to 2, wherein the silane compound to connect the silicate oligomers, are silicon containing molecules of the form of SiXYZA whereby minimum 2 of the groups X, Y, Z, A are independently from the group of reactive leaving groups (Cl, Br) and whereby the remaining 0, 1 or 2 groups X, Y, Z, A are independently from the organic groups of one of the following types: aliphatic organic group, aromatic organic group, alcohol, thiol, phenolic compound, amine, keton, ester, ether, amide, cyanate, nitrile, sulfate, sulfonate, halogenated organic compound, epoxide, phosforous containing organic compound, organic acid, organic acid chloride, aldehyde, anhydride, alkene, alkyne, cyclic alkane, cyclic alkene, cyclic alkyne or their derivates
26. The process or method according to any one of the preceding embodiments 1 to 2, wherein the silane compound to connect the silicate oligomers, is a silane comprising one silicon atom
27. The process or method according to any one of the preceding embodiments 1 to 2, wherein the silane compound to connect the silicate oligomers, is a silane comprising multiple silicon atoms with minimum two reactive leaving groups on said the silane.
28. The process or method according to any one of the preceding embodiments 1 to 27, characterized in that the reaction is in the absence of water so that the silane compounds can only react with silica oligomer but not with itself
29. The process or method according to any one of the preceding embodiments 1 to 27, characterized in that the reaction is in a reaction medium with a water/silane compounds ratio of less than 4/1 so that the silane compounds can only react with silica oligomer but not with itself.
30. The process or method according to any one of the preceding embodiments 1 to 27, characterized in that the reaction is in a reaction medium with a water/silane compounds ratio of less than 1/1 so that the silane compounds can only react with silica oligomer but not with itself.
31. The process or method according to any one of the preceding embodiments 1 to 27, characterized in that the reaction is in a reaction medium with a water/silane compounds ratio of less than 0.25/1 so that the silane compounds can only react with silica oligomer but not with itself.
32. The process or method according to any one of the preceding embodiments 1 to 27, characterized in that the reaction is in is in a reaction medium with a water/silane compounds molecular ratio of less than 0.1 so that the silane compounds can only react with silica oligomer but not with itself.
33. The process or method according to any one of the preceding embodiments 1 to 32, characterized in that the reaction medium comprises solid silane compounds and solid silicate oligomers in gas atmosphere which reaction medium is heated to melt said silane or characterized in that the silane compounds are in a gas atmosphere
34. The process or method according to any one of the preceding embodiments 1 to 32, characterized in that the reaction medium comprises solid silane compounds and silicate oligomers in a vacuum which reaction medium is heated to melt said silane.
35. The process or method according to any one of the preceding embodiments 1 to 32, characterized in that the reaction medium comprises liquid silane compounds and solid silicate oligomers in gas atmosphere which reaction whereby the contact between the silane compounds and silicate oligomers is through the gas phase.
36. The process or method according to any one of the preceding embodiments 1 to 32, characterized in that the reaction medium comprises liquid silane compounds and silicate oligomers in which silicate oligomers and silane liquid are in direct contact with each other.
37. The process or method according to any one of the preceding embodiments 1 to 32, characterized in that the silicate oligomers and silane are in an organic fluid.
38. The process or method according to any one of the preceding embodiments 1 to 32, characterized in that the silicate oligomers and silane are in a water free organic fluid.
39. The process or method according to any one of the preceding embodiments 1 to 32, characterized in that the silicate oligomers and silane are in an organic fluid with a maximum water content so that the water/silane ratio of less than 4/1; preferably less than 1/1; more preferably less than 0.25/1 and most preferably less then 0.1/1.
40. The process or method according to any one of the preceding embodiments 1 to 40, wherein the fluid is a liquid.
41. The process or method according to any one of the preceding embodiments 1 to 40, wherein the fluid is a gas.
42. The process or method according to any one of the preceding embodiments 1 to 40, wherein the fluid comprises a suspension of silicate oligomers.
43. The process or method according to any one of the preceding embodiments, wherein the silicate oligomer starting material is comprised in a silicate hydrate.
44. The process or method according to any one of the preceding embodiments, wherein the silicate oligomer starting material is comprised in a silicate hydrate of which water is removed preceding to the process or method or during a reaction step of said the process or method.
45. The process or method according to any one of the preceding embodiments, wherein the siloxane bond formation between different silicate oligomers (A) without excluding the A-B bond formation is controlled or suppressed by stabilization of the silicate oligomers (A).
46. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
   f) removal of template
47. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
   f) removal of template
   g) repetition of step c-e
48. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
49. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
   f) repetition of step c-e
50. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
   f) addition of water
   g) repetition of step b-e
51. The process or method according to any one of the preceding embodiments 1 to 45, wherein the procedure involves the following steps:
   a) The synthesis of silicate oligomers
   b) removal of water from the silicate oligomers
   c) addition of the silane
   d) reaction between the silicate oligomers and the silanes
   e) removal of excess silane
   f) addition of water
   g) repetition of step b-e
   h) removal of template
52. The process or method according to any one of the previous embodiments 1-51 to produce a silica based polymer material comprising by siloxane bridges interconnected silicate oligomers (poly oligosiloxysilane).
53. The process or method according to any one of the previous embodiments 1-51 to produce a silica based polymer material consisting essentially of by siloxane bridges interconnected silicate oligomers.
54. The process or method according to any one of the previous embodiments 1-51 to produce a silica based polymer material consisting of by siloxane bridges interconnected silicate oligomers.
55. The process or method according to any one of the previous embodiments 1-54 to produce a silica based polymer material with the general formulae of A and Abₓ whereby B is a silane and A is a silicate oligomer
56. The process or method according to any one of the previous embodiments 1-54 to produce a silica based polymer material with the general formulae of A and Ab′ₓ whereby B′═B—B; B is a silane and A is a silicate oligomer and the B—B bond is a siloxy bond.
57. The process or method according to any one of the previous embodiments 1-54 to produce a silica based polymer material whereby for the silane (B) compounds linking two double ring silicate oligomers (A) the general formulae for the poly oligosiloxysilane compounds are:
   Silane (B) linking 2 silicate oligomers providing an Ab_{n/2} polymer or
   Silane (B) linking 3 silicate oligomers providing an Ab_{n/3} polymer or
   Silane (B) linking 4 silicate oligomers providing an Ab_{n/4} polymer
   with A=[SiₙO_{5n/2}] and with n=6, 8, 10, 12, 14, 16
58. The process or method according to any one of the previous embodiments 1-54 to produce a silica based polymer material whereby for the silane (B) compounds linking two single ring silicate oligomers (A) the general formulae for the poly oligosiloxysilane compounds are:
   Silane (B) linking 2 silicate oligomers providing an Abₙ polymer or
   Silane (B) linking 3 silicate oligomers providing an Ab_{2n/3} polymer or
   Silane (B) linking 4 silicate oligomers providing an Ab_{n/2} polymer
   with A=[SiₙO₃ₙ] and with n=3, 4, 5, 6, 7, 8, 9
59. The process or method according to any one of the previous embodiments 1-54 to produce a silica based polymer material whereby for the silane (B) compounds linking linear chain silicate oligomers (A) the general formulae for the poly oligosiloxysilane compounds are:
   Silane (B) linking 2 silicate oligomers providing an Abₙ₊₁ polymer or
   Silane (B) linking 3 silicate oligomers providing an Ab_{(2n+2)/3} polymer or
   Silane (B) linking 4 silicate oligomers providing an Ab_{(n+1)/2} polymer
   with A=[SiₙO₃ₙ₊₁] and with n=1, 2, 3, 4, 5, 6, 7, 8,
60. The process or method according to any one of the previous embodiments 1-54 to produce a silica based polymer material whereby for the silane (B) compounds linking linear chain silicate polymers (A) the general formulae for the poly oligosiloxysilane compounds are:
   Silane (B) linking 2 silicate oligomers providing an Abₙ₊₁ polymer or
   Silane (B) linking 3 silicate oligomers providing an Ab_{(2n+2)/3} polymer or
   Silane (B) linking 4 silicate oligomers providing an Ab_{(n+1)/2} polymer or
   Silane (B) linking 5 silicate oligomers providing an Ab_{(2n+2)/5} polymer or
   Silane (B) linking 6 silicate oligomers providing an Ab_{(n+1)/3} polymer
   with A=[Siₙ—O₃ₙ₊₁] and with 20<n<∞
61. The process or method according to any one of the previous embodiments 1-54 to produce a silica based polymer material whereby for the silane (B) compounds linking ladder type linear double chain silicate polymers (A) the general formulae for the poly oligosiloxysilane compounds are:
   Silane (B) linking 2 silicate oligomers providing an Ab_{n+2 polymer or}
   Silane (B) linking 3 silicate oligomers providing an Ab_{(2n+4)/3} polymer or
   Silane (B) linking 4 silicate oligomers providing an Ab_{(n+2)/2} polymer
   with A=[Si₂ₙO₅ₙ₊₂] and with 20<n<∞
62. The process or method according to any one of the previous embodiments 1-54 to produce a silica based polymer material whereby for the silane (B) compounds linking six-ring type linear double chain silicate polymers (A) the general formulae for the poly oligosiloxysilane compounds are:
   Silane (B) linking 2 silicate oligomers providing an Ab₃ₙ₊₂ polymer or
   Silane (B) linking 3 silicate oligomers providing an Ab_{(6n+4)/3} polymer or
   Silane (B) linking 4 silicate oligomers providing an Ab_{(3n+2)/2} polymer
   with A=[Si₄ₙO₁₁ₙ₊₂] and with 20<n<∞
63. The process or method according to any one of the previous embodiments 1-54 to produce a silica based polymer material whereby for the silane (B) compounds linking double chain silicate polymers (A) the general formulae for the poly oligosiloxysilane compounds are:
   Silane (B) linking 2 silicate oligomers providing an Abₓ polymer or
   Silane (B) linking 3 silicate oligomers providing an Ab_{2x/3} polymer or
   Silane (B) linking 4 silicate oligomers providing an Ab_{x/2} polymer or
   Silane (B) linking 5 silicate oligomers providing an Ab_{2x/5} polymer or
   Silane (B) linking 6 silicate oligomers providing an Ab_{x/3} polymer
   with A=[SiₙO_{y}], with 20<n<∞; 5n/2+1≦y≦3n+1; x=y−2n
64. The process or method according to any one of the previous embodiments 1-54 to produce a silica based polymer material whereby for the silane (B) compounds linking silicate oligomers (A) the general formulae for the poly oligosiloxysilane compounds are:
   Silane (B) linking 2 silicate oligomers providing an Abₓ polymer or
   Silane (B) linking 3 silicate oligomers providing an Ab_{2x/3} polymer or
   Silane (B) linking 4 silicate oligomers providing an Ab_{x/2} polymer or
   Silane (B) linking 5 silicate oligomers providing an Ab_{2x/5} polymer or
   Silane (B) linking 6 silicate oligomers providing an Ab_{x/3} polymer or
   Silane (B) linking 7 silicate oligomers providing an Ab_{2x/7} polymer or
   Silane (B) linking 8 silicate oligomers providing an Ab_{x/4} polymer or
   Silane (B) linking 10 silicate oligomers providing an Ab_{x/5} polymer or
   Silane (B) linking 12 silicate oligomers providing an Ab_{x/6} polymer
   with A=[SiₙO_{y}], with 1<n≦40; 2n+1≦y≦3n+1; x=y−2n
   Some embodiments of the invention are set forth in claim format directly below:
1) A silica based polymer comprising by siloxane bridges interconnected silicate oligomers, whereby said material is ordered, has long range ordering or locally ordered.
2) A silica based polymer according to claim 1, whereby the polymer is not a liquid and the polymer is not a gel material.
3) A silica based polymer according to any one of the claims 1 to 2, whereby the silica based polymer comprises by siloxane bridges interconnected silicate oligomers (poly oligosiloxysilane), with the general formulae Abₓ whereby b is a siloxane bridge and A is a silicate oligomer
4) A silica based polymer according to any one of the claims 1 to 2, whereby the silica based polymer comprises by siloxane bridges interconnected silicate oligomers (poly oligosiloxysilane), with the general formulae [Abₓ+b_{y}] whereby b is a siloxane bridge and A is a silicate oligomer
5) A silica based polymer according to any one of the claims 1 to 4, whereby the silica based polymer comprises local ordering or is locally ordered as demonstrable by pair correlation function analysis.
6) A silica based polymer according to any one of the claims 1 to 5, whereby the silica based polymer comprises local ordering or is locally ordered as demonstrable by Extended X-ray adsorption fine structure analysis.
7) A silica based polymer according to any one of the claims 1 to 6 whereby the silica based polymer comprises local ordering or is locally ordered as demonstrable by Infrared spectroscopy or Fourier transform infrared spectroscopy.
8) A silica based polymer according to any one of the claims 1 to 7, whereby the silica based polymer comprises local ordering or is locally ordered as demonstrable by RAMAN spectroscopy.
9) A silica based polymer according to any one of the claims 1 to 8, whereby the silica based polymer comprises local ordering or is locally ordered as demonstrable by N₂-fysisorption.
10) A silica based polymer according to any one of the claims 1 to 9, whereby the silica based polymer comprises local ordering or is locally ordered as demonstrable by ²⁹Si MAS NMR.
11) A silica based polymer according to any one of the claims 1 to 10 whereby the silica based polymer comprises local ordering or is locally ordered as demonstrable by 2D and 3D ²⁹Si NMR techniques.
12) A silica based polymer according to any one of the claims 1 to 11, whereby the silica based polymer comprises local ordering or is locally ordered as demonstrable by Shape selective adsorption of molecules
13) A silica based polymer according to any one of the claims 1 to 12, whereby the silica based polymer comprises local ordering or is locally ordered as demonstrable by adsorption sites with similar energy of adsorption for a specific molecules or for several specific molecules
14) A silica based polymer according to any one of the claims 1 to 13, whereby the silica based polymer comprises local ordering or is locally ordered as demonstrable by X-ray diffraction (WAXS):
15) A silica based polymer according to any one of the claims 1 to 14, whereby the silica based polymer comprises local ordering or is locally ordered as demonstrable by Small angle X-ray scattering.
16) A silica based polymer according to any one of the claims 1 to 15, whereby the silica based polymer comprises local ordering or is locally ordered as demonstrable by Electron diffraction.
17) A silica based polymer according to any one of the claims 1 to 16, whereby the silica based polymer comprises local ordering or is locally ordered as demonstrable by nanobeam Electron diffraction.
18) A silica based polymer according to any one of the claims 1 to 17, whereby the silica based polymer comprises long range ordering or is long range ordered as demonstrable by X-ray diffraction.
19) A silica based polymer according to any one of the claims 1 to 18, whereby the silica based polymer comprises long range ordering or is long range ordered as demonstrable by high resolution transmission electron microscopy
20) A silica based polymer according to any one of the claims 1 to 19, whereby the silica based polymer comprises long range ordering or is long range ordered as demonstrable by electron diffraction.
21) A silica based polymer according to any one of the claims 1 to 20, whereby the silica based polymer comprises long range ordering or is long range ordered as demonstrable by scanning electron diffraction microscopy.
22) A silica based polymer according to any one of the claims 1 to 21 whereby the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of H, OH, Cl, Br, I, NHR, NR₂, OSi(R)₃, NSi(R)₃, OSn(R)₃, OSb(R)₃ or OSi(R)₂H, OR, (with R selected from methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl and dibromoethyl or being an organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne) and whereby the remaining 0, 1 or 2 groups W, X, Y, Z are independently of each other selected from the organic groups consisting of H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene and cyclic alkyne.
23) A silica based polymer according to any one of the claims 1 to 21 whereby the siloxane bridge (b) is derived from a silane (B) or combination of silanes of form SiWXYZ whereby 2, 3 or 4 of the groups W, X, Y, Z are independently of each other selected from the group of reactive leaving groups (rlg) consisting of Cl, Br, NR₂, OR, (with R selected of the group consisting of methyl, ethyl, vinyl, allyl, isopropyl, propyl, isobutyl, butyl, phenyl, benzyl, cyclopentyl and cyclohexyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl, cyclohexyl, alkyl, alkenyl, aryl, arenyl, haloalkyl, haloaryl, fluoroalkyl and fluoroaryl.
24) A silica based polymer according to any one of the claims 1 to 21 whereby the siloxane bridge (b) is derived from a silane (B) or combination of form SiWXYZ whereby 2, 3 or 4 of the groups W, X, Y, Z are independently of each other selected from the group of reactive leaving groups (rlg) consisting of Cl, Br, OR, (with R selected of the group consisting of methyl, ethyl, isopropyl and propyl) and whereby the remaining 0, 1 or 2 groups W, X, Y, Z are independently of each other selected from the organic groups consisting of H, methyl, ethyl, vinyl, allyl, isopropyl, propyl, isobutyl, butyl, phenyl, benzyl, cyclopentyl and cyclohexyl.
25) A silica based polymer according to any one of the claims 1 to 21, whereby the siloxane bridge (b) is derived from a silane (B) or combination of silanes selected of SiCl₂(CH₃)₂, SiCl₂(CH₃)H, SiCl₂H₂, SiCl₃(CH₃), SiCl₃H and SiCl₄.
26) A silica based polymer according to any one of the claims 1 to 25, whereby silicate oligomer A is a D4R silicate octamer of formula [Si₈O₂₀H_{b}]^{b-8} with b selected from 0, 1, 2, 3, 4, 5, 6, 7, 8, 9, 10, 11, 12, 13, 14, 15 and 16
27) A silica based polymer according to any one of the claims 1 to 25, whereby each silicate oligomer A is a double ring silicate oligomer independently from each other of formula [SiₙO_{5n/2}H_{b}]^{b-n} with n being 6, 8, 10, 12, 14 or 16 and each b selected from 0 to 2n
28) A silica based polymer according to any one of the claims 1 to 25 with each silicate oligomer A is a ring silicate oligomer independently of formula [SiₙO₃ₙH_{b}]_{b-2n} with n=4, 5, 6, 7, 8 or 9 and each b independently from 0 to 4n
29) A silica based polymer according to any one of the claims 2 to 28 whereby x=4
30) A silica based polymer according to any one of the claims 2 to 28 whereby x=2-6
31) A silica based polymer according to any one of the claims 2 to 28 whereby x=2.5-5.5
32) A silica based polymer according to any one of the claims 2 to 28 whereby x=3-5
33) A silica based polymer according to any one of the claims 2 to 28 whereby x=3.5-4.5
34) A silica based polymer according to any one of the claims 1 to 33 whereby the structure of the polymer is structurally related to zeolite with the LTA topology but whereby the Oxygen atoms of the siloxane bonds (—O—) between the silicate cubes in the LTA zeolites are replaced by siloxane bridges (—O—Si(Y)(Z)—O—) formed by the silane molecule B and with Y and Z as defined in any one of the claims 22 to 24.
35) A silica based polymer according to any one of the claims 1 to 33 whereby the structure of the polymers is structurally related to zeolite whereby the oxygen atoms of siloxane bonds (—O—) between specific silicate oligomeric species in the zeolite are replaced by a siloxane bridge (—O—Si(Y)(Z)—O—) formed by the silane molecule B and with Y and Z as defined in any one of the claims 22 to 24.
36) A silica based polymer according to any one of the claims 1 to 35 whereby each A silicate oligomer is directly connected through siloxane bridges with eight other neighboring silicate oligomers.
37) A silica based polymer according to any one of the claims 1 to 35 whereby minimum 50% of the silicate oligomers is directly connected through siloxane bridges with exactly eight other neighboring silicate oligomers.
38) A silica based polymer according to any one of the claims 1 to 35 whereby minimum 80% of the silicate oligomers is directly connected through siloxane bridges with exactly eight other neighboring silicate oligomers.
39) A silica based polymer according to any one of the claims 1 to 35 whereby if a silicate oligomer is connected to another silicate oligomer through minimum one siloxane bridge, then in more than 50% of the cases, this connection consist of exactly one siloxane bridge.
40) A silica based polymer according to any one of the claims 1 to 35 whereby if a silicate oligomer is connected to another silicate oligomer through minimum one siloxane bridge, then in more than 75% of the cases, this connection consist of exactly one siloxane bridge.
41) A silica based polymer according to any one of the claims 1 to 35 whereby if a silicate oligomer is connected to another silicate oligomer through minimum one siloxane bridge, then in more than 90% of the cases, this connection consist of exactly one siloxane bridge.
42) A silica based polymer according to any one of the claims 1 to 35 whereby if a silicate oligomer is connected to another silicate oligomer through minimum one siloxane bridge, then in more than 95% of the cases, this connection consist of exactly one siloxane bridge.
43) A silica based polymer according to any one of the claims 1 to 42 whereby less than 20% of the connections between a silicate oligomers and another silicate oligomer consists of minimum 2 siloxane bridges.
44) A silica based polymer according to any one of the claims 1 to 43 whereby the siloxane bridges b connected to a silicate oligomers are connected to two silicate oligomers.
45) A silica based polymer according to any one of the claims 1 to 43 whereby minimum 50% of the siloxane bridges b connected to a silicate oligomer are connected to two silicate oligomers.
46) A silica based polymer according to any one of the claims 1 to 43 whereby minimum 75% of the siloxane bridges b connected to a silicate oligomer are connected to two silicate oligomers
47) A silica based polymer according to any one of the claims 1 to 43 whereby minimum 90% of the siloxane bridges b connected to a silicate oligomer are connected to two silicate oligomers
48) A silica based polymer according to any one of the claims 1 to 43 whereby minimum 95% of the siloxane bridges b connected to a silicate oligomer are connected to two silicate oligomers
49) A silica based polymer according to any one of the claims 1 to 48 whereby less than 25% of the siloxane bridges b connected to a silicate oligomer are connected to only one silicate oligomer.
50) A silica based polymer according to any one of the claims 1 to 48 whereby less than 10% of the siloxane bridges b connected to a silicate oligomer are connected to only one silicate oligomer.
51) A silica based polymer according to any one of the claims 1 to 33 whereby the structure of the individual polymers has a linear shape.
52) A silica based polymer according to any one of the claims 1 to 33 or according to claim 51, whereby each A silicate oligomer is directly connected through siloxane bridges with two other neighboring silicate oligomers.
53) A silica based polymer according to any one of the claims 1 to 33 or according to any one of the claims 51 to 52, whereby minimum 50% or the silicate oligomers is directly connected through siloxane bridges with exactly two other neighboring silicate oligomers.
54) A silica based polymer according to any one of the claims 1 to 33 or according to any one of the claims 51 to 52, whereby minimum 80% or the silicate oligomers is directly connected through siloxane bridges with exactly two other neighboring silicate oligomers.
55) A silica based polymer according to any one of the claims 1 to 33 or according to any one of the claims 51 to 52, whereby minimum 40% of the siloxane bridges involved in the bridging of silicate oligomers are involved in the bridging of neighboring silicate oligomers so that a linear shape structure if formed.
56) A silica based polymer according to any one of the claims 1 to 33 or according to any one of the claims 51 to 55, whereby a connection between a silicate oligomers consists of four siloxane bridges.
57) A silica based polymer according to any one of the claims 1 to 33 or according to any one of the claims 51 to 55, whereby minimum 50% of the connections between a silicate oligomers and another silicate oligomer consists of four siloxane bridges.
58) A silica based polymer according to any one of the claims 1 to 33 or according to any one of the claims 51 to 55, whereby minimum 80% of the connections between a silicate oligomers and another silicate oligomer is formed by or consists of four siloxane bridges.
59) A silica based polymer according to any one of the claims 1 to 33 or according to any one of the claims 51 to 55, whereby minimum 50% of the connections between a silicate oligomers and another silicate oligomer is formed by or consists of minimum 3 siloxane bridges.
60) A silica based polymer according to any one of the claims 1 to 33 or according to any one of the claims 51 to 55, whereby minimum 80% of the connections between a silicate oligomers and another silicate oligomer is formed by or consists of minimum 3 siloxane bridges.
61) A silica based polymer according to any one of the claims 1 to 33 or according to any one of the claims 51 to 55, whereby minimum 80% of the connections between a silicate oligomers and another silicate oligomer is formed by or consists of minimum 2 siloxane bridges.
62) A silica based polymer according to any one of the claims 1 to 33 or according to any one of the claims 51 to 61, whereby the siloxane bridges b connected to a silicate oligomers are connected to two silicate oligomers.
63) A silica based polymer according to any one of the claims 1 to 33 or according to any one of the claims 51 to 61, whereby minimum 30% of the siloxane bridges b connected to a silicate oligomers is connected to two silicate oligomers.
64) A silica based polymer according to any one of the claims 1 to 33 or according to any one of the claims 51 to 61, whereby minimum 75% of the siloxane bridges b connected to a silicate oligomers is connected to two silicate oligomers.
65) A silica based polymer according to any one of the claims 1 to 33 or according to any one of the claims 51 to 61, whereby minimum 90% of the siloxane bridges b connected to a silicate oligomers is connected to two silicate oligomers.
66) A silica based polymer according to any one of the claims 1 to 33 or according to any one of the claims 51 to 61, whereby minimum 50% of the siloxane bridges b connected to a silicate oligomers is connected to minimum two silicate oligomers.
67) A silica based polymer according to any one of the claims 51 to 66 whereby no siloxane bridges are formed between parallel linear silica based polymer chains

68) A silica based polymer according to any one of the claims 51 to 66 whereby the individual poly oligosiloxysilane chains, composed of silicate oligomers interconnected by siloxane bridges, form silica based nano needles or nano fibers with a diameter or with a thickness between 0.6 nm to 3 nm, preferably 0.8 nm to 1.5 nm and with a length preferable less than 5 □m long.
69) A silica based polymer according to any one of the claims 51 to 66 whereby the individual poly oligosiloxysilane chains, composed of silicate oligomers interconnected by siloxane bridges, form silica based nano needles or nano fibers with a diameter or with a thickness between 0.5 nm to 3 nm, preferably between 0.7 nm to 1.5 nm and with a length preferable less than 5 □m long and with less than 4 silanol groups per nm of length of the individual nano fiber or nano needle, preferably less than 2 silanol groups per nm of length of the individual nano fiber or nano needle.
70) A silica based polymer according to any one of the claims 51 to 66 wherein the nano needles or nano fibers are more rigid than typical poly dimethyl siloxane (PDMS) polymers
71) A silica based polymer according to any one of the claims 51 to 61 whereby less than 25% of the siloxane bridges between silicate oligomers form siloxane bridges between parallel linear silica based polymer chains
72) A silica based polymer according to any one of the claims 51 to 61 whereby less than 10% of the siloxane bridges between silicate oligomers form siloxane bridges between parallel linear silica based polymer chains
73) A silica based polymer according to any one of the claims 51 to 61 or according to any one of the claims 68 to 69 whereby more than 50% of the siloxane bridges b is involved is involved in more than two siloxane bonds
74) A silica based polymer according to any one of the claims 51 to 61 whereby more than 30% the siloxane bridges is involved in siloxane bridges between the parallel linear silica based polymer chains
75) A silica based polymer according to any one of the claims 51 to 61, whereby more than 60% the siloxane bridges is involved in siloxane bridges between parallel linear silica based polymer chains
76) A silica based polymer according to any one of the claims 51 to 61, whereby more than 20% of the silicon atoms of the silicate oligomers is involved in siloxane bridges between silicate oligomers in parallel linear silica based polymer chains
77) A silica based polymer according to any one preceding claims 1 to 25, whereby for the siloxane bridge (b) linking double ring silicate oligomers (A) the general formulae for the poly oligosiloxysilane compounds are: siloxane bridge (b) linking 2 silicate oligomers providing an Ab_{n/2} polymer or siloxane bridge (b) linking 3 silicate oligomers providing an Ab_{n/3} polymer
   with A=[SiₙO_{5n/d}]* and with n selected from 6, 8, 10, 12, 14 and 16
   a. for sake of clarity Hydrogen atoms in the formulae of A are omitted.
78) A silica based polymer according to any one preceding claims 1 to 25, whereby for the siloxane bridge (b) linking single ring silicate oligomers (A) the general formulae for the poly oligosiloxysilane compounds are:
   siloxane bridge (b) linking 2 silicate oligomers providing an Abₙ polymer or
   siloxane bridge (b) linking 3 silicate oligomers providing an Ab_{2n/3} polymer
   with A=[SiₙO₃ₙ]* and with n selected from 3, 4, 5, 6, 7, 8 and 9
   a. for sake of clarity Hydrogen atoms in the formulae of A are omitted.
79) A silica based polymer according to any one preceding claims 1 to 25, whereby for the siloxane bridge (b) linking linear chain silicate oligomers (A) the general formulae for the poly oligosiloxysilane compounds are:
   siloxane bridge (b) linking 2 silicate oligomers providing an polymer or
   siloxane bridge (b) linking 3 silicate oligomers providing an Ab_{(2n+2)/3} polymer
   with A=[SiₙO₃ₙ₊₁]* and with n selected from 1, 2, 3, 4, 5, 6, 7 and 8
   a. for sake of clarity Hydrogen atoms in the formulae of A are omitted.
80) A silica based polymer according to any one preceding claims 1 to 25, whereby for the siloxane bridge (b) linking linear chain silicate polymers (A) the general formulae for the poly oligosiloxysilane compounds are:
   siloxane bridge (b) linking 2 silicate oligomers providing an Abₙ₊₁ polymer or
   siloxane bridge (b) linking 3 silicate oligomers providing an Ab_{(2n+2)/3} polymer or
   siloxane bridge (b) linking 5 silicate oligomers providing an Ab_{(2n+2)/5} polymer
   with A=[SiₙO₃ₙ₊₁]* and with 20<n<∝
   a. for sake of clarity Hydrogen atoms in the formulae of A are omitted.
81) A silica based polymer according to any one preceding claims 1 to 25, whereby for the siloxane bridge (b) linking ladder type linear double chain silicate polymers (A) the general formulae for the poly oligosiloxysilane compounds are:
   siloxane bridge (b) linking 2 silicate oligomers providing an Abₙ₊₂ polymer or
   siloxane bridge (b) linking 3 silicate oligomers providing an Ab_{(2n+4)/3} polymer
   with A=[Si₂ₙO₅ₙ₊₂]* and with 20<n<∞
   a. for sake of clarity Hydrogen atoms in the formulae of A are omitted.
82) A silica based polymer according to any one preceding claims 1 to 25, whereby for the siloxane bridge (b) linking six-ring type linear double chain silicate polymers (A) the general formulae for the poly oligosiloxysilane compounds are:
   siloxane bridge (b) linking 2 silicate oligomers providing an Ab₃ₙ₊₂ polymer or
   siloxane bridge (b) linking 3 silicate oligomers providing an Ab_{(6n+4)/3} polymer
   with A=[Si₄ₙO₁₁ₙ₊₂]* and with 20<n<∝
   a. for sake of clarity Hydrogen atoms in the formulae of A are omitted.
83) A silica based polymer according to any one preceding claims 1 to 25, whereby for the siloxane bridge (b) linking double chain silicate polymers (A) the general formulae for the poly oligosiloxysilane compounds are:
   siloxane bridge (b) linking 2 silicate oligomers providing an Abₓ polymer or
   siloxane bridge (b) linking 3 silicate oligomers providing an Ab_{2x/3} polymer or
   siloxane bridge (b) linking 5 silicate oligomers providing an Ab_{2x/5} polymer
   with A=[SiₙO_{3y}]*, with 20<n<∝; 5n/2+1≦y≦3n+1; x=y−2n
   a. for sake of clarity Hydrogen atoms in the formulae of A are omitted.
84) A silica based polymer according to any one preceding claims 1 to 25 whereby for the siloxane bridge (b) linking silicate oligomers (A) the general formulae for the poly oligosiloxysilane compounds are:
   siloxane bridge (b) linking 2 silicate oligomers providing an Abₓ polymer or
   siloxane bridge (b) linking 3 silicate oligomers providing an Ab_{2x/3} polymer or
   siloxane bridge (b) linking 5 silicate oligomers providing an Ab_{2x/5} polymer
   with A=[SiₙO_{y}]*, with 1<n≦40; 2n+1≦y≦3n+1; x=y−2n
   a. for sake of clarity Hydrogen atoms in the formulae of A are omitted.
85) A silica based polymer according to any one of the claims 1 to 66 or according to any one of the claims 71 to 84 wherein the silicate oligomers interconnected by siloxane bridges in the form of microporous silica polymers materials with a pore size in the range of 0.2 to 2 nm, preferably 0.3 to 1 nm.
86) A silica based polymer according to any one of the claims 1 to 66 or according to any one of the claims 71 to 85 wherein the silicate oligomers interconnected by siloxane bridges in the form of microporous silica polymers materials with pores mainly formed by six, eight, nine, ten, twelve, fourteen, fifteen, sixteen, eighteen, twenty, twenty-one or twenty-four silicate tetrahedral or any combination of those different ring structures.
87) A silica based polymer according to any one of the claims 1 to 66 or according to any one of the claims 71 to 86 whereby the material is microporous with pores accessible through 9 ring and 12 ring structures (9 and 12 ‘—Si—O—’ units)
88) A silica based polymer according to any one of the claims 1 to 66 or according to any one of the claims 71 to 86 whereby the material is microporous with pores formed by 9 rings (9 ‘—Si—O—’ units)
89) A silica based polymer according to any one of the claims 1 to 66 or according to any one of the claims 71 to 86 whereby the material is microporous with pores formed by 12 rings (12 ‘—Si—O—’ units)
90) A silica based polymer according to any one of the claims 1 to 66 or according to any one of the claims 71 to 86 whereby the material is microporous with pores formed by one dimensional 16 ring structures (ring structures formed by 16 ‘—Si—O—’ units) interconnected by a network of 8 ring pores (ring structures formed by 8 ‘—Si—O—’ units)
91) A silica based polymer according to any one of the claims 1 to 66 or according to any one of the claims 71 to 86 whereby the material is microporous with pores formed by one dimensional 20 ring structures (ring structures formed by 20 ‘—Si—O—’ units) interconnected by a network of 10 ring pores (ring structures formed by 10 ‘—Si—O—’ units)
92) A silica based polymer according to any one of the claims 1 to 66 or according to any one of the claims 71 to 86 whereby the material is microporous with pores formed by one dimensional 15 ring structures (ring structures formed by 15 ‘—Si—O—’ units) interconnected by a network of 10 ring pores (ring structures formed by 10 ‘—Si—O—’ units)
93) A silica based polymer according to any one of the claims 1 to 66 or according to any one of the claims 71 to 86 whereby the material is microporous with pores formed by one dimensional 12 ring structures (ring structures formed by 12 ‘—Si—O—’ units) interconnected by a network of 8 ring pores (ring structures formed by 8 ‘—Si—O—’ units)
94) A silica based polymer according to any one of the claims 1 to 66 or according to any one of the claims 71 to 86 whereby the material is microporous with pores formed by one dimensional 8, 12 or 16 ring structures (ring structures formed by 8, 12 or 16 ‘—Si—O—’ units) interconnected by a network of 14 ring pores (ring structures formed by 14 ‘—Si—O—’ units)
95) A silica based polymer according to any one of the claims 1 to 66 or according to any one of the claims 71 to 86 whereby the material is microporous with pores formed by one dimensional 6, 9 or 12 ring structures (ring structures formed by 6, 9 or 12 ‘—Si—O—’ units) interconnected by a network of 12 ring pores (ring structures formed by 12 ‘—Si—O—’ units)
96) A silica based polymer according to any one of the claims 1 to 66 or according to any one of the claims 71 to 86 wherein silicate oligomers, which are interconnected by siloxane bridges, in the form of microporous silica polymers materials with hydride or organic groups connected to the silica core structure.
97) A silica based polymer according to any one preceding claims 1 to 96, wherein the silica based polymer contains less than 4 silanol groups per nm² of BET surface area, preferably less than 2 silanol groups per nm² of BET surface area, more preferably less than 1 silanol groups per nm² of BET surface area, most preferably less than 0.5 silanol groups per nm² of BET surface area.
98) A silica based polymer according to any one of the claims 1 to 2 or according to any one of the claims 4 to 97, whereby the silica based polymer comprising by siloxane bridges interconnected silicate oligomers (poly oligosiloxysilane) with the general formulae Abₓ whereby b is a siloxane bridge and A is a silicate oligomer also contains one or more different types of silane oligomers b_{y}
99) A silica based polymer according to any one of the claims 1 to 2 or according to any one of the claims 4 to 98, whereby part of the silane oligomers b_{y} are inside the pores of the Abₓ polymer
100) A silica based polymer according to any one of the claims 1 to 2 or according to any one of the claims 4 to 99, whereby part of the silane oligomers b_{y} are in close contact with the Abₓ polymer
101) A silica based polymer according to any one of the claims 1 to 2 or according to any one of the claims 4 to 100, whereby part of the silane oligomers b_{y} are directly connected to the Abₓ polymer
102) A silica based polymer according to any one of the claims 1 to 73 or according to any one of the claims 77 to 101 whereby no silanes B or siloxane bridges b connected by minimum one siloxane bond to minimum one silicate oligomer A are also connected to minimum one silane molecule B or B′ or to minimum one siloxane bridge b or b′.
103) A silica based polymer according to any one of the claims 1 to 73 or according to any one of the claims 77 to 101 whereby maximum 30% of the silanes B or siloxane bridges b connected by minimum one siloxane bond to minimum one silicate oligomer A are also connected to minimum one silane molecule B or B′ or to minimum one siloxane bridge b or b′.
104) A silica based polymer according to any one of the claims 1 to 73 or according to any one of the claims 77 to 101 whereby maximum 10% of the silanes B or siloxane bridges b connected by minimum one siloxane bond to minimum one silicate oligomer A are also connected to minimum one silane molecule B or B′ or to minimum one siloxane bridge b or b′.

105) A silica based polymer according to any one of the claims 1 to 73 or according to any one of the claims 77 to 101 whereby maximum 5% of the silanes B or siloxane bridges b connected by minimum one siloxane bond to minimum one silicate oligomer A are also connected to minimum one silane molecule B or B′ or to minimum one siloxane bridge b or b′.

106) A silica based polymer according to any one of the claims 1 to 73 or according to any one of the claims 77 to 105, whereby B═B′—B′; B′ is a silane and A is a silicate oligomer and the B′—B′ bond is a siloxy bond.
107) A silica based polymer according to any one of the claims 1 to 73 or according to any one of the claims 77 to 105, whereby B═B″—B″; B″ is a silane and A is a silicate oligomer and the B″—B″ bond is a silicon-silicon bond.
108) A silica based polymer according to any one of the claims 1 to 73 or according to any one of the claims 77 to 107, whereby siloxane bridges are formed between two silicate oligomers and whereby the polymer Abₓ is more flexible than structurally related materials of form A_{y}
109) A silica based polymer according to any one of the claims 1 to 66 or according to any one of the claims 73 to 105, whereby siloxane bridge are of the form —OSi(CH₃)₂O— and the material is hydrophobic.
110) A silica based polymer according to any one of the claims 1 to 66 or according to any one of the claims 73 to 105, whereby siloxane bridge are of the form —OSi(CH₃)₂O— and the material is very hydrophobic.

### DETAILED DESCRIPTION

### Detailed Description of Embodiments of the Invention

The following detailed description of the invention refers to the accompanying drawings. The same reference numbers in different drawings identify the same or similar elements. Also, the following detailed description does not limit the invention. Instead, the scope of the invention is defined by the appended claims and equivalents thereof.

Several documents are cited throughout the text of this specification. Each of the documents herein (including any manufacturer's specifications, instructions etc.) are hereby incorporated by reference; however, there is no admission that any document cited is indeed prior art of the present invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn to scale for illustrative purposes. The dimensions and the relative dimensions do not correspond to actual reductions to practice of the invention.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. It is thus to be interpreted as specifying the presence of the stated features, integers, steps or components as referred to, but does not preclude the presence or addition of one or more other features, integers, steps or components, or groups thereof.

The word “a” or “an” preceding an element does not exclude the presence of a plurality of such elements.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details.

In other instances, well-known methods, structures and techniques have not been shown in detail in order not to obscure an understanding of this description.

Other embodiments of the invention will be apparent to those skilled in the art from consideration of the specification and practice of the invention disclosed herein.

It is intended that the specification and examples be considered as exemplary only.

Each and every claim is incorporated into the specification as an embodiment of the present invention. Thus, the claims are part of the description and are a further description and are in addition to the preferred embodiments of the present invention.

Each of the claims set out a particular embodiment of the invention.

The following terms are provided solely to aid in the understanding of the invention.

### DEFINITIONS

As used herein, term “hydrophobic” refers to a material for instance its surface that is difficult to wet with water. Such material will be considered hydrophobic if a coating or surface of said material demonstrated a receding water contact angle of at least 70°, very hydrophobic if it demonstrated a receding water contact angle of a least 90°, and extremely hydrophobic if it demonstrated a receding water contact angle of at least 120°. The term “superhydrophobic” refers to a surface or coating that is extremely difficult to wet with water. A superhydrophobic surface or coating will usually have receding water contact angles in excess of 140°, and often in excess of 150°.

As used herein, the term “polymer” refers to polymers, copolymers (e.g., polymers formed or formable from two or more different monomers), oligomers (comprising minimal five monomer units) and combinations thereof.

According to IUPAC a hydrogen bond is: “The hydrogen bond is an attractive interaction between a hydrogen atom from a molecule or a molecular fragment X—H in which X is more electronegative than H, and an atom or a group of atoms in the same or a different molecule, in which there is evidence of bond formation.”

In the frame of this patent, we further specify the distance between X and H is smaller than 0.25 nm and X is an atom (X is N, O, S, F, or Cl) or group of atoms containing minimum one N, O, S, F or Cl atom.

A silsesquioxane is an organosilico compound of general formula (RSiO_{3/2})ₙ. R being a H or any organic moiety. Every silicon atom in a silsesquioxane has a direct Si—H or Si—C bond.

A POSS is a silsesquioxane of formula (RSiO_{3/2})ₙ whereby the core structure formed by the Si—O—Si bonds is a polyhedral structure such as a cube, a double three ring, a double five ring, or any other polyhedral structure.

A siloxane as used herein refers to an organosilico compound with minimum one direct Si—R bond, with R being a hydrogen atom or any organic moiety. In a siloxane there is minimum one silicon atom that has a direct Si—H or Si—C bond.

A silicate oligomer as used herein refers to silicon containing oligomer or polymer whereby every silicon atom is bound to four oxygen atoms. In a silicate oligomer no direct Si—H bonds, no direct Si—C and no direct Si—Si bonds are present. In every silicate oligomer the dimensions in minimum two orthogonal axes through the center of the particle/oligomer are smaller than 3 nm.

The term “silane” as used herein refers to chemical compounds of silicon, in which every silicon atom is involved into minimum one labile Si(rlg) bond with rlg=reactive leaving group ═N, Cl, Br, I, F, H, OR (OH, OH₂⁺, O⁻, R, NR₂) (R being any alkyl, or any aryl or any other organic molecule some examples are: R=Methyl, ethyl, propyl, isopropyl, butyl, tertiar butyl, phenyl, benzyl, cyclohexyl, acetate, lactate, C₂H₃, C₃H₅, C₄H₇, C₅H₄, C(O)CH₃, C₂H₂CₙF₂ₙ₊₁, etc.). Silanes may also contain one or several, equal or different Si—O and/or Si—Si and/or Si—C bonds.

As used herein “sylilation” represents the reaction of silanes with silica material.

The term “poly oligosiloxysilane” as used herein concerns silicate oligomers interconnected through siloxane bridges or a material that comprises such silicate oligomers interconnected through siloxane bridges.

As used herein, the term “siloxane bond” refers to a Si—O—Si bond. The formation of a siloxane bond between a silicon containing compound “Q₃SiOT” and a silane “SiXZ₃” is explained in the following reaction scheme: Q₃SiOT+SiXZ₃=>Q₃Si—O—SiZ₃+TX.

For the reaction between a silicate oligomer A and a silane B a siloxane bond is formed through the following reaction:

A+B=>Ab+T(rlg) with b(rlg)=B and with —OT=—OH, —OH₂⁺, —O⁻, —OR, —OM; with R is an alkylgroup and with M is Na⁺, K⁺ or any other kation.

As used herein, the term “siloxane bridge” refers to an —O—Si—O— bridge. A siloxane bridge interconnect two or more silicate oligomers; one or more silicate oligomers and one or more other silicon containing compounds or it interconnect two or more silicon containing compounds. The formation of a siloxane bridge (—O—Si—O—) derived from a silane (Si(rlg)ₐZ_{b}) interconnecting two or more silicon containing compounds “Q₃SiOT” is explained in the following reaction scheme:

zQ₃SiOT+Si(rlg)ₐZ=>Q₃Si—OSi(rlg)_{a-z}Z_{b}[O—SiQ₃]_{z-1}+zT(rlg)with z≦a and a+b=4.

For the reaction between a silicate oligomer A and a silane B a siloxane bridge is formed through the following reaction: z A+B=>A(b)A_{z-1}+z T(rlg); with 1≦z; b(rlg)_{z}=B and with —OT=—OH, —OH₂⁺, —O⁻, —OR, —OM; with R is an alkylgroup and with M is Na⁺, K⁺ or any other kation. Apart from —O—Si—O— also the bridges between more than two silicon containing compounds and the following bridges —O—Si—O—Si—O—, —O—Si—C—Si—O—, —O—Si—Si—O—, —O—Si—C—Si—C—Si—O—, —O—Si—O—Si—O—Si—O—, —O—Si—Si—Si—O— are considered siloxane bridges in present invention.

A silica based polymer comprising, consisting of or consisting essentially of by siloxane bridges interconnected silicate oligomers is considered ordered if the material is crystalline or if a coordination sequence for each of the limited (<25) topologically distinct silicate oligomers in the framework structure can be obtained.

A silica based polymer comprising, consisting of or consisting essentially of by siloxane bridges interconnected silicate oligomers is considered to have a long range ordering if the material can be described by a repetition in one, two or three dimensions of a so called unit cell whereby dimensions of the individual unit cells can deviate to some extent (max 10%) around the average dimensions of the so called unit cell and whereby the relative positions of the silicate oligomers and/or the siloxane bridges in the unit cell can deviate to some extent (average deviation <25% of the dimensions of the silicate oligomer and average deviation <0.5 nm and average deviation <10% of the dimensions of the so called unit cell) around the average positions of the silicate oligomers and siloxane bridges in the so called unit cell.

The poly oligosiloxysilane of present invention is considered to have a long range ordering if the material can be described by a repetition in one, two or three dimensions of a so called unit cell whereby dimensions of the individual unit cells can deviate to some extent (max 10%) around the average dimensions of the so called unit cell and whereby the relative positions of the silicate oligomers and/or the siloxane bridges in the so called unit cell can deviate to some extent (average deviation <25% or the dimensions of the silicate oligomer and average deviation <0.5 nm or average deviation <10% of the dimensions of the so called unit cell) around the average positions of the silicate oligomers and siloxane bridges in the so called unit cell.

A silica based material comprising, consisting of or consisting essentially of by siloxane bridges interconnected silicate oligomers is considered locally ordered if minimum one of the following conditions is met:
1. a theoretical coordination sequences for each of the limited number (<10) of topologically distinct silicate oligomers in the framework structure can be obtained and each of the numbers Ni in the coordination sequence of the individual silicate oligomers on average deviate by less “0.2Ni+1” from the theoretical value for Ni in the idealized structure.
2. the structure of the silicate oligomer based polymer consists essentially of small domains (>2*2*2* size of a silicate oligomer) wherein the material resembles an ordered by siloxane bridges interconnected silicate oligomers network.
3. around most (>50%) of the individual silicate oligomers, similar ring structures formed by silicate oligomers and siloxane bridges are present.
4. For most (>50%) of the individual silicate oligomers, if the position and orientation of the silicate oligomer is known, the position and orientation of neighboring silicate oligomers (connected through a siloxane bridge) can be accurately predicted with less than 10% error on distance, less than 0.5 radials error on the direction and less than 20% error on the orientation.

A poly oligosiloxysilane of present invention is considered locally ordered if minimum one of the following conditions is met:
1. a theoretical coordination sequences for each of the limited number (<10) of topologically distinct silicate oligomers in the framework structure can be obtained and each of the numbers Ni in the coordination sequence of the individual silicate oligomers on average deviate by less “0.2Ni+1” from the theoretical value for Ni in the idealized structure.
2. the structure of the silicate oligomer based polymer consists essentially of small domains (>2*2*2* size of a silicate oligomer) wherein the material resembles an ordered by siloxane bridges interconnected silicate oligomers network.
3. around most (>50%) of the individual silicate oligomers, similar ring structures formed by silicate oligomers and siloxane bridges are present.
4. For most (>50%) of the individual silicate oligomers, if the position and orientation of the silicate oligomer is known, the position and orientation of neighboring silicate oligomers (connected through a siloxane bridge) can be accurately predicted with less than 10% error on distance, less than 0.5 radials error on the direction and less than 20% error on the orientation.

Flexibility of a material can be expressed in the way a material react upon an applied force. This force can be in the form of pressure in one or more direction or under the form of a torsion applied upon a particle. The more a material reacts upon the applied force, the more the material is flexible.

A gel as used herein refers to a sol in which the solid particles are interconnected in such a way that a rigid or semi-rigid structure results. In contrast to a powder or particles, the form and shape of a gel is related to the recipient in which it has been synthesized.

For clarity the following notations will be used

Silanes will be represented by capital letters (B, B′, B″, C, D, . . . )

Silicon containing compounds connected by minimum one siloxane bond will be represented by small letters (b, b′, b″, c, d, e, f, g, h, i, . . . )

A silane compound B can also be represented as being a silicon containing compound, connected to a number x of reactive leaving groups whereby B=b(rlg)ₓ.

Silicate oligomers will be represented by a capital letter (A)

Silicate oligomers connected through siloxane bonds to other silicon containing compounds will also be represented by a capital letter (A).

The present invention relates to a new synthesis procedure for a new family of silica based polymers synthesized through the interconnection of silicate oligomers with reactive silanes. The in the present invention mentioned poly oligosiloxysilane can be best described with the formula Abₓ whereby A represents the silicate oligomer, b the siloxane bridges linking the different silicate oligomers and x represent the ratio between the number of silane compounds and silicate oligomers in the idealized final poly oligosiloxysilane material.

The present invention includes a family of silica based polymers, the poly oligosiloxysilane materials. These silica based polymers are built from two types of elemental building units, the silicate oligomers (A) and the siloxane bridges (b). Different groups of silicate oligomers are described into detail in below “step a” of the synthesis. In short silicate oligomers of present invention extend to all silicate linear chain oligomers composed of 2-20 silicate tetrahedra, silicate ring structures composed of 3-12 silicate tetrahedra, silicate double ring structures composed of 6, 8, 10, 12, 14 or 16 silicate tetrahedra and any other silicate oligomers composed of 2-40 silicate tetrahedra. Silicate oligomers or silicate polymers whereby the dimensions in minimal two orthorhombic axes are less than 3 nm are for the present invention considered as being silicate oligomers. In an embodiment of present invention linear silicate polymer chains and linear silicate polymer double chains whereby the dimensions in minimal two orthorhombic axes are less than 3 nm are also considered as being silicate oligomers.

Preferred silicate oligomers are double ring silicate oligomers whereby the double four ring silicate oligomer is the most preferred member. Preferred siloxane bridges are siloxane bridges with only one silicon atom. In the family of the poly oligosiloxysilane the siloxane bridge interconnect two or more silicate oligomers. Preferably the siloxane bridges interconnect two silicate oligomers. In another embodiment of the present invention, two silanes connected by a siloxane bond together, can form a siloxane bridge between two silicate oligomers. In yet another embodiment of the present invention, the siloxane bridge can interconnect two silicate oligomers and can form a siloxane bond with another silane molecule. In another embodiment of the present invention, the siloxane bridge can interconnect two silicate oligomers and can form a siloxane bond with another silane molecule only connected to silane molecules. In yet another embodiment of the present invention, the siloxane bridges can interconnect three silicate oligomers. In another embodiment of the present invention, the siloxane bridges can interconnect three silicate oligomers and can form a siloxane bond with another silane molecule. In yet another embodiment of the present invention, the siloxane bridges can interconnect four silicate oligomers.

There are some potential interesting properties of many of the silica based polymers in the family of materials of present invention. These properties concern for instance the flexibility of many of the materials, the hydrophobicity of some of the materials the ordering of the materials and combinations thereof.

The poly oligosiloxysilanes materials whereby the siloxane bridges interconnect two silicate oligomers can render the poly oligosiloxysilane materials flexible. The flexibility is expected to be larger than structural related zeolite materials. This flexibility can originate in the fact that the siloxane bridge only connects two silicate oligomers and therefore still keeps a large freedom to compensate for stress originating from inside or outside of the material. This flexibility however can generate difficulties in observing ordering of the silicate oligomers and silanes in the material. By creating such materials with flexible siloxane bridges it is possible to create poly oligosiloxysilane materials for adsorption applications, for coatings, sealants, sensor application and other applications that need flexible poly oligosiloxysilanes. This is an embodiment of present invention. The nature of the siloxane bridge (b) has a huge influence on the hydrophobicity of the poly oligosiloxysilanes. The use of silanes with two reactive leaving groups and two hydrophobic organic groups can result in a highly hydrophobic internal surface of the material.

Especially for some of the poly oligosiloxysilane materials with a one or two dimensional structures the external surface is also hydrophobic. In some other materials the external surface is still hydrophilic due to the presence of silanols or reactive leaving groups on the surface of the material. If desired the external surface is rendered more hydrophobic through a silylation step with a silane with one or two reactive leaving groups and the remaining groups being hydrophobic organic groups. According to the present invention there is provided poly oligosiloxysilane materials which are hydrophilic, hydrophobic, very hydrophobic, extremely hydrophobic or superhydrophobic.

The order or some degree of order in the poly oligosiloxysilane materials is one of other the interesting properties this family of materials of present invention.

Ordering can be seen at small wave-numbers (<1300 cm⁻¹) in spectroscopic features of specific FTIR and/or raman spectroscopy. Especially fingerprint vibrations or rotations of silicate ring structures not present in the silicate oligomer can point in the direction or order in the poly oligosiloxysilane material. Specific hierarchical structures formed by a local order of the Abₓ polymer can also give rise to specific features in FTIR or RAMAN spectroscopy.

²⁹Si MAS NMR is another technique generally used in measuring the local structure of materials. For example a resonance spectrum of a perfect and ordered poly oligosiloxysilane material consisting only of silicate octamers (A) connected through dimethylsiloxane bridges (b) is expected to show only two resonances or groups of resonances with a 1 to 2 ratio. Especially with 2D ²⁹Si NMR the A-b bond formation and the lack of A-A bonds and the lack of b-b bonds can be confirmed. In specific cases even the A-b-A and/or b-A-b connectivity can be obtained with the use of 2D ²⁹Si NMR.

Pair correlation functions and extended X-ray adsorption fine structure can be used to reveal the ordered nature of the poly oligosiloxysilanes of the present invention. Specific interatomic distances that cannot be explained by silicate oligomers (A), silane molecules (B) or by siloxane bonds (b) between a silicate oligomer and a silane molecule alone, can point in the direction of a degree of directional order in a large part of the A-b-A bridges. The observation of stronger signals than the signals that can be expected from a totally random connection of silicate oligomers (A) and siloxane bridges (b) can also reveal a certain degree of ordering in the poly oligosiloxysilane materials.

Porous poly oligosiloxysilane materials with some degree of local ordering or long range ordering show a monodisperse nano- or mesoporesize distribution. In ordered poly oligosiloxysilane materials with different pore systems or different pore sizes a multimodal pore size distribution can be expected.

Local ordering of porous materials can also be observed through a shape or size selective adsorption of molecules by the material.

A porous material with local ordering results in similar adsorption sites. Similar adsorption sites will generally have similar energies of adsorption for specific molecules. A large fraction of adsorption sites with similar adsorption energy therefore points to a material with minimal some local ordering.

X-ray diffraction is one of the best techniques to acquire evidence for long range ordering in a material. Several sharp peaks in an X-ray diffractogram will therefor provide a strong evidence for the existence of long range ordering. When the ordering only appears on a more local scale, often one or several broader “diffraction” peaks appear. These “diffraction” peaks do not always point to diffraction, but in some cases they can come from scattering and therefor point to average distances between particles in a material.

Average distances between particles in a material are often obtained using SAXS. In a local ordered poly oligosiloxysilane material the average distance between neighboring particles will be relatively constant. The scattering pattern using SAXS should therefore be a means to obtain information on the local ordering of the poly oligosiloxysilane materials. Due to adsorption of molecules, the X-ray diffractogram and/or the SAXS scattering pattern of the poly oligosiloxysilane materials can in some cases be altered. Especially for flexible structures the adsorption of specific molecules prior to X-ray diffraction, pair correlation, SAXS or EXAFS can be a way to get easier access to the degree of ordering in the connectivity of a material.

Electron diffraction is a useful technique to obtain information on the local and long range ordering of the poly oligosiloxysilanes materials, sharp diffraction spots provide evidence for relatively large ordered domains, diffraction circles will point to small ordered domains or only local ordering.

Long range order of the poly oligosiloxysilanes materials results in fringes or ordered structures in high resolution transmission electron microscopy.

With scanning electron microscopy important information about the ordering of poly oligosiloxysilane materials can be obtained. Distinct angles between the edges of a crystal, sharp edges, symmetry in the particle shape all point towards some degree of (long range) ordering inside the particle.

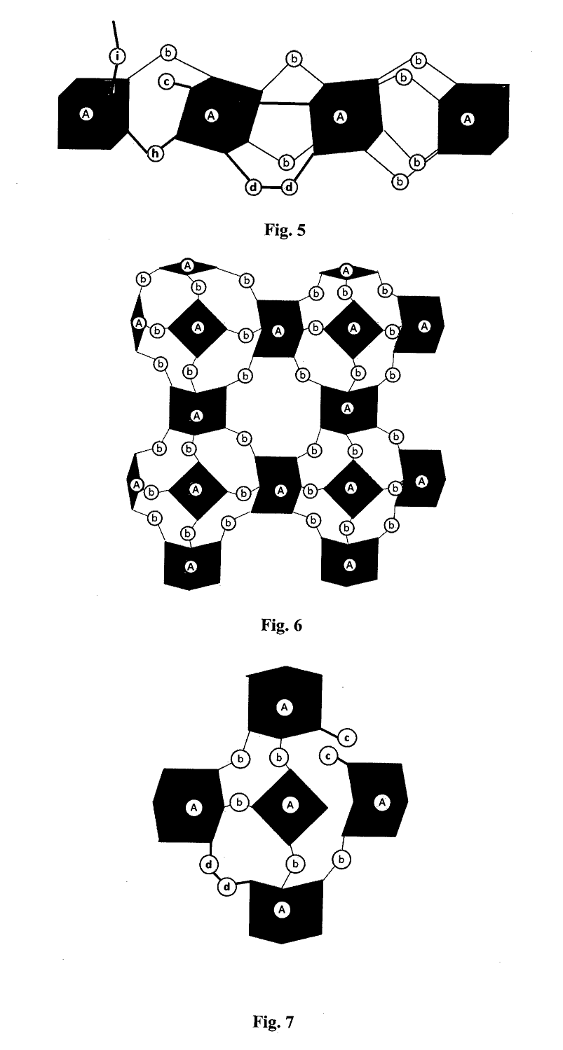

Silicate oligomers can for instance in a linear way be connected through siloxane bridges. The resulting silicate polymer then can have very specific features. Several different ways to connect silicate oligomers (A) with silanes to form siloxane bridges (b, b′) or siloxane bonds (c) in a linear way are given in FIGS. 1-3. During the connection of the different silicate octameric cubes some imperfection towards the general structure can be formed (FIG. 5). When in general the silicate oligomers are connected to each other by a siloxane bridge (b), than a possible imperfection of the ideal structure is the formation of a siloxane bridge of the form “b-b” or “b_{y}” (with y >1) (example d-d bond in FIG. 5). In poly oligosiloxysilane materials with a three dimensional structure silanes only connected to one silicate oligomer are often found at the particle or crystal boundaries. In poly oligosiloxysilanes with a one or two dimensional structure silanes connected to only one silicate oligomer are expected on respectively minimal one or minimal two pairs of opposing crystal planes. Not only at the boundaries of the poly oligosiloxysilanes particles or crystals, imperfections under the form of silanes connected to only one silicate oligomer can exist. Multiple silanes “b-b” or “b_{y}” (with y >1) can have only one siloxane bond with a silicate oligomer. siloxane bridges between two silicate oligomers but in a way other than expected based on the normal connections in other parts of the poly oligosiloxysilane materials can also be present. Missing siloxane bridges are another potential stacking fold in poly oligosiloxysilanes. Last but not least silane monomers and silane oligomers, linear and cyclic of the form b_{y}, can also be in and around the poly oligosiloxysilane materials. Since these silanes are not connected to the poly oligosiloxysilane materials, therefore these silanes and oligomers will not be considered as being deviations of the general structure.

Some of the possible deviations of a perfect structure are given in FIG. 5 whereby the general occurring silane bridges are represented by “b”, a “b-b” siloxane bridge is represented by a “d-d” bridge, a silane only linked to one silicate octamer is represented by “c” and a siloxane bridge between two silicate oligomers but in a way different than expected for a perfect ordered material is represented by a “h” or “i”.

In some embodiments the poly oligosiloxysilane materials of present invention are not a perfect ordered material, but still contain some degree of ordering. In an embodiment of present invention the poly oligosiloxysilane materials have a strong resemblance to the silicate oligomer material to which the silanes where added. In many cases the silanes bridges in the poly oligosiloxysilane materials replace hydrogen bonds or hydrogen bridges between the silicate oligomers in the silicate oligomer material obtained during one of the synthesis steps of the synthesis of the poly oligosiloxysilane materials. Siloxane bridges will preferentially be formed between terminal oxygen atoms of silicate oligomers when the distance between those terminal oxygen atoms does not differ to much from the distance between the oxygen atoms in the potential siloxane bridge. In order to obtain siloxane bridge of the form —OSi(R₂)O— the theoretical ideal Oₜₑᵣₘ—Oₜₑᵣₘ distance will probably be around 0.26 nm with everything between around 0.20 nm and around 0.33 nm probably still being acceptable.

A linear chain poly oligosiloxysilane materials with a theoretical structure similar to the structure represented in FIG. 1 has been synthesized. A high resolution transmission electron microscopy (HRTEM) can reveal the linear nature of the chains; ordering of these linear chains and/or some fringes in the electron microscopy images can also be observed. In specific conditions it is to be expected that bundles of linear chains silicate polymers can be separated into (almost) individually linear chain silicate polymers. A HRTEM image of a small bundle of linear chain silicate polymers can be seen in FIG. 9-R. A HRTEM image of a silicate oligomer material used in the first steps of the synthesis of this material is given in FIG. 9-L.

In an embodiment of present invention silanes with three or four reactive leaving groups can be used in a synthesis similar to the synthesis of linear chains poly oligosiloxysilane materials as shown in FIG. 1, those linear chains can be connected through siloxane bonds between the silanes in order to form a three dimensional structure for example similar to the structure shown in FIG. 4. Depending on the exact connectivity porous materials with different pore structures can be formed. Interconnected porous networks of 8 rings and 12 rings or interconnected porous networks of 8 rings and 16 ring structures are some of the possible pore architectures that can be obtained in this way.

The present invention provides also an embodiment on poly oligosiloxysilane materials with a structure similar to the materials represented in FIG. 3. These are for instance formed starting from a silicate hydrate materials synthesized in the presence of a cobalt ethylenediamine complex. The structure of this material provides minimum one type of siloxane bridges and minimum one other type of siloxane bonds or bridges. In FIG. 3 silanes forming a siloxane bridge between two silicate oligomers are represented by (b) and silicon containing species forming only one siloxane bond with a silicate oligomer are represented by (c). In an additional embodiment of present invention, these linear chains can be connected through siloxane bonds between the silanes (c-c siloxane bonds) in order to form a two or three dimensional structure.

Through the connection of linear poly oligosiloxysilane chains different porous structures can be formed. Depending on the exact connectivity porous materials with different pore structures are formed, especially an interconnected net of 8 rings and 12 rings or an interconnected net of 8 rings and 16 ring structures can be formed.

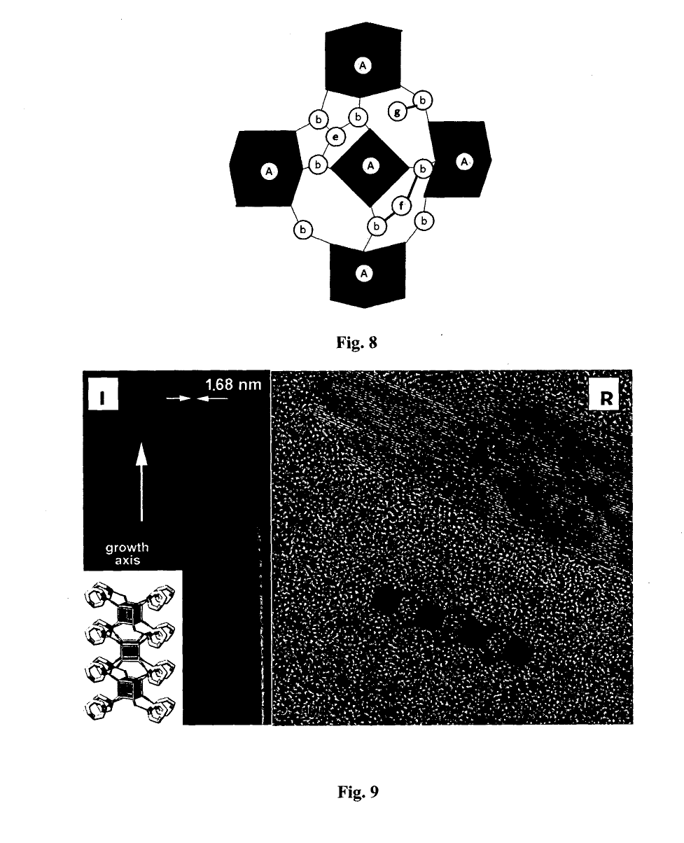

Similar to one dimensional poly oligosiloxysilane materials, the present invention also involves materials with a 2 or 3 dimensional structure. As an example a poly oligosiloxysilane material with a structure related to the LTA zeolite topology of zeolites is schematically drawn in FIG. 6. Poly oligosiloxysilane materials as schematically drawn in FIG. 6 are composed if silicate octameric cubes connected through eight siloxane bridges with eight different silicate octameric cubes. In this material two different types of zero dimensional pores are accessible through 9 rings and 12 rings. Some of the possible deviations from the perfect crystal structures are schematically drawn in FIG. 7 whereby “b”, “c” and “d” represent respectively: a silane molecule forming a siloxane bridge between two silicate oligomers (b); a silicon containing compound forming a siloxane bond with a silicate oligomer and also having a silanol group or a reactive leaving group (c); a silicon containing compound forming a siloxane bond with a silicate oligomer and a second siloxane bond with a second silicon containing compound (d). When similar poly oligosiloxysilanes are synthesized using a silane with three or four reactive leaving groups, many other from silanes derived species (for instance b, e, f, g) can be formed (see FIG. 8).

Apart from these three dimensional poly oligosiloxysilane networks many other two and three dimensional structures of poly oligosiloxysilanes can be synthesized.

Without intention of being limited to a certain process for obtaining the materials of present invention a general synthesis procedure for the synthesis of members of this new family of silica based polymers—the POSiSils—is hereby provided. In comprises the following steps a-p, whereby not all steps a-h are necessary; whereby the order of the steps a-p can be altered and whereby anyone or more of the steps a-p can be repeated one or more times.

Step a: take one or more suitable silicate materials containing silicate oligomers and/or synthesis one or more types of silicate oligomers
Step b: suspension of the silicate oligomers
Step c: (re)crystallizing silicate oligomers
Step d: removal of excess template
Step e: removal of solvent
Step f: drying of the silicate oligomers (A)
Step g: addition of adsorbents
Step h: addition of the silane linker molecules (B)
Step i: formation of siloxane bonds and siloxane bridges (b) between silicate oligomers (A) and silanes (B)
Step j: removal of H(rgl)
Step k: removal of excess silane linker molecules
Step l: addition of water to the formed material
Step m: removal of template molecules
Step n: repetition of steps h to l
Step o: surface treatment
Step p: removal of solvent(s)

For instance a simple synthesis procedure can involve the use of a silicate oligomer source, addition of a silane linker molecule linking the silicate oligomers together. Such simple synthesis procedure involves for example only steps a, h and i; while in more specific synthesis procedures more synthesis steps a to p is involved and some of those steps is eventually repeated. In general ordering of the silicate oligomers prior to the linking of these silicate oligomers is expected to be an essential step in order to obtain in one of the next steps the ordered POSiSil Materials. Ordered silicate oligomers can be used as a starting material in step a or can be used as obtained through any of the steps b, c, d, e, for g.

### Step a: Silicate Oligomers

Silicate oligomers can be obtained in different ways. In a first embodiment of present invention (aqueous) suspensions of silicate oligomers is obtained using the methods known by those skilled in the art. As an example: double four ring silicate octamers can be obtained from an aqueous suspension containing a silica source, tetramethylammonium hydroxide and methanol.

In another embodiment of present invention silicate hydrate materials and silicate amines is obtained from a variety of silicate suspensions. As an example: double four ring silicate hydrate crystals can be formed in an aqueous suspension of (excess) hexamethyleneimine and a silica source.

In yet another embodiment of present invention an organic suspension of silicate oligomers is for instance be obtained by suspending the silicate hydrates formed from an aqueous solution of hexamethyleneimine and a silica source in N-methylimidazole or in an acidic tetrahydrofuran solution.

In another embodiment Nesosilicates, sorosilicates, cyclosilicates, inosilicates and pyroxenes, some of the natural occurring classes of minerals containing silicate oligomers could be used in the synthesis of the silicate oligosiloxysilane polymers of present invention.

In yet another embodiment of present invention any of the previously described silicate oligomers could be silylated in order to form larger silicate oligomers.

The five above mentioned embodiments of present invention concerning the silicate oligomers are discussed into more detail below.

Aqueous suspensions of silicate oligomers exist for some time. In some specific cases aqueous solutions containing only one specific type of silicate oligomers have been synthesized. It is for example possible to stabilize exclusively D4R silica octamers in an aqueous suspension of tetramethylammonium hydroxide. Next to solutions containing D4R silica species, also (aqueous as well as organic) suspension containing silica monomers, dimers, cyclic and double ring silicate species are stabilized. Furthermore in specific conditions it is possible to silylate these silicate oligomers in suspension to form other (specific) (larger) silicate oligomers.

Specific silicate oligomers can also be found in natural and synthetic silica based materials. The natural and synthetic silica based materials containing silicate oligomers is subdivided into different groups, such the nesosilicates, the sorosilicates and the cyclosilicates. Inosilicates, Pyroxenes and Amphiboles silicates do not comprise of specific silicate oligomers, but of silicate chains or double silicate chains. Due to the specific feature of those silicate chains for present invention the silicate chains and silicate double chains of the inosilicates, the Pyroxenes and the Amphiboles are considered as a specific types of silicate oligomers. Therefore these silicate chains are comprised under the definition of Silica oligomers of present invention.

Nesosilicates are a first class of silicate materials. The silica tetrahedra in nesosilicates are isolated and exist as discrete anionic structural subunits. In nature nesosilicates are formed at high temperature from magma containing a high concentration of alkali cations. In Olivine, silica tetrahedra are arranged such that alternate SiO₄⁴⁻ subunits are inverted and linked by Mg²⁺ or Fe²⁺ cations. Other minerals of the nesosilicate group include for instance garnet and zircon.

The structure of sorosilicates is based on dimers of silicate units. Two silicate tetrahedra share one oxygen atom and form Si₂O₇⁶⁻ anionic units, the charge of which is compensated by inorganic cations. Compared to the nesosilicates, the sorosilicates crystallize from magma enriched in silicon and containing a lower concentration of alkaline cations.

In the class of the cyclosilicates, all silicate tetrahedra share two oxygen atoms in order to form ring structures. The majority of cyclosilicates is built from three-, four- or six-rings of silicate tetrahedra. Exceptionally, cyclosilicates containing eight, nine or twelve rings of silicate units are encountered. Double rings are rarely encountered in silicate minerals, but still some examples of such cyclosilates are described in literature. Examples of cyclosilicates constructed from trigonal prisms, cubes or hexagonal prisms have been reported. Silicate hydrates form a special group within the cyclosilicates. In this group of synthetic cyclosilicates, water molecules often play an important structural role.

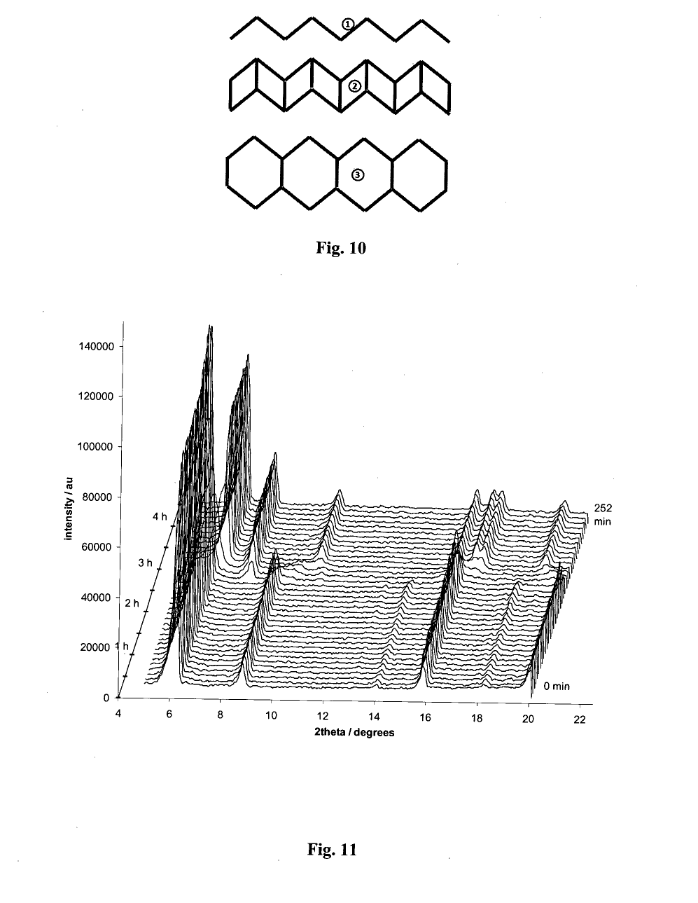

The chain silicates, such as Inosilicates or Pyroxenes are in a particular embodiment of present invention used for producing polymers by contacting said the chain silicates with silane compounds to form siloxane bridges interconnecting the chain silicates (hereinafter called poly oligosiloxysilane) by a process of lining silicate oligomers by silane compounds. Inosilicates or chain silicates contain linear chains of silicate tetrahedra formed by corner sharing of monomer tetrahedra. Inosilicates or chain silicates are realized by linking [SiO4]⁴⁻ tetrahedrons in a way to form continuous chains. They may be represented by a composition of [SiO3]²⁻. Pyroxenes are isolated linear chain silicates and have a compositional formula in which the silicate is represented by (SiO3)ₙ²⁻. Apart from single chains also double chain silicates exists. Double chains are obtained by systematic interlinking of tetrahedra from linear chains by corner sharing. Half of the silicate tetrahedra in amphiboles share three oxygen atoms with other silicon tetrahedra, the other half shares oxygen atoms with only two other tetrahedra. The general compositional formula of the amphiboles is based on the (Si4O11)ₙ⁶⁻ silicate unit. In FIG. 10 a schematic representation of single chain and two double chain silicate “oligomers” is given.

The crystalline silicates are a preferred basis for manufacturing the silica based polymers of present invention. Silicate hydrates are known crystalline materials in containing specific silicate oligomers (preferably D3R, D4R and D6R). The organic cations are embedded in cages or pores formed by a network of hydrogen bonded water molecules and oligomeric silicate clusters. Some silicate hydrate materials have been described to contain for example also some: aluminum, Cobalt, Nickel copper, palladium or zinc atoms. Different arrangements of those silicate oligomers are known. We have recently discovered that many silicate hydrate structures are changed through the use of a whole variety of small manipulations. This together with our knowledge about the synthesis of silicate hydrates makes is for us perfectly feasible to create a large set of ordered materials in which the oligomers are arranged in different ways. In many cases the silicate oligomers in those materials are interconnected through a network of hydrogen bonds. So far however no one has ever started looking at potential applications for those materials. Moreover no one has ever mentioned any possible method for linking those silicate oligomers though the use of specific (in)organic linker molecules. Silicate hydrates are positioned between zeolites and clathrate hydrates. In zeolites (organic) template molecules are embedded in the pores of a four-connected silicon dioxide network. The template molecules reside in zero, one, two or three dimensional pores. In the crystal structure of clathrate hydrates, the template molecules are partially or entirely surrounded by water molecules. The first silicate hydrate was reported in 1937 when Glixelli described a new type of crystal. From an aqueous suspension containing tetramethylammonium hydroxide (TMAOH) and silica gel the new kind of crystals were synthesized. Those crystals were slightly soluble in water, methanol and ethanol. In air the crystals decomposed. It was confirmed that the crystals contained water molecules. Similar crystals are obtained using tetraethylammonium hydroxide (TEAOH) as mineralized. It was only in 1952 that Prikid'ko described the structure of a silicate unit in a silicate hydrate. It took until the early seventies before the first silicate hydrate structures was solved. So far three different silicate units have been found in silicate hydrates. Most silicate hydrates contain double four ring silicate units. Next to many four ring silicate hydrates only one double six ring silicate hydrate and a few double three ring silicate hydrates have been reported.

Silicate hydrates can also effectively be formed in for instance tetramethyl-(TMA), tetraethyl-(TEA) and tetrabutylammonium (TBA) aqueous suspensions. The use of these TMA gives rise to hydrates with isolated D4R silicate units; TEA to D3R silicate units and TBA to D4R silicate cubes. The cubes in the TBA based structure are interconnected by direct hydrogen bonds between the terminal oxygen (Si—O—) and silanol (Si—OH) groups. Each of the terminal oxygen or silanol group is hydrogen bonded to a terminal oxygen or silanol group of a different silica cube. The TBA-based silicate hydrate structure resembles closely to the structure of zeolite A. The difference is that the TBA-silicate hydrate structure contains some Si—O—H—O—Si bonds instead of siloxane bonds in the LTA zeolite structure (FIG. 9). In TBA-silicate hydrates charge compensation of the negatively charged silicate cubes occurs not only by TBA cations, but also by protonated water clusters. Inside of each “sodalite-like cage” a H₄₁O₁₆⁹⁺ cluster is located. Apart from this water cluster, no other water molecules are present in TBA-silicate hydrate. The TBA template molecule resides in the “8+-ring” pores with the nitrogen atom of TBA in the “8+ ring” pore and the butyl groups pointing two by two to different ‘lta-like” cages. Structurally similar silicate hydrates were formed from ethylenediamine containing clear solution of TBA, water and silicic acid. The structure resembled the TBA-silicate hydrate in which part of the water was replaced by ethylenediamine (en). Adding diethylentriamine (di-en), triethylenetetramine (tri-en), 1,4-Diazabicyclo[2.2.2]octane (triethylenediamine; di-tri), hexamethylenetetramine (hex-tetra) or para-xylenediamine (p-Xyl-di) to the starting clear solution resulted in a structure similar to the TBA-silicate hydrate in which it is expected that part or all the water is replaced by en, di-en, tri-en, di-tri, hex-tetra or p-Xyl-di molecules. In the presence of ethylenediamine and tetrabutylphosphonium (TBP) cations, TBP-silicate hydrate are prepared. The structure of this material seemed to be very similar to the TBA-silicate hydrate.

The use of hexamethyleneimine (HMI) as a template give rise to yet another different silicate hydrate structure (HMI-CySH). The structure of HMI-CySH is described as a heteronetwork structure formed by both covalent and non-covalent interactions between the water, inorganic and organic species. The crystal packing contains 16 D4R units on two crystallographic independent positions centered on inversion centers in the asymmetric unit. The crystal packing shows that alternating cube 1 and cube 2 are stacked onto each other, forming columns of silicate species. The terminal oxygen atoms (Oₜₑᵣₘ) on the silicate cubes are partly hydrated. Six hydrogen atoms were localized in the difference maps for cube 1 [Si₈O₁₄(OH)₆]²⁻, and two hydrogen atoms on the second silicate cube 2 [Si₈O₁₈(OH)₂]⁶⁻. The overall charge-compensation is achieved by eight protonated hexamethyleneimine molecules, hydrogen bonding two neighboring cubes within one stack. An extensive hydrogen bond network is present in the crystal structure. All terminal oxygen atoms (Oₜₑᵣₘ) are engaged in hydrogen bonds with the Oₜₑᵣₘ of the neighbouring silicate cube, either as donor (OₜₑᵣₘH) or as acceptor (Oₜₑᵣₘ). Due to the short distance between the silicate cubes within a column, it is probable that the hydrogen atoms on the terminal oxygen atoms are flipping from one silicate cube to the other, spreading the net negative charge over the whole of the silicate column.

Each oxygen in OₜₑᵣₘH and each Oₜₑᵣₘ⁻ acts as a proton acceptor in a hydrogen bond with a water molecule. This way eight water molecules are located in the direct vicinity of a silicate anion. In accordance with the 24 water rule, each terminal oxygen is involved in hydrogen bonding to three protons resulting in a tetrahedral oxygen environment. One of the hydrogen bonds originates from the water molecules, one from a proton shared between cubes and the third from an hexamethyleneiminium ion, which in turn also binds to a neighboring cube in the same stack.

Silicate columns are connected through a network of water molecules. All terminal oxygen atoms are connected with a terminal oxygen atom of a neighboring silicate column through a chain of hydrogen bonds involving three water molecules, whereof one is not in direct interaction with any D4R unit.

The HMI molecules, all hydrogen bonded to two D4R cubes in one stack, are grouped by four thus maximizing the shielding of their hydrophobic moieties from the polar silicate-water network. The refined structure revealed that the hydrophobic parts of the HMI molecules are partially distorted.

Upon air drying HMI-CySH crystals lose most or all of their crystal water and the structure partially changes to form a new crystalline fase: HMI-CySA. X-ray diffractograms showing the transformation upon air drying of a silicate hydrate HMI-CySH in the mother liquid into the silicate amine HMI-CySA are shown in FIG. 11. A HRTEM image of a HMI-CySA crystal can be seen in FIG. 9-L.

It is to be expected that many other templates can be used to synthesise silicate hydrate materials. Especially but not exclusively water soluble amines with some degree of restrained flexibility (ring structures, high degree of branching, multiple charge centres) and quaternary methyl amines are interesting candidates as (co-)template in the synthesis of (new) silicate hydrate materials.

### Silicate Hydrates Containing Ethylenediamine Metal-Complex-Isolated Silicate Octamers and Cu(en)₂

A silicate hydrate containing isolated cubes was formed in presence of Cu(en)₂. In this structure all terminal oxygens are stabilized by three hydrogen bonds. 4 out of the 8 terminal oxygens are hydrogen bonded to nitrogen atoms of the metal-ethylenediamine complex.

Twenty further hydrogen bonds water molecules aligned with the edges of the silica cubes are involved.

### Silicate Hydrates Containing Ethylenediamine Metal-Complex-Double Three Ring Silicates and Ni(en)₃

Using metal ethylenediamine complexes several structurally different silicate hydrates have been obtained. Ni(en)₃ favors the formation of double three ring silicate units. The Ni(en)₃ molecules reside in channels formed by water molecules and the D3R silicate units.

### Silicate Hydrates Containing Ethylenediamine Metal-Complex-Cubic Octamers Bridged Together by Direct Hydrogen Bonds Using Co(En)₃.

Double four ring silicates are formed in presence of Co(en)₃. Those silicate units are directly linked to each other by hydrogen bridges between terminal oxygen atoms. Silica columns formed by silica cubes hydrogen linked though the edges are formed.

### Other Silicate Hydrates Synthesized Using Metal-Ethylenediamine Complexes

Some more silicate hydrates are formed using ethylendiamine complexes of zinc and palladium. The crystal structure of these silicate hydrates has not been reported so far.

### Silicate Hydrates Based on Alfa-Cyclodextrine

So far only one silicate hydrate with a double six-ring silicate unit is described in literature. This silicate hydrate structure includes alpha-Cyclodextrine. Potassium or sodium cations are necessary for compensating the charge of the cyclosilicate units. In the crystal structure layers of double six rings are sandwiched between double layers of alpha-Cyclodextrine molecules. In the centre of each of the hexagonal silicate face a potassium cation resides. Other potassium cations reside between the hexagonal silicate prisms. Each of the terminal oxygen atoms of a silicate unit takes part in three hydrogen bonds. Most of the hydrogen bonds engage the alpha-Cyclodextrine molecules and on average only 1.3 hydrogen bonds per terminal oxygen atom engage a water molecule.

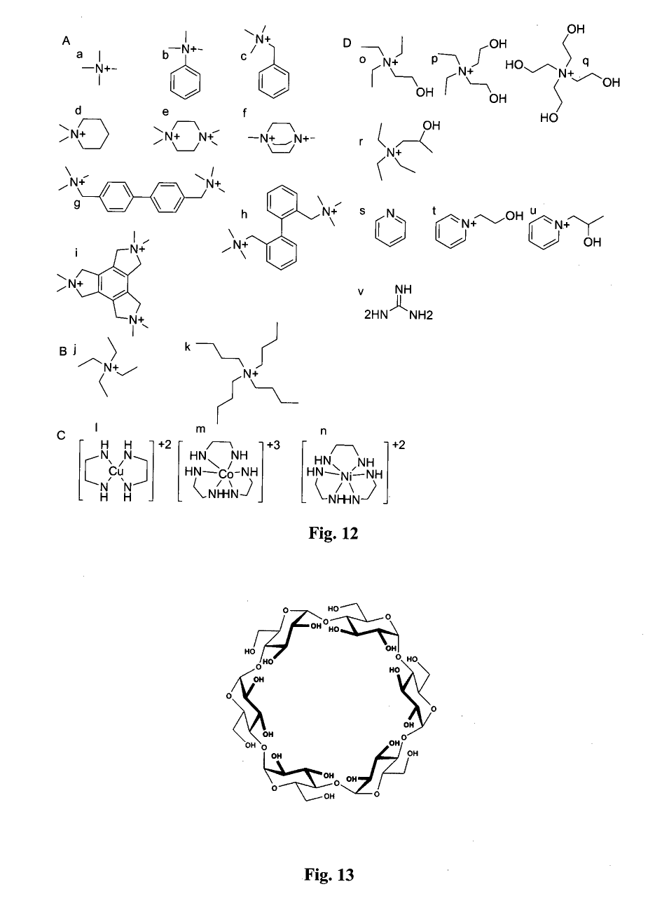

Presently three groups of silicate hydrate structures types having silicate units that are directly connected to each other through hydrogen bonds are described in literature. Furthermore it is found that in some if not all silicate hydrate materials a large fraction (if not all) of the crystal water can be removed while retaining specific silicate oligomers inside the structure. In a particular embodiment of present invention silicate hydrate crystals after drying, for instance drying under vacuum, are used to prepare silicate polymers by sylilation. The silicate oligomers are lined by silane compounds so that silicate oligomers are interconnected by siloxane bridges form a silica based polymers (poly oligosiloxysilane). The here above described or silicate hydrate structures that are for instance synthesized by a selection of the organic templates shown in FIG. 12, FIG. 13, mentioned in the above text are suitable for the production of the silicate oligomers used in the synthesis of the silica based polymers of present invention.

In another embodiment of present invention silicate oligomers are obtained through a catalyzed or spontaneous alcoholysis of Si—H groups on hydrosilsesquioxanes. In this way linear, ladder, cyclic or double ring silicate oligomers can be obtained in an organic suspension.

### Step b: Suspension of the Silicate Oligomers

Different silicate oligomer suspensions and other silicate oligomer containing materials are obtained by addition of silicate oligomers to a solvent or mixture of solvents.

N-methylimidazole, N-Methylpyrolidone, Acidic tetrahydrofuran, Acidic diethylether, acidic aqueous suspensions, Tetramethylammoniumhydroxide aqueous suspensions and many other solvents and combinations of solvents are suited to stabilize silicate oligomer suspension to a certain degree.

In some cases a stable suspension will form, in other cases after a short or a longer period of time a ((relatively)crystalline) silicate oligomer containing material is formed. In some other cases, the silicate oligomers will interact and other (often larger) silicate oligomers/polymers/nanoparticles can eventually form.

### Step c: (Re)Crystallizing Silicate Oligomers

As mentioned in step b above, some silicate oligomer suspensions are not stable in time and spontaneously crystalline silicate oligomer containing materials or larger silicate oligomers/polymers/nanoparticles can form. Removal of the solvent from a silicate oligomer suspension can also cause the silicate oligomers to precipitate in an ordered or disordered fashion. Further many other ways to form ordered silicate oligomer materials from silicate suspension are known by those skilled in the art and can for example be based on the reduction of the temperature of the suspension or based on the alternation of other properties of the solvent (pH, polarity, addition of salts, addition of templates, addition of surfactants, etc.). Recrystallization techniques are known by those skilled in the art as a way to purify molecules. Adapted recrystallization techniques are expected to be a possible way to improve the uniformity of the silicate oligomers speciation. Washing the silicate oligomers material with a suitable solvent is an alternative way to improve the uniformity of the silicate oligomers or to improve the crystalline nature of the silicate oligomer material.

### Step d: Removal of Excess Template

Removal of (excess) template can be performed by several methods. Washing of silicate hydrate crystals with a suitable solvent is a suitable way to remove excess template from the silicate oligomer materials. Vacuum drying; vacuum drying at increased temperature or an increased temperature in itself is in some cases enough to remove the template from some silicate oligomer materials. In some cases the removal of excess template is counter advised since excess of some templates acts as an adsorbent for the H(rgl) molecules (see step g).

### Step e: Removal of the Solvent

Removal of solvent from silicate oligomeric suspensions; silicate oligomeric crystals or silicate oligomeric species in general is performed by a range of possible methods.

Filtration, centrifugation, freeze drying and decantation are suitable methods for the removal of solvent from a suspension of silicate hydrate crystals from the mother liquid. For many suspensions containing silicate oligomers freeze drying or evaporation is used to remove the solvent from the suspension, but the higher the temperature the more this step can promote the formation of side products (for example through the formation of direct siloxane bonds between silicate oligomers) or the formation of a gel.

### Step f: Drying of the Silicate Oligomers

In reactions where silicate oligomers (A) and silanes (B) are to be interlinked by siloxane bonds, water is one of the key players in the formation of side products. Therefore the removal of water from the silicate oligomers (A) generally is a key step in the reduction of side products. The removal of water is performed in many different ways. The application of vacuum is one method to remove the adsorbed water and crystal water inside a silicate oligomer material. Application of heat is another potential interesting way to remove adsorbed water and crystal water inside a silicate oligomer material. Application of vacuum in combination with the application of heat is a next interesting possibility to remove the adsorbed water and the crystal water from the silicate oligomer material. Another method to dry silicate oligomer materials involves a flow of dry gas or a flow of dry air over the silicate oligomer material. Addition of drying agents also show an interesting potential to remove the adsorbed water and the crystal water from the silicate oligomer material. Some potential drying agents are amongst others: MgSO₄; CaSO₄; zeolite 3A; zeolite 4A; zeolite 5A; CaCO₃; CaO; CaH₂; Na; Na₂O, K, K₂O, Ag, Ag₂O, LiBH₄, NaBH₄ and many other drying agents known by those skilled in the art.

The desired reaction of the water adsorbent (w-ADS) is the following:

x(w-ADS)+aH₂O->(w-ADS)ₓ(H₂O)ₐ(with x>0 and a>0) (reaction: w-ADS 1)

whereby the water is physical or chemical bound to the water adsorbent (w-ADS).

A water adsorbent can also be used to remove water from silicate oligomer material. Further in some cases a wet silicate oligomer material can lose most of its water by standing in contact with the air.

The most preferred methods for drying aqueous suspensions of silicate oligomers involve evaporation or freeze drying; adsorbents are often a method of choice for drying organic suspensions of silicate oligomers. Vacuum; a dry air flow or a dry gas flow are often the methods of choice for drying solid silicate oligomer materials. In many of all the above mentioned drying procedures, heating is used to improve or accelerate the drying of the silicate oligomer materials.

Apart from the adsorbed water, also crystal water inside the silicate oligomer materials can be removed using the above mentioned drying methods.

Removal of water from the adsorbents for H(rgl) (optionally added in step g) is often also very important and can be performed in similar or different ways as the water removal from the silicate oligomers whereby the method is dependent upon the nature of the adsorbent.

### Step g: Addition of Adsorbents

In the reaction of silicate oligomers (A) with silanes (B) (with reactive leaving groups (rlg)), H(rgl) molecules are often formed. These H(rgl) can however disturb the further desired reactions of A with B, therefore it is desirable to remove the H(rgl) molecules from the reaction mixture. One way to do this is be adsorbing them with a suitable adsorbents. Suitable adsorbents are adsorbents that can react or adsorb H(rgl) without the formation of water. Depending on the nature of the H(rgl) different H(rgl) adsorbents are suitable. For the (strong) acids reactive leaving groups H(rgl) (HCl, HBr, HI, HF, CH₃—COOH) some of the materials with H(rgl) adsorbing potential are: primary amines, secondary amines, tertiary amines (some examples are: Dimethylformamide, pyridine, N-methylimidazole, hexamethylenetetramine, trioctylamine). Other materials with a strong potential for the adsorption of those acid reactive leaving groups and H—(OR) reactive leaving groups are Na, K, Ag, Na₂O, K₂O, Ag₂O, metal hydrides, acid anhydrides, Metal organic frameworks (MOF's) etc.

The desired reaction between the adsorbent (ADS) and the H(rlg) is:

xADS+nH(rlg)->(ADS)ₓ[H(rlg)]ₙ(with x>0 and n>0) (reaction: ADS 1)

whereby the H(rlg) is physical or chemical bound to the adsorbent (ADS) another potential useful reaction of the adsorbent is:

xADS+aH₂O->(ADS)ₓ(H₂O)ₐ(with x>0 and a>0) (reaction: ADS 2)

whereby the water is physical or chemical bound to the adsorbent (ADS)
some of the undesired reactions between the (ADS) and the H(rgl) and/or the silane are

xADS+zB->(ADS)ₓ(B)_{z}(with x>0 and z>0) (reaction: ADS 3)

xADS+nH(rlg)+zB->(ADS)ₓ[H(rlg)]ₙ(B)_{z}(with x>0 and z>0) (reaction: ADS 4)

other undesired reactions between the (ADS) and the H(rgl) and/or the silane are

xADS+nH(rlg)->(ADS)ₓ[H(rlg)]ₙ+yH₂O(with x>0 and y>0) (reaction: ADS 5)

xADS+zB->(ADS)ₓ(B)_{z}+yH₂O(with x>0 and y>0) (reaction: ADS 6)

xADS+nH(rlg)+zB->(ADS)ₓ[H(rlg)]ₙ(B)_{z}+yH₂O(with x>0 and y>0) (reaction: ADS 7)

In lab scale synthesis it is useful to use dry adsorbents and to add the dry adsorbents to the reactor vessel containing the dried silicate oligomer material. Removal of traces of water after this manipulation is carried out by a new drying step can be useful. Direct contact between the silicate oligomer material and the adsorbent can in some cases be counter-indicated due to the strong base properties of some potential H(rgl) adsorbents.

### Step h: Addition of the Silane Linker Molecules

In principle all silane compounds with minimal two reactive leaving groups are possible candidates as linker molecules in the synthesis of poly oligosiloxysilane materials. The size of the silanes is important since the silanes will have to diffuse towards the different silicate oligomers especially since the silicate oligomers are preferentially contained in an ordered or crystalline matrix. Therefore especially smaller silanes have a higher potential for the synthesis of poly oligosiloxysilane materials. Larger silanes unable to diffuse to through the silicate oligomer containing matrix can however be used to form siloxane bonds with the silicate oligomers on the outside of the particles or crystals. In some cases the silanes used in order to form siloxane bonds with the silicate oligomers on the outside of the particles or crystals do not have to have more than two reactive leaving groups since they do not always have to form siloxane bridges between the silicate oligomers

The silane compounds (B) are particularly suitable for present invention to connect the silicate oligomers, are silicon containing molecules of the form SiWXYZ whereby 2, 3 or 4 of the groups W, X, Y, Z are independently from the group of reactive leaving groups (rlg) (with the reactive leaving groups (rlg) independently from: H, OH, Cl, Br, I, NHR, NR₂, OSi(R)₃, NSi(R)₃, OSn(R)₃, OSb(R)₃ or OSi(R)₂H, OR, O(O)R (with R independently from: methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl, dibromoethyl or any organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, cyclic alkyne or their derivates) and whereby the remaining 0, 1 or 2 groups W, X, Y, Z are independently from the organic groups of one of the following types: H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, cyclic alkyne or their derivates. Hydrogen (H) is a specific case, dependent of the reaction conditions H is considered as a reactive leaving group (rlg) or an organic group. If during the reaction between silicate oligomers (A) and silanes (B) the Si—H bond of the silane is broken and replaces by a siloxane bond, than the “H atom” is considered a reactive leaving group (rlg) else “H” is considered an organic group.

The more preferred silanes have a general formula SiXₓ(R)₄₋ₓ, with x=2, 3 or 4; X═Cl or Br and with R═H, CH₃, C₂H₃, C₂H₅ or any other small alkyl or alkenyl group.

In an embodiment of present invention to connect the silicate oligomers as described in present application, apart from silanes containing one silicon atom, also silanes containing multiple silicon atoms are used, as long as there are minimum two reactive leaving groups (rlg) on the silane compound. Bonds between the different silicon atoms in these silane compounds can be independently of the following types: Si—Si bonds, Si—O bonds, Si—C bonds and Si—N bonds.

Depending on the vapor pressure of the silane, the nature of the silane, the temperature, the environment (closed versus open; vacuum versus gas atmosphere), the nature of the silicate oligomer material, the desired product, the reaction rate, the available set-up etc. Different methods for the addition of silanes onto the silicate oligomer materials are recommended.

In an embodiment of present invention volatile silanes are brought into contact with the silicate oligomers trough the gas phase. Through an air flow (partially) saturated with silane vapors or through a gas flow (partially) saturated with silane vapors, silanes are brought into contact with the silicate oligomer materials. In another embodiment of present invention silanes are added to a closed recipient containing silicate oligomer materials while avoiding direct contact between the silanes and the silicate oligomer materials other than through the vapor phase.

Furthermore silanes will be divided into three groups depending on the aggregation conditions (gaseous, liquid and solid) of the silane at the temperature of the reaction vessel where the silane will react with the silicate oligomer material.

In yet another embodiment of present invention, liquid or solid silanes are impregnated into solid silicate oligomer materials in a way (partially) similar to impregnation procedures for zeolites. In an embodiment of present invention liquid silane are added to solid silicate oligomer material or solid oligomer material are added to liquid silane. In yet another embodiment of present invention a silane (gas, liquid, solid) is added to a suspension of silicate oligomers or a suspension of silicate oligomers is added to any silane (gas, liquid, solid). In another embodiment of present invention solid silanes are mixed with solid silicate oligomer materials. In yet another embodiment of present invention a silane (gas, liquid, solid) is dissolved into a solvent and this solvent is added to a solid silicate oligomer material or a solid silicate oligomer material is added to a solvent containing a silane (gas, liquid, gas) or a silane (gas, liquid, solid) is dissolved into a solvent and this solvent is added to a suspension of silicate oligomer materials or a suspension of silicate oligomer materials is added to a solvent containing a silane (gas, liquid, gas).

In another embodiment of present invention silanes are added to the silicate oligomers in several different stages. In yet another embodiment of present invention more than different silanes is brought into contact with the silicate oligomer material. Similar or different silanes are added at the same time or at different moments during the synthesis procedure. Addition of similar or different silanes is performed using a similar method or using different addition methods.

In another embodiment of present invention the silanes are purified prior to the addition of the silanes to the silicate oligomers. This purification is performed using standard methods known by those skilled in the art, for example: distillation; drying; vacuum distillation; distillation over NaOH; over pyridine or over other chemicals known by those skilled in the art.

### Step i: Formation of Siloxane Bonds Between the Silicate Oligomers and the Silanes And/or Siloxane Bridges Between the Silicate Oligomers

Siloxane bonds can be formed between silicate oligomers (A), between silicate oligomers (A) and silicon containing compounds (b) or between silicon containing compounds (b). The present invention involves a method to reduce the formation of both the siloxane bonds between silicate oligomers (A) and the siloxane bonds between silicon containing compounds (b). Diffusion of silanes (B) towards the silicate oligomers (A) is essential in order to be able to form siloxane bonds between silicate oligomers (A) and silicon containing compounds (b). In order to allow diffusion of silanes toward the silicate oligomers in the center of the silicate oligomer materials, the silicate oligomer material should be porous or at least the structure should be flexible enough to allow silanes to diffuse inside the silicate oligomer material in order to reach the different silicate oligomers.

Silanes that are not capable of diffusing to the inside the silicate oligomer material generally only react to silicate oligomers on the outer shell of the silicate oligomer materials. In this case a second (smaller) silane capable of diffusing towards the inside of the silicate oligomer material can simultaneously or consecutively react with the different silicate oligomers more at the inside of the silicate oligomer material.

Reaction rates of the reaction between the silicate oligomers (A) and the silane (B) are very dependent upon: the reaction temperature; the diffusion rate; the molecular dimensions of the silane; the type of reactive leaving groups on the silane; the number of reactive leaving groups on the silane; the concentration of the silane; the structure of the silicate oligomers; the structure of the silicate oligomer material; the size of the silicate oligomer particles, the reaction coordinate; the concentration of H(rlg); the water content of the reaction vessel; the side reactions, the method to add the silane and many other reaction conditions (for example vacuum versus gas flow) etc.

When several silanes are used simultaneously of consecutively, the distribution of the siloxane bridges formed by the different silanes are dependent upon the reaction temperature; the diffusion rate of the different silanes; the molecular dimensions of the different silanes; the type or the different types of reactive leaving groups on the different silanes; the number or the different numbers of reactive leaving groups on the different silanes; the concentration of the different silanes and the differences between the silanes; the structures of the silicate oligomers; the structure of the silicate oligomer material; the size of the silicate oligomer particles, the reaction coordinate; the concentration or the different concentrations of H(rlg) or the different H(rgl)'s; the water content of the reaction vessel; the side reactions, the order of addition of the different silanes, the different methods used to add the silanes, the time or different times when the different silanes are added and many other reaction conditions (for example vacuum versus gas flow) etc.

In a particular process of the present invention a catalyst is added in order to have a sufficient reaction rate between the silanes and the silicate oligomers. A catalyst is especially useful for reactions between a silane and a silicate oligomer whereby the reactive leaving group on the silane is a H atom or a less reactive OR or O(O)CR group.

Removal of the formed H(rgl) during or after the reaction can also be of importance in order to increase the number of siloxane bonds between the silanes and the silicate oligomers.

### Step j: Removal of H(Rlg)

In the reaction of silicate oligomers (A) with silanes (B) (with reactive leaving groups (rlg)), H(rgl) molecules are generally formed. These H(rgl) can however disturb the further desired reactions of A with B, therefore it is be desirable to remove the H(rgl) molecules from the reaction mixture. One way to do this is be adsorbing them with a suitable adsorbents as described in step g. Another way is to remove the H(rgl) vapors from the reaction mixture. These vapors are removed by a (dry) gas flow or a (dry) air flow over the silicate oligomer material during or after the reaction between the silanes and silicate oligomers. H(rgl) can also be removed though the application of vacuum. Together with H(rgl) also silanes are removed, therefore it thet steps h, i and j can be repeated until the reaction between the silicate oligomers and the silanes went to a satisfactory completion. the in step h described addition of silanes through a (dry) air flow or a (dry) gas flow over the silicate oligomer material can be optimized to remove (some of) the formed H(rgl).

### Step k: Removal of Excess Silane Linker Molecules

Removal of excess of silane is not a mandatory step in a poly oligosiloxysilane synthesis procedure, often however it is desirable to avoid to have large quantities of bₓ oligomer and bₙ polymers next to the Abₓ polymer.

In order to reduce the amount of bₓ and bₙ in the final Abₓ polymer many potential pathways can be applied. A first and often desired pathway is to start with pure silane. Some silanes tend to be not too stable over time. They often react with traces of water to form Si—OH groups or even small oligomers bₓ or polymers bₙ. During storage spontaneous or catalyzed disproportionation or group transfer reactions of the silanes can sometimes occur. Therefore it is advisable to purify the silanes prior to the addition of the silanes to the silicate oligomer material. Furthermore since bₓ oligomers and bₙ polymers are not always too easy to remove from Abₓ polymers it is desired to avoid the formation of those bₓ oligomers and bₙ polymers. Factors stimulating the formation of these undesired bₓ and bₙ species are: the presence of water during reaction of the silicate oligomers with the silanes; the addition of large excess of silanes to the silicate oligomer material; the presence of formed H(rgl) and no removal or only a limited removal of excess unreacted silane monomer after the reaction between the silane and the silicate oligomers has went to the desired completion. Also the temperature or the presence of a catalyst can influence the formation of the bₓ oligomers and bₙ polymers.

Removal of (some) excess silane, silane oligomers bₓ, or silane polymers bₙ is possible through some of the following techniques or some combinations of techniques: the application of vacuum; heating whether or not in combination with vacuum; a washing procedures; a soxlet extraction an alkoxylation of the silanes with alcohols followed by a washing procedure, a soxlet extraction, the application of vacuum with or without heating; etc. When the silane (B) has more than two reactive leaving groups (rlg) then the removal of the formed bₓ oligomer and bₙ polymer species can be even more difficult. If in this case only limited amounts of bₓ and bₙ species are desired within the Abₓ polymer, than the avoidance of the formation of bₓ and bₙ species can be even more important.

### Step l: Addition of Water to the Formed Material

After formation of the Abₓ polymer generally still reactive leaving groups (rlg) attached to the “A” and/or “b” parts and some H(rgl) molecules are present inside and outside of the Abₓ polymer. Through the addition of water (vapor, liquid or in a solvent); a material with chemically bound water (for example NaOH, KOH, . . . ) or a material with physically bound water (material•xH₂O), the reactive leaving groups attached to the “A” and/or “b” part will be exchanged for silanol groups. In the case H(rgl) is a (strong) acid, the H(rgl) can be neutralized using a base.

### Step m: Removal of Template Molecules

In many cases there is still a large amount of organic material present in or around the Abₓ polymer. In some cases there is also an amount of inorganic cations, inorganic anions of inorganic salts present in or around the Abₓ polymer. This organic or inorganic material can for example originate from an organic template (for example: HMI, HMI.HCl, TBA, TBA•HCl, tributylamine, triputylammoniumchloride, en, en•HCl, en•2HCl, tri-en, . . . ), an inorganic template (for example: Na⁺, K⁺, Mg²⁺, Ca²⁺, . . . ), the H(rgl) (for example: HOR, R¹COOR², R₃Sn—O—SnR₃, HMI.HCl, . . . ), an organic solvent used in one of the reaction steps a to n, the water adsorbent (step f), the H(rgl) adsorbent (step g) or from a reaction of the silane with any of the not silicon containing components used in step a to n.

Depending on the nature of this organic or inorganic material present in or around the Abₓ polymer different methods to remove this organic or inorganic material are used. In many cases a washing procedure or a soxlet extraction is applied to remove all or a part of this organic and/or inorganic material. A cation or anion exchange procedure (for example with a NH₄Cl solution) can in some case be used to remove cations or anions present in or around the Abₓ polymer. The cations or anions present in or around the Abₓ polymer after the exchange procedure can be removed using one of the methods known by those skilled in the art. For some of the organic compounds heating, the application of vacuum or vacuum in combination with heating is used to remove part or all of the organic compounds. Calcination in inert gas, in air or in oxygen is another potential procedure to remove the organic compounds.

Some of the methods described above can also change the properties of the organic groups on the b part of the Abₓ polymers, if this is not desired than a different method for the removal (of the organic or inorganic material present in or around the Abₓ polymer) should be chosen.

### Step n: Repetition of any of the Steps a to m

In order to get the desired crystal structure and/or the right crystallinity and/or the right crystal size or the right silicate oligomer it is possible to repeat one or more of the synthesis steps a to e.

In order to get the desired speciation of silanes over the Abₓ polymer, in order to reduce the amount of A* end groups (with A* being a silicate oligomer in an Abₓ polymer with one or more silanol groups or a reactive leaving groups), in order to introduce different silanes into the Abₓ polymer, in order to get specific materials it can desirable to repeat one or more of the synthesis steps f to j. In order to remove bₓ, bₙ, organic templates, inorganic template molecules etc. it can be desired to repeat one or more of the synthesis steps k to m.

### Step o: Silylation of the Outer Surface.

In order to get the desired properties it can be useful to do a surface treatment on the Abₓ polymers. For example in order to get a hydrophobic outer surface of the Abₓ polymer an additional silylation step is useful. In order to crosslink the Abₓ polymer with an organic polymer it is useful to do an additional silylation step with a silane containing a H, vinyl or aryl group.

### Step p: Removal of Solvent(s)

In many of the steps a-o solvents can be used. In some synthesis steps it is desired to remove the solvent. Solvents are removed using one or a combination of the following methods: application of vacuum, heating, a combination of heating and the application of vacuum, a solvent exchange procedure (washing, solvent extraction), calcination (in inert atmosphere, in air, in oxygen), through adsorption on an added adsorbent, filtration, centrifugation, decantation, etc.

In the present invention the silicate oligomer containing material should be more or less ordered prior to the formation of the siloxane bridges in order to obtain an ordered silicate polymer material. In another embodiment of the present invention the silicate oligomer containing material is not fully ordered, but only the material containing the silicate oligomers connected to silane molecules but prior to the formation of the siloxane bridges is ordered and still an ordered silicate polymer material is obtained. In this specific case (most or all of) the siloxane bridges will be composed of more than one silane molecule.

In the following equations some of the potential reactions occurring in the synthesis of poly oligosiloxysilanes are given:

A+xB→Abₓ+xH(rlg) (equation 1)

A+H(rlg)←>A*(rlg)+H₂O (equation 2)

nB+yH₂O<→bₙ+2yH(rlg)with n/2≦y (equation 3)

Abₓ+nB+yH₂O<→Abₓ₊ₙ+2nH(rlg)with n/2≦y (equation 4)

(With “A*(rlg)” being A whereby one silanol (Si—OH) group is replaced by a Si-(rlg))

It should be clear that especially the reaction of equation 1 is preferred. The other reactions could eventually lead to the formation of side products.

It is also an object of present invention to control direct siloxane bond formation between different silicate oligomers (A). According to an aspect of the present invention there is also provided a system to control such direct siloxane bond formation. The direct siloxane bond formation between different silicate oligomers (A) is reduced though stabilization of the silicate oligomers. The surface of silicate oligomers generally contains silanol groups of the form Si—O⁻; Si—OH or Si—OH₂⁺. These silanol groups can react with each other to form siloxane (Si—O—Si) bonds. This siloxane bond formations is catalyzed by among others: acid, base or fluor ions. In order for two silanol groups to react with each other the interatomic distance between the different silicon atoms should be small enough. Reduction of the A-A bond formation without excluding the A-B bond formation is done in different ways.

The A-A bond formation between the silanol groups on A is reduced through stabilization of the silanol groups. This stabilization is originating in sterical hindrance, Hydrogen bonding of the silanol groups, charge repulsion, interaction with other molecules (for instance amines). Different silicate oligomers (A) in a crystalline matrix or in a non crystalline matrix will have a limited mobility and therefore the A-A bond formation can also be hindered. All of these above mentioned techniques to reduce the A-A bond formation are of importance in the present invention. A limited mobility of silicate oligomers due to the incorporation in a (crystalline or non crystalline) matrix is however a more desired stabilization technique for the reduction of A-A bonds.

Some of the stabilization to be used to reduce the A-A bond formation will be discussed into more detail below. In aqueous conditions silicate oligomers often possess a positive or negative charge. This charge can create a repellent force which makes it difficult for two silicate oligomers to approach well enough to react with each other. Therefore in specific conditions (relatively) stable aqueous silicate oligomer suspensions are obtained. In specific conditions especially at very high pH and/or at very low pH stable silicate oligomeric suspensions are obtained. In addition to the stabilization of silicate oligomers in aqueous suspensions, we have been able to make (relatively) stable suspensions of silicate oligomers in some organic solvents. The formation of stable suspensions of silicate oligomers in organic suspensions is however not yet fully understood, small traces of water can in some cases play an important role in the dispersion, stabilization or destabilization of the silicate oligomers. In some cases also the addition of an (strong) acid (for example: HCl, SO₃, H₂SO₄, HNO₃, acetic acid, etc.) is mandatory in order to stabilize the suspension. In some suspensions, the ability to form one or more hydrogen bonds between the silicate oligomers and the organic solvent is expected to be of major importance. Also the presence of some kind of a (local) dipole moment in the organic solvent molecules seems mandatory in order to make a stable silicate oligomer suspension. Therefore organic solvents or mixtures capable of stabilizing silicate oligomers desirably contain minimum one organic compound with minimum one N, O, S or P atom in its structure. Moreover organic compounds having minimum two N, O, S and/or P atoms in there structure are more likely to stabilize silicate oligomer suspensions. Especially organic compounds having two or more (N, O, S or P) atoms connected to the same carbon atom have been found to stabilize silicate oligomer suspensions. Some examples of organic solutions used in the formation of (relatively) stable silicate oligomer suspension are: dimethylformamide; dimethylacetamide; N-methyl imidazole; N-methylpyrolidone; gamma-butyrolactone; Pyridine; dimethylsulfoxide; mixtures of tetrahydrofuran and HCl; mixtures of dioxane and HCl; mixtures of tetrahydrofuran, HCl and diethylether; mixtures of tetrahydrofuran and H₂SO₄; mixtures of acetone and HCl etc. Another method to avoid silicate oligomers to form stable siloxane bonds with each other is to coat them with organic groups. One way of coating them is to replace (some) of the silanol groups with alkoxy groups. One way to replace silanol groups with alkoxy groups is to dissolve the silicate oligomers in a suspension containing alcohol. This relatively slow replacement reaction is catalyzed by acids (for example: HCl, HClO₃, HI, HIO₃) or bases (for example: NaOH, sodium ethanolate, pyridine). This replacement reaction is accelerated by increasing the reaction temperature. Replacement of silanol groups by alkoxy groups follows an equilibrium process. Therefore the ratio of alcohol to water is very important. A low ratio of alcohol to water will yield only a limited amount of alkoxy groups. A high ratio of alkoxy to silanol is obtained in organic liquids using an excess of alcohol. A (azeotropic) destilation to remove the formed water increases this alkoxy/silanol ratio. Furthermore a high ratio of alkoxy groups compared to silanol groups is obtained using for example trimethoxy acetate; trimethoxy formate; triethoxy acetate or triethoxy formate. Silicate oligomers coated to some extend with alkoxy groups can be seen as silane compounds. In particular embodiment of present invention silicate oligomers (with more than three silicon atoms) coated to some extend with one or more alkoxygroups are considered as being silicate oligomers.

Sterical hindrance around the silanol groups can also cause a stabilization of silanol groups. Sterical hindrance can be caused by organic groups connected to the silicate oligomer, alkoxy-groups connected to the silicate oligomer, a specific shape of the silicate oligomer, etc. Similar to the stabilization of silanol groups also alkoxy groups connected to silicon are stabilized through sterical hindrance.

Furthermore silanol groups involved in hydrogen bonding with water, organic templates or other silanol groups are in some cases be stabilized due to a reduced mobility or due to sterical hindrance.

In an embodiment of present invention a method to avoid silicate oligomers to connect to each other through siloxane bonds is to make the individual silicate oligomers less mobile. This reduced mobility will make that the different silicate oligomers cannot meet each other and therefore cannot form siloxane bonds. Materials of the classes of natural occurring nesosilicates, sorosilicates, cyclosilicates, inosilicates and the pyroxenes are some examples of materials where the silicate oligomers or silicate chains are stabilized through entrapment in a crystal structure.

In an embodiment of present invention silicate oligomers are entrapped in the crystal structure of the synthetic silicate hydrates and silicate amines. Through this entrapment the silicate oligomers and silicate chains encounter a reduced mobility. The silicate oligomers cannot or hardly move within the crystal structure, however in some materials the crystal structure is still flexible or soft enough to allow small molecules to enter the crystal. This unexpected flexibility allows (small) silane compounds to enter the crystals and to react with the silanol groups of the silicate oligomers without rearranging the crystal structure as a whole to a large extend. This allows the formation of new ordered silicate-silane mixed structures (poly oligosiloxysilane) to be prepared. All other known methods to stabilize nanoparticles in suspensions (high concentration of other solutes, a polymeric coating, an electrical double layer, dilution, dispersion in a liquid with a high viscosity, low temperature, freezing, freeze drying, etcetera) are also potential candidates to figure as method to stabilize silicate oligomers. These methods involve a large variety of different approached and are known by those skilled in the art and will therefore not be mentioned further. All above mentioned methods for the stabilization of silicate oligomers (A) are good starting points for the synthesis of poly oligosiloxysilane materials (Abₓ), whereby the stabilization techniques involving hydrogen bonding and especially a reduced mobility of the silicate oligomer species are among the more preferred stabilization techniques.

A further embodiment of the present invention, concerns the control of the b-b bond formation in the production of silica based polymers. In order to reduce b-b bond formation and the formation of bₓ (2≦x≦20) oligomers and polymers (n >20), it is desirable to avoid contact between the silane compounds and water. Water will promote the formation of silanol groups on the silanes and therefore enable the silane molecules (B) to react with other silane molecules (B) through b-b siloxane bond formation. Silanes in general do not possess silanol groups. Silanes in general do not react with each other except at high temperature or when water is present. In the absence of water silanes are more prone to react with silanol groups than with each other. Some of the techniques described above are in present invention embodied as method of silytation control to generate desired variability in the design and production of silica based polymers. Reduction the temperature of the synthesis is expected to suppress the siloxane bond formation between different silanes (B) especially in the absence of water.

Removal of the H(rgl) formed through reaction of a silane with a silanol group (for example a silanol group on a silicate oligomer) is also expected to reduce the b-b bond formation due to the following equations (5-7)

A+xB→Abₓ+xH(rgl) (equation 5)

A+H(rgl)<->A*(rlg)+H₂O (equation 6)

nB+y H₂O→bₙ+2yH(rgl)(n−2≦y) (equation 7)

(With A*(rlg) being A with one silanol group (Si—OH) replaced by a Si-(rlg) bond and with bₙ an oligomer or polymer whereby n silane units (B) are connected by y siloxane bonds.)

Another embodiment of present invention is the generation of silica based polymers of the form of A-b-b-A whereby B is a silane compound, b is a silicon containing compound and A is a silicate oligomer, a silane or silicate oligomer as defined in this application here above and whereby the b-b bond is a siloxy bond. Such structure according to the general formula, A-b-b-A, is obtainable in silicate oligomer suspensions in the absence of water whereby enough silane (B) is used and whereby the addition of silane is followed by a removal of the excess silane and subsequently water is added. Especially through departing from silicate oligomer containing solids where the silicate oligomers are located at somewhat larger distances from each other A-b-b-A materials are obtainable. These A-b-b-A materials can however also be expressed by the general formula Abₓ′ whereby b′ is a double siloxane bridge with b′=b-b and with a siloxy bond between the two different silicon containing compounds b. The methods to make such silica based polymers and the materials obtained by this process are an embodiment of present invention. b-b bound can be formed through the addition of water or heat. Optimally the A-b bonds are formed prior to the b-b bonds, although this is not always mandatory.

### EXAMPLES

### Example 1

### HMI-CySH/HMI-CySA: Linear Chains of D4R Silicate Oligomers Connected Through Hydrogen Bonds

20 ml Hexamethyleneimine (HMI) was added to a 250 ml polypropylene containing 60 ml of deionized water. To this stirred aqueous mixture, 20 ml tetraethyl orthosilicate (TEOS) was added over a period of 60 minutes. This mixture was stirred continuously until crystals were formed. After 3 additional days of stirring, the mixture was filtered. A white/yellowish powder is obtained, HMI-CySH crystals. The structure of the silicate hydrate material was confirmed using X-ray diffraction (XRD). Though a loss of crystal water HMI-CySH crystals are easily transformed into HMI-CySA crystals. This transformation process can easily be followed using XRD techniques as can be seen in FIG. 11. A HRTEM image of a HMI-CySA crystal can be seen in FIG. 9-L.

### Example 2

### TBA-En: D4R Connected Through Hydrogen Bonds in a Three Dimensional Network

20 ml Tetrabuthylammonium hydroxide (40 wt % in water) and 20 ml ethylenediamine were added to a 250 ml polypropylene containing 48 ml of distillated water. To this stirred aqueous mixture, 20 ml tetraethyl orthosilicate (TEOS) was added over a period of 40 minutes. This mixture was stirred continuously until crystals were formed. After one additional month of stirring, the mixture was filtered. A white/yellowish powder is obtained, TBA-en crystals. The structure of the silicate hydrate material was confirmed using X-ray diffraction (XRD).

### Example 3

### TBA-Dien: D4R Connected Through Hydrogen Bonds in a Three Dimensional Network

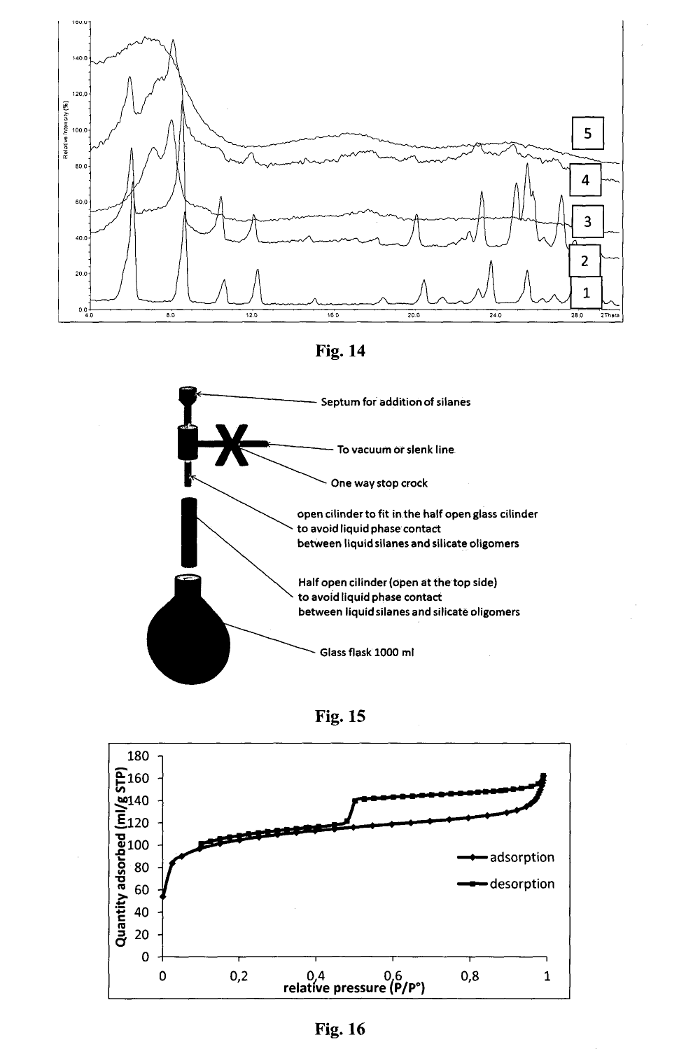

20 ml Tetrabuthylammonium hydroxide (40 wt % in water) and 20 ml diethylenetriamine were added to a 250 ml polypropylene containing 48 ml of deionized water. To this stirred aqueous mixture, 20 ml tetraethyl orthosilicate (TEOS) was added over a period of 60 minutes. This mixture was stirred continuously until crystals were formed. After 3 additional days of stirring, the mixture was filtered. A white/yellowish powder is obtained, TBA-dien crystals. The structure of the silicate hydrate material was confirmed using X-ray diffraction (XRD) (FIG. 14-1).

### Example 4

### TBA-Trien:_D4R Connected Through Hydrogen Bonds in a Three Dimensional Network

20 ml Tetrabuthylammonium hydroxide (40 wt % in water) and 20 ml triethylenetetramine were added to a 250 ml polypropylene containing 50 ml of deionized water. To this stirred aqueous mixture, 20 ml tetraethyl orthosilicate (TEOS) was added over a period of 60 minutes. This mixture was stirred continuously until crystals were formed. After 2 additional days of stirring, the mixture was filtered and washed with deionized water in order to remove excess of triethylenetetramine. A white powder is obtained, TBA-trien crystals. The structure of the silicate hydrate material was confirmed using X-ray diffraction (XRD).

### Example 5

### TMA Isolated D4R

40 ml Tetramethylammonium hydroxide (25 wt % in water) was poured into to a 125 ml polypropylene bottle. To this stirred aqueous mixture, 10 ml tetraethyl orthosilicate (TEOS) was added over a period of 30 minutes. This mixture was stirred continuously until crystals were formed. After 5 additional days of stirring, the mixture was filtered. A white powder is obtained, TMA cyclosilicate hydrate (TMA-CySH) crystals. The crystalline nature of the material was confirmed using X-ray diffraction (XRD). The ordering of the material changed and became less prominent upon air drying.

### Example 6

### Suspension of D4R

1 gram of HMI-CySH/HMI-CySA (EXAMPLE 1) was dispersed into 30 ml dry tetrahydrofuran (THF) and 5 ml of a 2 M solution of HCl in diethylether was added. The suspension was stirred for 30 minutes and filtered. The retentate is to a large extent a chlorine salt of hexamethyleneimine. The filtrate contains double-four-ring silicate oligomers. ²⁹Si NMR of the suspension showed one sharp peak, providing the evidence for the presence of double four-ring-silicate oligomers.

### Example 7

### Suspension and Crystallization of D4R

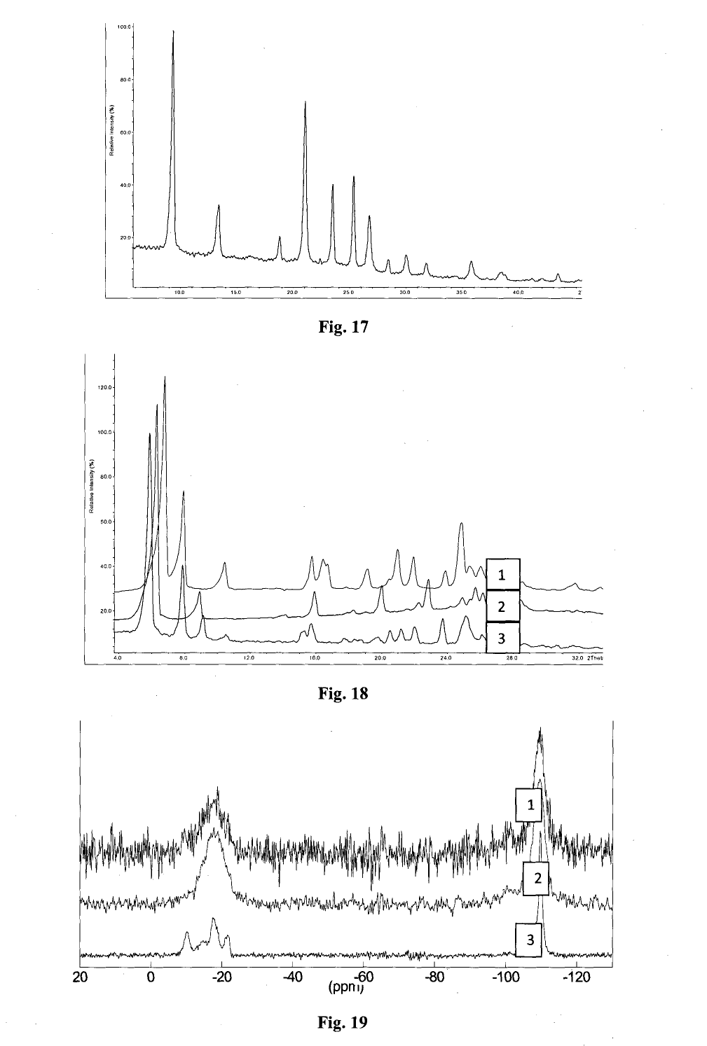

1 gram of HMI-CySH/HMI-CySA (EXAMPLE 1) put into 30 ml dry tetrahydrofuran (THF). 5 ml of a 2 M solution of HCl in diethylether was added. The suspension was stirred for 30 minutes and filtered. The retentate is to a large extent a chlorine salt of hexamethyleneimine. The filtrate contains containing a large part of the double-four-ring silicate oligomers and was at room temperature, slowly evaporated under reduced pressure. The remaining powder is a crystalline, water sensitive material containing columns of double-four-ring silicate oligomers and some other (organic) molecules. The general structure of this crystalline material was obtained using X-ray diffraction techniques (FIG. 17).

### Example 8

### Change of Crystal Structure Due to Solvent

1 gram of HMI-CySH/HMI-CySA (EXAMPLE 1) put into 25 ml aceton. The suspension was stirred, filtered and washed with aceton. The retentate was a crystalline white solid with a different X-ray diffraction pattern as the original HMI-CySH or HMI-CySA crystals (FIG. 18).

### Example 9

### Suspension of D4R

1 gram of HMI-CySH/HMI-CySA (EXAMPLE 1) put into 30 ml N-methylimidazole. After several minutes up until one day, a relatively clear suspension was obtained. The suspension was stable during several days and ²⁹Si NMR showed only one sharp resonance peak assigned to double-four-ring silicate oligomers.

### Example 10

### Sylilation of Glassware

A mixture of dry toluene (20 ml) chlorotrimethylsilane (1 ml) were added to a 2-neck flask.

The system was closed and shaken for 1 day. The liquid was disposed and the flask was rinsed three times with dry toluene (3*20 ml) and subsequent with methanol (3*20 ml). The flask is dried at 100° C., closed and stored at room temperature up until its use.

### Example 11

### Drying Cyclosilicate Hydrate Materials

1 gram of crystals (EXAMPLE 1) was added into a sylilated 2-neck flask (EXAMPLE 10). One end is closed with a septum, the other is connected through a stopcock with glassplug with a Slenk line. In order as much water as possible the crystals are dried for 24-96 hours at a pressure below 3 mBar.

### Example 12

### Drying Cyclosilicate Hydrate Materials

1 gram of crystals (EXAMPLE 1) were added into an open 10 ml glass vial inside a 100 ml sylilated 2-neck flask (EXAMPLE 10). One end is closed with a septum, the other is connected through a stopcock with glassplug with a Slenk line. In order as much water as possible the crystals are further dried for 24-96 hours at a pressure below 3 mBar. Subsequently the flask is put at atmospheric pressure with dry N₂ gas and the stopcock is closed.

### Example 13

### Drying Cyclosilicate Hydrate Materials

2 gram of (dry) crystals (EXAMPLE 1) were added into a 1000 ml sylilated glass set-up (see FIG. 15) (EXAMPLE 10). In order as much water as possible the crystals are (further) dried for 24-96 hours at a pressure below 3 mBar.

### Example 14

### Drying Cyclosilicate Hydrate Materials

2 gram of (dry) crystals (EXAMPLE 1) were added into a 1000 ml sylilated glass set-up (see FIG. 15). In order as much water as possible the crystals are (further) dried for 24-96 hours at a pressure below 3 mBar at a temperature of about 50° C.

### Example 15

### Linear Chain Poly Oligosiloxysilane

To 1 gram of crystals (EXAMPLE 1) in a 2-neck flask (250 ml) vacuum dried (following the procedure of EXAMPLE 11) 0.8 ml of dichlorodimethylsilane is added and the mixture is shaken by hand in order to wet all crystals evenly. After 7 days, the flask was put again under vacuum to remove the unreacted dichlorodimethylsilane. The resulting material is hydrophobic and the presence of HMI.HCl salt is confirmed using X-ray diffraction. Specific distances between the silicate oligomers is confirmed by a X-ray scattering signal at a d-value of about 1.4-1.6 nm.

### Example 16

### Three Dimensional Poly Oligosiloxysilane with a Structure Related to the Structure of Zeolites with a LTA Topology

To 2 gram of crystals (EXAMPLE 3) in a 2-neck flask vacuum dried—following the procedure of EXAMPLE 11-2.5 ml of dichlorodimethylsilane is added and the mixture is shaken by hand in order to wet all crystals evenly. After 7 days, the flask was put again under vacuum to remove the unreacted dichlorodimethylsilane. The resulting poly oligosiloxysilane is a white/yellow powder and is characterized using the X-ray diffraction technique and ²⁹Si MAS NMR.

### Example 17

### Coupling Reaction with Dichlorodimethylsilane, Gas Phase

To 2 gram of crystals (EXAMPLE 3) vacuum dried (following the procedure of EXAMPLE 14) 1.5 ml of dichlorodimethylsilane is added. After 1 day, the flask was put again under vacuum to remove the unreacted dichlorodimethylsilane. The resulting poly oligosiloxysilane is a white/yellow powder and is characterized using the X-ray diffraction technique and ²⁹Si MAS NMR.

### Example 18

### Coupling Reaction with Dichlorodimethylsilane, Liquid Phase

To 2.7 gram of crystals (EXAMPLE 3) vacuum dried (following the procedure of EXAMPLE 13) 3.5 ml of dichlorodimethylsilane is added. The 2-neck flask is put under a slight underpressure and the mixture is shaken by hand in order to wet all crystals evenly. After 7 days, the flask was put again under vacuum to remove the unreacted dichlorodimethylsilane. The resulting poly oligosiloxysilane is a white/yellow powder and is characterized using the X-ray diffraction technique.

### Example 19

### Coupling Reaction with Tetrachlorosilane, Gas Phase

In a dessicator with a total volume of about 3 liter, 5.5 gram of crystals (EXAMPLE 3) vacuum dried where mixed with 7.5 gram of dry hexamethylenetetramine. During 96 hours the dessicator was put under vacuum at a pressure below 3 mbar in order to remove water. Consequently 3.5 ml of SiCl₄ is added, care was taken to avoid contact between the liquid silane and the silicate hydrate material. After 48 hours the dessicator was evacuated again in order to remove the excess silanes and eventually some of the formed HCl gas. The resulting poly oligosiloxysilanes is a white powders and is characterized using X-ray diffraction. X-ray diffraction shows many diffraction peaks. After washing with methanol, trimethylorthoacetate and water a white material is obtained. This material is characterized by X-ray diffraction and ²⁹Si NMR. Using X-ray diffraction several diffraction peaks are obtained, with ²⁹Si MAS NMR three sharp signals for respective Q², Q³ and Q⁴ silicon species are present.

### Example 20

### Coupling Reaction with Trichlorosilane, Gas Phase

To 1 gram of crystals (EXAMPLE 1) vacuum dried (following the procedure of EXAMPLE 15) 5 ml of cold (5° C.) trichlorosilane is injected trough the septum, inside the 2-neck flask (100 ml), but outside of the open glass vial. The 2-neck flask was left at room temperature for 7 days. During those 7 days, the flask was connected several times to the dry N₂ side of the Slenk line in order to avoid a too high pressure building up. After 7 days, the flask was put under vacuum to remove the unreacted trichlorosilane. The resulting white/yellow powder was characterized using the X-ray diffraction technique and shows a broad scattering signal corresponding to a d-distance of about 1.5 nm.

### Example 21

### Removal of Template and Silane Oligomers

1 Gram of white/yellow powder (example 18) was put in a polypropylene bottle and purified in using the following method. To this bottle was added consecutively 15 ml of the following solvents or solvent mixtures: ethanol (3×); a 50/50 (volume based) water/ethanol mixture (3×); ethanol; 90/10 ethanol/acetic acid (3×); water (3×); tetrahydrofuran (2×); ethanol (3×). After each addition of 15 ml of solvent, the mixture was shaken and about 90 vol % of the solvent was removed prior to the addition of a new quantity of solvent. After addition of the last quantity of solvent, the remaining powder was washed on a filter paper using 100 ml of ethanol. The obtained white powder was characterized using X-ray diffraction techniques.

### Example 22

### Removal of Template and Silane Oligomers and Dispersion for HRTEM

1 Gram of white/yellow powder (example 15) was put in a polypropylene bottle and purified in using the following method. To this bottle was added consecutively 15 ml of the following solvents or solvent mixtures: aceton (2×); tetrahydrofuran (2×); ethanol (2×); a 50/50 (volume based) water/ethanol mixture (2×); ethanol (2×); After each addition of 15 ml of solvent, the mixture was shaken and about 90 vol % of the solvent was removed prior to the addition of a new quantity of solvent. After addition of the last quantity of solvent, the mixture was decanted. To the remaining powder 20 ml aceton was added and the liquid was shaken vigorously during 15 minutes. After shaking, the liquid became slightly turbid. This liquid suspension was used to disperse the poly oligosiloxysilane particles prior to characterizing using transmission electron microscopy (HRTEM) (FIG. 9-R).

### Example 23

### N₂-fysisorption

1 Gram of white/yellow powder (example 18) was put in a polypropylene bottle and purified in using the following method. To this bottle was added consecutively 15 ml of the following solvents or solvent mixtures: ethanol (3×); a 50/50 (volume based) water/ethanol mixture (3×); acetone (3×). After each addition of 15 ml of solvent, the mixture was shaken and about 90 vol % of the solvent was removed prior to the addition of a new quantity of solvent. After addition of the last quantity of solvent, the remaining powder was washed on a filter paper using subsequently 100 ml acetone and 100 ml ethanol. The obtained white powder was characterized using X-ray diffraction techniques, ²⁹Si MAS NMR. After calcination at 400° C. the micropore volume measured using N₂-fysisorption (FIG. 16) was larger than 0.15 ml.

### Example 24

### D6R Silicate Oligomers

12 ml of a 3 molar aqueous solution of KOH and 3. 96 gram of alfa-cyclodextrine are added to a 60 ml polypropylene bottle containing 20 ml of deionized water. To this stirred aqueous mixture, 8 ml tetraethyl orthosilicate (TEOS) is added over a period of 15 minutes. This mixture is stirred continuously. After a few hours up until a few days a silk like suspension is formed. After one additional month of stirring, the mixture is filtered and white crystals containing double sixring silicate dodecamers are obtained. The structure of the silicate hydrate material was confirmed using X-ray diffraction (XRD).

### Example 25

### TBA-Hextetra: D4R Connected Through Hydrogen Bonds in a Three Dimensional Network

20 ml Tetrabuthylammonium hydroxide (40 wt % in water) and 10 gram hexamethylenetetramine were added to a 250 ml polypropylene containing 50 ml of deionized water. To this stirred aqueous mixture, 20 ml tetraethyl orthosilicate (TEOS) was added over a period of 60 minutes. This mixture was stirred continuously until crystals were formed. After several weeks stirring, the mixture was filtered and washed with deionized water in order to remove excess of hexamethylenetetramine. A white powder is obtained, TBA-hextetra crystals. The structure of the silicate hydrate material was confirmed using X-ray diffraction (XRD).

### Example 26

### Coupling Reaction with Dichlorodimethylsilane, Gas Phase

In a dessicator 5 gram of crystals (EXAMPLE 25) are vacuum dried during 96 hours at a pressure below 3 mbar followed by an addition of 5 ml of dichlorodimethylsilane whereby direct contact between the liquid silane and the solids is avoided. After 7 days, unreacted dichlorodimethylsilane was removed under vacuum. The resulting poly oligosiloxysilane is a white/yellow powder and is characterized using the X-ray diffraction technique and ²⁹Si MAS NMR.

### Example 27

### Use of Natural Silicate Oligomer Sources

Dilute but relatively stable suspensions of silicate oligomers can be obtained through dissolution of nesosilicates, sorosilicates, cyclosilicates pyroxenes or amphiboles in an aqueous solution with a pH between 0 and 3.

### Example 28

### Use of Natural Silicate Oligomer Sources

Dilute but relatively stable suspensions of silicate oligomers can be obtained through dissolution of nesosilicates, sorosilicates, cyclosilicates pyroxenes or amphiboles in dry tetrahydrofuran with HCl acid.

### Example 29

### Use of Natural Silicate Oligomer Sources

Dilute but relatively stable suspensions of silicate oligomers can be obtained through dissolution of nesosilicates, sorosilicates, cyclosilicates pyroxenes or amphiboles in N-methylimidazole.

### Example 30

### Silicate Oligomers from Silsesquioxanes

Cyclic, linear or ladder-type silicate oligomers can be obtained through spontaneous or catalyzed alcoholysis of the structurally related hydridosilsesquioxanes.

### Example 31

### Coupling Reaction with Dichlorodimethylsilane

To 2 gram of TBA silicate hydrate crystals (EXAMPLE 3, 4 or 29) are vacuum dried at a pressure below 3 mbar during 24-125 hours by a temperature between 0° C. and 60° C., subsequently 1 ml to 5 ml of dichlorodimethylsilane is added. Contact between the silane and the silicate oligomer material is through the gas phase or through the liquid phase. During 4 hours up until 21 days, siloxane bridges between the silicate oligomers and silanes are allowed to form at a temperature below 60° C. Next the unreacted silanes, small B_{y} oligomers and some of the template are removed under vacuum during 5 minutes up until 2 days at a temperature between 0° C. and 250° C. Template and B_{y} oligomers can be further removed by washing the powder with organic solvents, water or combinations of organic solvents or combinations of organic solvent and water. The resulting poly oligosiloxysilane is a white, yellow or brown powder and is characterized using the X-ray diffraction (FIG. 14) and ²⁹Si MAS NMR (FIG. 19 (2-3)).

Particular and preferred aspects of the invention are set out in the accompanying independent and dependent claims. Features from the dependent claims may be combined with features of the independent claims and with features of other dependent claims as appropriate and not merely as explicitly set out in the claims.

Thus, the claims following the detailed description are hereby expressly incorporated into this detailed description, with each claim standing on its own as a separate embodiment of this invention.

FIG. 1: Schematical drawing of a linear chain poly oligosiloxysilane polymer with idealized composition Ab₄ (with A=[Si₈O₂₀H^{b}]^{b-8} and B═[Si(CH₃)X₂] and with X═Cl is the reactive leaving group (rlg), b=—Si(CH₃)₂—) synthesized starting from HMI-CySH silicate hydrate crystals

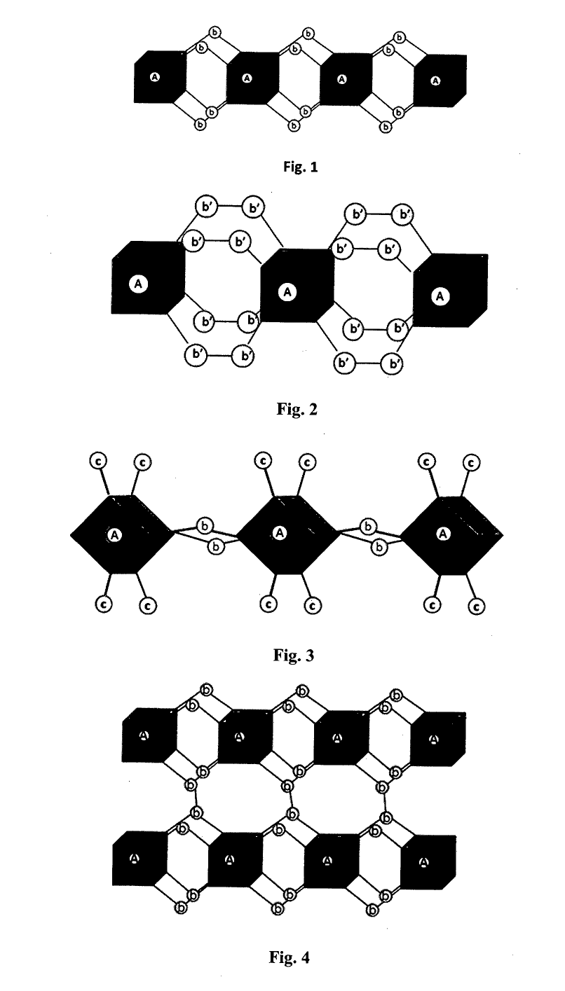

FIG. 2: Schematical drawing of a linear chain poly oligosiloxysilane polymer with idealized composition Ab′₈=Ab₄; with b′ a silicon containing compound, b is a siloxane bridge whereby b=b′-b′ and the b′-b′ bond is a Si—Si, Si—C—Si, or a Si—O—Si bond and A is a silicate oligomer with A=[Si₈O₂H_{b}]^{b-8}

FIG. 3: Schematical drawing of a linear chain poly oligosiloxysilane polymer with idealized composition Ab₂c₄ with b a siloxane bridge, c a silicon containing compound, A a silicate oligomer with A=[Si₈O₂₀H_{b}]^{b-8}

FIG. 4: Schematical drawing of a linear chain poly oligosiloxysilane polymer whereby siloxane bonds are formed between the siloxane bridges of different poly oligosiloxysilane polymer chains with idealized composition Ab₄=Ab″₂; with b″ a silicon bridge between four different silicate oligomers, b is a siloxane bridge between two silicate oligomers and whereby b″=b-b″ and the b-b bond is a siloxane bond and A is a silicate oligomer with A=[Si₈O₂₀H_{b}]^{b-8}

FIG. 5: Schematical drawing of a not perfect linear chain poly oligosiloxysilane polymer with idealized composition Ab₄ (with A=[Si₈O₂₀H_{b}]^{b-8} and b is a siloxane bridge between two silicate oligomers. Some of the potential side reactions are shown: A-A siloxane bond (centre of the figure); a siloxane bond only connected to one silicate oligomer (c); a siloxane bridge between a silicate oligomer and another silicon containing compound different from the silicate oligomers (d), (d-d); A siloxane bridge formed between two silicate oligomers but in a different way than expected based on the general ordering of the material (h); a siloxane bridge between different silicate oligomeric chains (i) and silicate oligomers with silanol groups and therefor missing siloxane bonds/siloxane bridges.

FIG. 6: Schematical drawing of a three dimensional poly oligosiloxysilane polymer with a structure related to zeolites with LTA topology and with an idealized composition Ab₄; A is a silicate oligomer with A=[Si₈O₂₀H_{b}]^{b-8}; B is a silane with B═[Si(CH₃)X₂] and with X═Cl is the reactive leaving group (rlg); b is a siloxane bridge b=—Si(CH₃)₂—) synthesized starting from TBA-di-en silicate hydrate crystals.

FIG. 7: Schematical drawing of a not perfect three dimensional poly oligosiloxysilane polymer with a structure related to zeolites with LTA topology and with an idealized composition Ab₄; A is a silicate oligomer with A=[Si₈O₂₀H_{b}]^{b-8}; B is a silane with B═—[Si(CH₃)X₂] and with X═Cl is the reactive leaving group (rlg); b is a siloxane bridge b=—Si(CH₃)₂—) synthesized starting from TBA-di-en silicate hydrate crystals. Some of the potential side reactions are shown: a siloxane bond only connected to one silicate oligomer (c); a siloxane bridge between a silicate oligomer and another silicon containing compound different from the silicate oligomers (d), (d-d).

FIG. 8: Schematical drawing of a not perfect three dimensional poly oligosiloxysilane polymer with a structure related to zeolites with LTA topology and with an idealized composition Ab₄; A is a silicate oligomer with A=[Si₈O₂₀H_{b}]^{b-8}; B is a silane with more than two reactive leaving groups; b is a siloxane bridge b=—Si(CH₃)₂—) Some of the potential side reactions are shown and are represented by the letters “e”, “f” and “g”.

FIG. 9: HRTEM images of HMI-CySA (L) and a small bundle of linear poly oligosiloxysilane polymer chains synthesized through linking of the silicate octameric cubes of HMI-CySA silicate amine material with dimethyldichlorosilane (R).

FIG. 10: Schematical drawing of linear chain silicate “oligomers” (1) and linear double chain silicate “oligomers” (2 and 3).

FIG. 11: In situ X-ray diffraction measurements providing evidence for the transition of HMI-CySH to HMI-CySA through air drying of a suspension of HMI-CySH crystals.

FIG. 12: Provides a structural drawing of some of the different N-containing template molecules used to synthesise silicate hydrate crystals. A) Quaternary methylammonia: a) Tetramethylammonium (TMA), b) phenyltrimethylammonium (NPhTMA), c) benzyltrimethylammonium (NBzTMA), d) 1,1-dimethylpiperidinium, e) 1,1,4,4-tetramethylpiperazinium (TMPA) 1,4-dimethyl-1,4-diazoniabicyclo[2.2.2]octane (DDBO) g) N,N,N,N′,N′,N′-hexamethyl[1,1′-biphenyl]-4,4′ dimethanaminium h) N,N,N,N′,N′,N′-hexamethyl[1,1′-biphenyl]-2,2′ dimethanaminium i) 2,3,4,5,6,7,8,9-octahydro-2,2,5,5,8,8-hexamethyl-1H-benzo[1,2-c: 3,4-c′: 5,6e]tripyrrolium (HMBPT) B) other quaternary ammonia: j) tetraethylammonium (TEA), k) tetrabuthylammonium C) Metal-ethylenediamine (en) complexes: 1) Cu(en)22+ m), Co(en)33+ n) Ni(en)33+ D) Templates capable of synthesizing silicate hydrate crystals of unknown structure: o) triethyl-(2-hydroxyethyl)ammonium, p) diethyl-di(2-hydroxyethyl)ammonium, q) tetra(2-hydroxyethyl)ammonium, r) triethyl-(2-hydroxypropyl)ammonium, s)pyridine t) N-(2-hydroxyethyl)pyridinium, u) N-(2-hydroxypropyl)pyridinium, v) guanidine

FIG. 13: Alfa-cyclodextrine, a template used in the synthesis of silicate hydrate crystals with D6R silicate dodecamers.

FIG. 14: X-ray diffraction measurements of TBA-dien silicate hydrate crystals (1) and different poly oligosiloxysilanes with a three dimensional structure structurally related to zeolites with the LTA topology (2-5), a poly oligosiloxysilane synthesized starting from TBA-hextetra silicate hydrate crystals (2) and poly oligosiloxysilanes synthesized starting from TBA-dien (3-5). The difference in the diffraction patterns of 2-5 can be explained by the flexibility of the lattice. Diffraction patterns similar to 5 can be obtained from as-synthesized poly oligosiloxysilanes with a three dimensional structure related to zeolites with LTA topology but are more typical for extensively washed poly oligosiloxysilane materials with a three dimensional structure related to zeolites with LTA topology.

FIG. 15: Schematically representation of the set-up used to dry silicate hydrate crystals, and add silanes while avoiding contact between the liquid silane and the silicate hydrate crystals.

FIG. 16: N₂-fysisorption on poly oligosiloxysilane with a structure related to zeolites with a LTA topology.

FIG. 17: X-ray diffraction measurements of a silicate oligomer containing crystalline material obtained though the slow evaporation of a suspension of HMI-CySA crystals in tetrahydrofuran, diethylether and HCl acid whereby part of the formed HMI.HCl is removed through filtration.

FIG. 18: X-ray diffraction measurements of a silicate oligomer containing crystalline materials: HMI-CySH (1), HMI-CySA (2), crystals obtained though the washing of HMI-CySA crystals with aceton (3).

FIG. 19: ²⁹Si MAS NMR measurements different poly oligosiloxysilanes with a one dimensional structure (1) and three dimensional structure structurally related to zeolites with the LTA topology (2-3).

1-20. (canceled)

21. An ordered or locally ordered silica based polymer comprising silicate oligomers (A) which are interconnected by siloxane bridges (b),
with general formula [Abₓ+b_{y}] wherein x is the ratio between the number of bridges and the number of silicate oligomers in the polymer wherein each (A) is a double ring silicate oligomer independently from each other of formula [SiₙO_{5n/2}H_{b}]^{b-n} with n being 6, 8, 10, 12, 14 or 16 and each b selected from 0 to 2n wherein [x=2-6 and wherein the silica based polymer contains one or more different types of silane oligomers b_{y} and wherein
i. part of the silane oligomers b_{y} are directly connected to the Abₓ polymer, and/or,
ii. part of the silane oligomers b_{y} are inside of the pores of the Abₓ polymer, and/or,
iii. Part of the silane oligomers b_{y} are in close contact with the Abₓ polymer or with general formula Abₓ wherein x is the ratio between the number of bridges and the number of silicate oligomers in the polymer wherein each (A) is a double ring silicate oligomer independently from each other of formula [SiₙO_{5n/2}H_{b}]^{b-n} with n being 6, 8, 10, 12, 14, or 16 and each n selected from 0 to 2n and wherein x=2-6,
characterized in that said polymer comprises organic groups on said siloxane bridges (b) of said polymer.

22. The silica based polymer according to claim 21, wherein silicate oligomer (A) is a double four ring silicate octamer of formula [Si₈O₂₀H_{b}]^{b-8} with b selected from the group consisting of 0, 1, 2, 3, 4, 5, 6, 7, 8, 9, 10, 11, 12, 13, 14, 15, and 16.

23. The silica based polymer according to claim 22, wherein said siloxane bridges b connected to said silicate oligomer (A) are connected to two silicate oligomers.

24. The silica based polymer according to claim 22, wherein x=3-5.

25. The silica based polymer according to claim 22, wherein x=3.5-4.5.

26. The silica based polymer according to claim 22, wherein x=4.

27. The silica based polymer according to claim 22, wherein said polymer is not a liquid and said polymer is not a gel material.

28. The silica based polymer according to claim 22, which is hydrophobic and wherein siloxane bridges are of the form —OSi(CH₃)₂O—.

29. The silica based polymer according to claim 22, wherein said siloxane bridge (b) is derived from a silane (B) or combination of silanes of form SiWXYZ wherein 2, 3 or 4 of the groups W, X, Y, Z are independently of each other selected from the group of reactive leaving groups (rig) consisting of H, OH, Cl, Br, I, NHR, NR₂, OSi(R)₃, NSi(R)₃, OSn(R)₃, OSb(R)₃ or OSi(R)₂H, OR, wherein R is selected from the group consisting of methyl, ethyl, vinyl, allyl, isopropyl, propyl, isobutyl, butyl, phenyl, benzyl, cyclopentyl, cyclohexyl, octyl, isooctyl, aminophenyl, aminopropyl, trifluoropropyl and dibromoethyl or being an organic group of one of the following types: alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, and cyclic alkyne,
and wherein the remaining 0, 1 or 2 groups W, X, Y, Z are independently of each other selected from the organic groups consisting of H, alkyl, alkenyl, aryl, arenyl, alcohol, thiol, phenolic compound, amine, keton, ester, ether, amide, cyanate, nitrile, sulfate, sulfonate, haloalkyl, haloaryl, fluoroalkyl, fluoroaryl, epoxide, phosforous containing organic compound, acid, acid chloride, aldehyde, anhydride, alkene, alkyne, cyclic alkane, cyclic alkene, and cyclic alkyne.

30. The silica based polymer according to claim 29, wherein said siloxane bridge is derived from a silane (B) or combination of silanes selected from the group consisting of SiCl₂(CH₃)₂, SiCl₂(CH₃)H, SiCl₂H₂, SiCl₃(CH₃), SiCl₃H, and SiCl₄.

31. The silica based polymer according to claim 29, wherein B═B′—B′, wherein B′ is a silane and the B′—B′ bond is a siloxy bond.

32. The silica based polymer according to claim 29, wherein B═B″—B″, wherein B″ is a silane and the B″—B″ bond is a silicon-silicon bond.

33. A poly oligosiloxysilane material for adsorption applications, coatings, sealants, sensors and other applications that need flexible poly oligosiloxysilanes, said material comprising a silica based polymer according to claim 21.

34. A method for preparing an ordered or locally ordered silica based polymer comprising silicate oligomers (A) which are interconnected by siloxane bridges (b) according to claim A, the method comprising the step of combining a silicate oligomer material containing one type of silicate oligomers and wherein a large fraction of the individual terminal oxygen atoms on the silicate oligomers have minimum one terminal oxygen on minimum one of the other silicate oligomers at a distance of between 0.17 and 0.35 nm with one or more silanes (B),
wherein contacting the one or more silanes with the silicate oligomer material is performed at a temperature below 150° C.

35. The method according to claim 34, wherein the one or more silanes can be added to the silicate oligomers as a solid, in a supercritical state, as a solution or a suspension in an organic liquid, as a solution or a suspension in an organic amine, in liquid phase or in gas phase.

36. The method according to claim 34, wherein the step of combining silicate oligomer material with one or more silanes is repeated.
